(19) United States
(12) Patent Application Publication
(10) Pub. No.: US 2026/0100108 A1
(43) Pub. Date: Apr. 9, 2026

(54) System and Methods for Operating a Casino Loyalty Computer System to Display Computer-Animated Images of Casino Charm Icons on Gaming Devices

(71) Applicant: Station Casinos LLC, Las Vegas, NV (US)

(72) Inventors: Thomas Mikulich, Las Vegas, NV (US); Jon Von Tobel, Las Vegas, NV (US); William Chad Little, Las Vegas, NV (US)

(21) Appl. No.: 19/347,503

(22) Filed: Oct. 1, 2025

Related U.S. Application Data
(60) Provisional application No. 63/703,036, filed on Oct. 3, 2024.
(60) Provisional application No. 63/729,231, filed on Dec. 6, 2024.

(51) Int. Cl. G07F 17/32

(52) U.S. Cl. CPC G07F 17/3293; G07F 17/3211; G07F 17/3255; G07F 17/3262

(57) ABSTRACT

A networked computer system for displaying computer-animated images on electronic gaming machines (EGMs) is described herein. The networked computer system includes a plurality of EGMs located at a gaming property and a gaming property management server coupled to each EGM. Each EGM includes a display device including a graphical user interface (GUI) display screen displaying computer-generated icon images thereon and a corresponding player tracking device configured to monitor wagering activity associated with the EGM. The gaming property management server includes one or more processors programmed to execute an algorithm to display a computer-animated sequence of computer-generated images on the GUI display screens of corresponding EGMs including the steps of displaying a game window and a patron service window on a first EGM including a user selectable charms challenge selection icon in the patron service window.

### CROSS-REFERENCE TO RELATED APPLICATION

This application claims the benefit of U.S. Provisional Patent Application Ser. No. 63/703,036, filed Oct. 3, 2024 and U.S. Provisional Patent Application Ser. No. 63/729,231, filed Dec. 6, 2024, the disclosures of which are hereby incorporated by reference in their entirety.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### FIELD OF THE DISCLOSURE

The present invention relates to networked computer systems for casino property management systems, and more particularly, to systems, methods, and computer-readable storage media to operate casino loyalty program computer system to improve computer-animated images associated with non-fungible tokens recorded on blockchain systems on gaming devices and modify the operation of gaming machines, including paytables and/or return to player, based on non-fungible tokens.

### BACKGROUND

As the increasingly globalized society accelerates its waves of new technology and innovation, the gaming industry has been impacted by two inversely related trends. Most significantly the technological advances in gaming, while greatly enhancing operational efficiencies, have had a profoundly negative impact on the value proposition of the casino experience for guests. As this casino experience value proposition continues to degrade, the number of competitors striving for a stake of guests' wallets is constantly multiplying, as is their case of access into those wallets. As a result, the efficacy of casino loyalty programs diminish over time, yet continues to utilize overplayed tactics that are ubiquitous within the gaming industry.

The present invention is aimed at one or more of the problems identified above.

### SUMMARY OF INVENTION

In one aspect of the present invention, a networked computer system for displaying computer-animated images on electronic gaming machines (EGMs) is provided. The networked computer system includes a plurality of EGMs located at a gaming property and a gaming property management server coupled to each EGM. Each EGM includes a display device including a graphical user interface (GUI) display screen displaying computer-generated icon images thereon and a corresponding player tracking device configured to monitor wagering activity associated with the EGM. The gaming property management server includes one or more processors programmed to execute an algorithm to display a computer-animated sequence of computer-generated images on the GUI display screens of corresponding EGMs including the steps of displaying a game window and a patron service window on a first EGM including a user selectable charms challenge selection icon in the patron service window and receiving a charms challenge gaming session request from the first EGM initiated by a patron selection of the charms challenge selection icon. The one or more processors then conduct a charms challenge session by identifying a second EGM, associating a first casino charm with the first EGM and a second casino charm with the second EGM with each of the first and second casino charms having corresponding charm luck values, establishing a number of game plays associated with the charms challenge session, displaying a charms challenge game screen on the first and second EGMs including casino charm icons associated with the first and second casino charms and the corresponding charm luck values, monitoring wagering activity at the first and second EGMs for each of the number of game plays, determining a number of charm luck points accumulated during the charms challenge session based on the monitored wagering activity at the first and second EGMs, animating a charms luck points icon on the first and second EGMs displaying the accumulated number of charm luck points, modifying the corresponding charm luck values of the first and second casino charms based on the accumulated number of charm luck points, and animating corresponding casino charm icons on the charms challenge game screen of the first and second EGMS to display the modified charm luck values of the first and second casino charms.

In another aspect of the invention, a method of operating a networked computer system is provided. The networked computer system includes a plurality of EGMs located at a gaming property with each EGM including a display device including a graphical user interface (GUI) display screen displaying computer-generated icon images thereon and a corresponding player tracking device configured to monitor wagering activity associated with the EGM, and a gaming property management server including one or more processors coupled to each EGM. The method includes the one or more processors performing an algorithm to display a computer-animated sequence of computer-generated images on the display screens of corresponding EGMs including the steps of displaying a game window and a patron service window on a first EGM including a user selectable charms challenge selection icon in the patron service window and receiving a charms challenge gaming session request from the first EGM initiated by a patron selection of the charms challenge selection icon. The one or more processors then conduct a charms challenge session by identifying a second EGM, associating a first casino charm with the first EGM and a second casino charm with the second EGM with each of the first and second casino charms having corresponding charm luck values, establishing a number of game plays associated with the charms challenge session, displaying a charms challenge game screen on the first and second EGMs including casino charm icons associated with the first and second casino charms and the corresponding charm luck values, monitoring wagering activity at the first and second EGMs for each of the number of game plays, determining a number of charm luck points accumulated during the charms challenge session based on the monitored wagering activity at the first and second EGMs, animating a charms luck points icon on the first and second EGMs displaying the accumulated number of charm luck points, modifying the corresponding charm luck values of the first and second casino charms based on the accumulated number of charm luck points, and animating corresponding casino charm icons on the charms challenge game screen of the first and second EGMS to display the modified charm luck values of the first and second casino charms.

In yet another aspect of the present invention, a non-transitory computer-readable storage media having computer-executable instructions embodied thereon to operate a networked computer system is provided. The networked computer system includes a plurality of EGMs located at a gaming property with each EGM including a display device including a graphical user interface (GUI) display screen displaying computer-generated icon images thereon and a corresponding player tracking device configured to monitor wagering activity associated with the EGM, and a gaming property management server including one or more processors coupled to each EGM. When executed by the one or more processors the computer-executable instructions cause the one or more processors to perform an algorithm to display a computer-animated sequence of computer-generated images on the display screens of corresponding EGMs including the steps of displaying a game window and a patron service window on a first EGM including a user selectable charms challenge selection icon in the patron service window and receiving a charms challenge gaming session request from the first EGM initiated by a patron selection of the charms challenge selection icon. The one or more processors then conduct a charms challenge session by identifying a second EGM, associating a first casino charm with the first EGM and a second casino charm with the second EGM with each of the first and second casino charms having corresponding charm luck values, establishing a number of game plays associated with the charms challenge session, displaying a charms challenge game screen on the first and second EGMs including casino charm icons associated with the first and second casino charms and the corresponding charm luck values, monitoring wagering activity at the first and second EGMs for each of the number of game plays, determining a number of charm luck points accumulated during the charms challenge session based on the monitored wagering activity at the first and second EGMs, animating a charms luck points icon on the first and second EGMs displaying the accumulated number of charm luck points, modifying the corresponding charm luck values of the first and second casino charms based on the accumulated number of charm luck points, and animating corresponding casino charm icons on the charms challenge game screen of the first and second EGMS to display the modified charm luck values of the first and second casino charms.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic illustrating various aspects of a networked computer system for displaying images associated with casino charm icons on gaming devices located within casino properties, according to the present invention;

FIGS. 2-7 are schematic diagrams of a customer loyalty program computer system that may be used with the system shown in FIG. 1, according to an embodiment of the present invention;

FIGS. 8-12 are flowcharts illustrating the algorithms executed by the customer loyalty program computer system for displaying images associated with casino charm icons on gaming devices located within casino properties, according to embodiments of the present invention;

FIGS. 13-16 are illustrations of exemplary data files generated by the networked computer system, according to embodiments of the present invention;

FIGS. 17-19 are illustrations of exemplary user interface screens that may be displayed by customer loyalty program computer system on gaming devices when executing the algorithms show in FIGS. 8-12, according to embodiments of the present invention;

FIG. 20 is another schematic diagram of networked computer system shown in FIG. 1 for displaying images associated with casino charm icons on gaming devices located within casino properties, according to embodiments of the present invention;

FIG. 21 is a flowchart illustrating an algorithm executed by the customer loyalty program computer system for displaying images associated with casino charm icons on gaming devices located within casino properties, according to embodiments of the present invention;

FIGS. 22-26 are illustrations of exemplary data files generated by the customer loyalty program computer system, according to embodiments of the present invention;

FIGS. 27-40 are illustrations of exemplary animated sequences of computer-generated images displayed on graphic user interface screens that may be displayed by customer loyalty program computer system on gaming devices when executing the algorithms show in FIGS. 8-12 and 21, according to embodiments of the present invention;

FIG. 41 is a schematic illustrating example components of a server computer that may be used with the system shown in FIG. 1, according to an embodiment of the present invention;

FIGS. 42-45 are flowcharts illustrating the algorithms executed by the server computer shown in FIGS. 1, 5-6, 20, and 41, according to embodiments of the present invention;

FIGS. 46-54 are illustrations of exemplary data files generated by the server computer shown in FIGS. 1, 5-6, 20, and 41, according to embodiments of the present invention;

FIGS. 55-59F are illustrations of illustrations of exemplary computer-animated sequences of computer-generated images displayed on graphic user interface screens that may be displayed by customer loyalty program computer system on gaming devices when executing the algorithms show in FIGS. 42-45, according to embodiments of the present invention;

FIG. 60 is a flowchart illustrating the algorithms executed by the server computer shown in FIGS. 1, 5-6, 20, and 41, according to embodiments of the present invention; and

FIGS. 61-79 are illustrations of illustrations of exemplary computer-animated sequences of computer-generated images displayed on graphic user interface screens that may be displayed by customer loyalty program computer system on gaming devices when executing the algorithms show in FIG. 60.

FIG. 80 is a flowchart illustrating the algorithms executed by the server computer shown in FIGS. 1, 5-6, 20, and 41, according to embodiments of the present invention; and

FIGS. 81-88 are illustrations of illustrations of exemplary computer-animated sequences of computer-generated images displayed on graphic user interface screens that may be displayed by customer loyalty program computer system on gaming devices when executing the algorithms show in FIG. 80.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION OF THE INVENTION

With reference to the FIGS. and in operation, the present invention provides a networked computer system, methods and computer product media that monitors the activities of casino patrons within multiple physical casino properties, displays computer-animated images of the casino charm icons on gaming devices, modifies the operation of gaming machines, including paytables and/or return to player, based on selected casino charm icons, and facilitates the purchase and sale of the casino charm icons using a blockchain ledger system.

In some embodiments, the system uses Non-Fungible Tokens (NFT) leveraging Blockchain technology to be used in conjunction with Station Casinos' Loyalty Program (Boarding Pass). These NFTs can be accessed by the patron (once they insert their Boarding Pass loyalty card) at a slot machine through the display devices (service window or TFT display) and an individual NFT can be selected to display a preview image, which is a graphical representation of the NFT, on the slot machine's banner located on the slot machine video monitor. This preview image displayed on the banner represents a lucky charm for the player as they play the game.

In an effort to combat these trends and enhance current Customer Relationship Management (CRM) systems, the present invention includes a customer loyalty program computer system programmed to implement an STN Charms™ program offered by Station Casinos™ that draws upon the achievement based foundation of Social Gaming and applies it to Gaming Loyalty Programs to reinvent and add value to the casino experience value proposition, drive incremental trips, cater to both traditional and new guests, while removing access barriers to guests. As symbols of guests' achievements as they progress advance levels and complete quests, they will be rewarded with various themed Non-Fungible Tokens (NFTs), called “Charms”, which will utilize blockchain technology. By strategically setting scarcity standards for these Charms, guests will associate various Charms as status symbols and utilize a Charm Market to buy and sell Charms with other guests and/or casino properties.

Blockchain Overview: A blockchain is a database formed by a sequence of entries called blocks. Blockchains have a special characteristic by which any attempt to modify one of its entries would modify the entire chain. It is, therefore, an immutable data structure, which stores blocks in chronological order of insertion. This makes blockchain a perfect storage medium for financial records which need to be audited (such as a Bitcoin transaction). Each entry in a blockchain is called a block, which is a data structure that contains a header and a payload. Every blockchain header must have a field that points to the block before. The link from every block to the block before forms the chain of blocks. These blocks are recorded in chronological order and this order cannot be modified. Therefore, blockchains prove not only that data is valid, but also at which point in time that data was inserted. For this reason, blockchains can be used as “proof of knowledge” of information.

NFT Overview: NFTs (Non-Fungible Tokens) are blockchain-based tokens that each represent a unique asset like a piece of art, digital content, or media. NFTs typically exist on a distributed blockchain ledger system such as, for example, Ethereum™ blockchain, IBM Blockchain™, Tezos™, Stellar™, and the like. Unlike a dollar bill, an NFT cannot be swapped for another similar NFT and inherently have the same value (such as trading a $5 bill for another $5 bill). Utilizing the same ‘proof of knowledge’ mentioned in the blockchain overview, NFT's are a method of documenting ‘proof of ownership’. Ownership has been defined loosely as NFT's have been made for art, videos, GIFs, tweets, and much more, but in reality one can make an NFT for just about anything. It is important to note that once a batch of NFT's is created, that batch cannot be edited or increased in the future. If one were to make 100 NFT's of their coffee cup, once minted there will only be 100 in perpetuity (although this does not prohibit that creator from making another 100 very similar NFT's). Another key feature of NFT's is that there is usually a royalty fee attached to them upon creation (determined by the creator). When an NFT transaction occurs, the buyer of the NFT ends up paying the royalty fee on top of the base price. This royalty fee is incurred every time the NFT is bought/sold and goes to the creator.

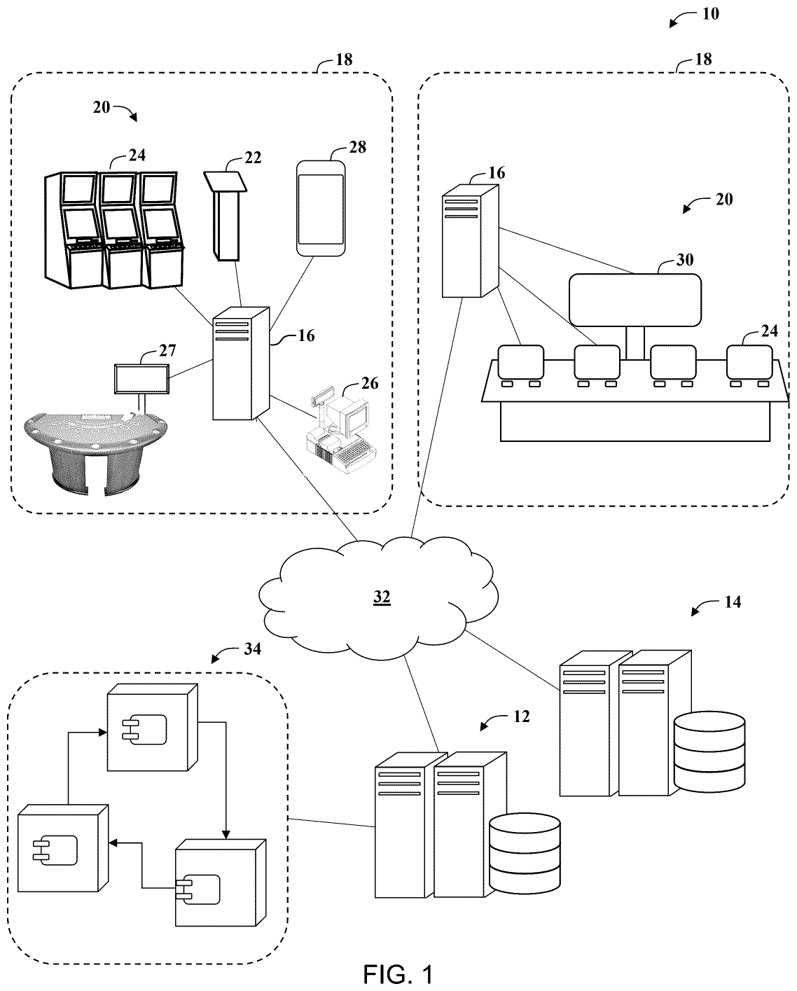

Referring to FIG. 1, an exemplary environment in which the networked computer system 10 operates is illustrated. In general, the present invention describes a networked computer system 10 for use in operating a customer loyalty program that generates NFT Charms that may be awarded to patrons. The system 10 interacts with a blockchain ledger system to record NFT Charm transactions associated with NFT Charm creation, NFT Charm ownership, and NFT Charm transactions.

In the illustrated embodiment, the system 10 includes a customer loyalty program computer system 12 that is coupled in communication with a casino management system server 14 and a plurality of player tracking servers 16 located at a plurality of casino property locations 18. The customer loyalty program computer system 12 communicates with the casino management system server 14 and the player tracking servers 16 and executes algorithms to implement the STN Charms™ program. Each player tracking server 16 is coupled in communication with a plurality of gaming devices 20 that are located at a corresponding casino property 18 and are accessible by casino patrons to purchase goods and services provided by the casino property. Each server may include one or more server computers that each include a processing device that includes a processor that is coupled to a memory device. The processing device executes various programs, and thereby controls components of the server according to user instructions received from the gaming devices 20 and/or other servers. The processing device may include memory, e.g., read only memory (ROM) and random access memory (RAM), storing processor-executable instructions and one or more processors that execute the processor-executable instructions.

In the illustrated embodiment, the plurality of gaming devices 20 includes kiosks 22, electronic gaming machines (EGM) 24, a point-of-sale (POS) terminals 26, electronic table games and/or table game display systems 27, and user/patron computing devices 28. The player tracking servers 16 monitor the purchases and activities of patrons and transmits the information to the customer loyalty program computer system 12 and/or the casino management system server 14. The casino management system server 14 generates and maintains patron account records associated with each patron that includes information associated with the purchase and activities of patrons being monitored by the player tracking servers 16, which are then used to award promotional points and/or NFT Charms to patrons that may be used to purchase additional goods and services and/or NFT Charms from the casino properties. For example, the player tracking servers 16 are configured to tracking patrons wagering activity and game play on electronic gaming machines, table games and other gaming revenue areas such as, bingo, keno, and sports wagering. In addition, the player tracking servers 16 are configured to monitor patron purchases of casino property services such as restaurant, spa services, merchandise, hotel rooms, and amenity services through non-gaming revenue POS terminals 26 and/or kiosks 22. Moreover, the player tracking servers 16 may be configured to monitor patron purchases and activities accessed using user computer software applications such as mobile software applications executed on mobile computing devices and/or websites. In some embodiments, the player tracking servers 16 and/or the casino management system server 14 identifies patrons using patron tracking ID cards and/or a patron identification numbers (PIN) that are linked to the patron account records. The casino management system server 14 tracks the patron's gaming play and may award patron tracking points, bonuses, and other incentives according to established criteria to promote continued patron loyalty. For example, in one embodiment, the casino management system server 14 may be configured to implement the myBoardingPass™ player rewards program offered by Station Casinos™.

The gaming devices 20, casino management system server 14, player tracking servers 16, and customer loyalty program computer system 12 communicate via a communications network 32. The communications network 32 may be any suitable connection, including the Internet, file transfer protocol (FTP), an Intranet, LAN, a virtual private network (VPN), cellular networks, etc. . . . , and may utilize any suitable or combination of technologies including, but not limited to, wired and wireless connections, always on connections, connections made periodically, and connections made as needed.

In the illustrated embodiment, each user/patron computing device 28 includes a display device and a processing device that includes a processor that is coupled to a memory device. The processing device executes various programs, and thereby controls components of the computing device according to user instructions received by the user to enable the user to access and communicate with the system 10 including sending and/or receiving information to and from the system 10 and displaying information received from the system 10 to the user.

For example, in some embodiments, the user computing device 28 may include, but is not limited to, a desktop computer, a laptop or notebook computer, a tablet computer, smartphone/tablet computer hybrid, a personal data assistant, a handheld mobile device including a cellular telephone, and the like. In addition, the user computing device 28 may include a touchscreen that operates as the display device and the user input device. In the illustrated embodiment, the user computing device 28 includes a web-browser program that is stored in the memory device. When executed by the processor of the user computing device, the web-browser program enables the user computing device to receive software code from the system 10 including, but not limited to, HTML, JavaScript, and/or any suitable programming code that enables the user computing device to generate and display a website and/or webpages on the display device of the user computing device.

Similarly, kiosks 22 may include a touchscreen display and processor for executing web-browser programs to receive software code from the system 10 and display a website and/or webpages on the touchscreen display. In addition, the kiosks 22 may also include a card reader device for obtaining patron ID's stored on the physical patron tracking ID cards.

In one embodiment, the user computing device 28 may include a mobile computing device such as, for example, a tablet computer, a smartphone/tablet computer hybrid, a smartphone such as an iPhone™, Samsung Galaxy™, and the like. The mobile computing device includes a processor coupled to a memory device for storing various programs and data for use in operating the mobile computing device. The mobile computing device may also include a touchscreen display unit, one or more video image cameras, one or more speakers, a microphone, at least one input button, and one or more sensors including, but not limited to, a touch ID fingerprint sensor coupled to an input button, a barometer, a three-axis gyro, an accelerometer, proximity sensor, and an ambient light sensor. In addition, the mobile computing device may also include a Wi-Fi antenna, a cellular network antenna, a Bluetooth™ communications device, assisted GPS and GLONASS, a digital compass, and an iBeacon™ microlocation device. The mobile computing device may be programmed to store and execute mobile computer program applications that display graphical user interfaces on the touchscreen display unit that allows the user to access the system 10 to retrieve and store information within the system 10 as well as interact with and operate the system 10. For example, the system 10 may be configured to implement a mobile application such as, for example, the “STN™” mobile application offered by Station Casinos™ available in Apple iOS™, Google Android™, and Amazon Kindle™ operating platforms, or on social-media websites such as Facebook™.

In some embodiments, the POS terminal 26 includes a computer processor, a monitor (e.g., a cashier-facing monitor), one or more input devices (e.g., scanners, keyboards, scales, or the like), one or more payment devices (e.g., cash drawers, card readers) for receiving or returning payments, one or more output devices (e.g., customer-facing display monitor, receipt printer), or the like or combinations or sub-combinations thereof, and a near field communication (NFC) device, such as, for example, an NFC dongle. The input devices and payment devices can feed data and commands to computer processor for processing or implementation. For example, a barcode scanner can pass data communicating the identity of one or more items to be purchased, returned, or the like to a computer processor. Similarly, a card reader can pass payment information and/or patron ID information to the computer processor. Similarly, customer-facing display and receipt printer can display or output data or information as instructed by the computer processor.

The electronic gaming machine (EGM) 24 includes a gaming cabinet that houses a display device and a gaming controller that includes one or more gaming computer processors for generating and displaying a plurality of games on the display device. The display device of the EGM may include an LCD or OLED display device including a graphical user interface (GUI) display screen displaying computer-generated icon images thereon, and/or a touchscreen display. The gaming computer processor executes a wagering game program that uses a random number generator to randomly generate outcomes of the games, which allows a player to make a wager, play a game, and potentially provide the player an award based on an outcome of the game and a paytable. For example, in some embodiments, the EGM 24 executes a video slot machine that executes a game including a plurality of video reels displaying game symbols. The EGM 24 may also execute any type of game including, but not limited to, a video slot game, a keno game, a blackjack game, a video poker game, or any type of game which allows a player to make a wager and potentially provide the player an award.

In some embodiments, the EGM 24 includes a user input device that includes a plurality of input buttons and an acceptor device that includes a coin slot and/or a bill acceptor. The acceptor device includes an input and output device that is configured to accept a bill, a ticket, and/or a cash card into the acceptor device to enable an amount of gaming credits associated with a monetary value of the bills, ticket, and/or cash card to be credited to the gaming device. For example, the acceptor device may utilize a cashless wagering system (not shown), such as a ticket in ticket out (TITO) system (not shown). The EGM 24 may also include a player tracking device that communicates with the player tracking server 16. The player tracking device includes a player identification card reader and a display. The player identification card reader is configured to accept a player tracking ID card inserted by the player, and read information contained on the player tracking card to identify the player account information. The player identification card reader may include, but is not limited to, a barcode reader, a magnetic card reader, and/or a radio frequency identification (RFID) card reader. The display device may include a touchscreen panel that includes a keypad to allow the player to enter a unique PIN that is used by the player tracking server 16 to identify the patron and the corresponding patron tracking account. The player tracking device is configured to communicate player account information and gaming activity between the player tracking server 16 and the EGM gaming controller. For example, the player tracking device may be used to track bonus points and/or credits awarded to the player during a gaming session and/or track bonus and/or credits downloaded to the EGM 24 from the player tracking server 16.

In some embodiments, the player tracking server 16 may be located at a gaming tavern and coupled to a plurality of bar top EGMs 24 and one or more central display devices 30 that include an LCD or OLED display device including a display screen displaying computer-generated icon images thereon.

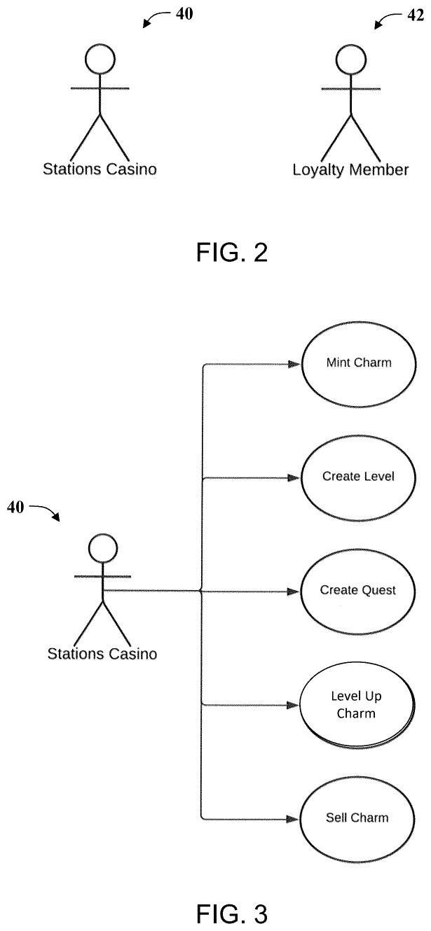

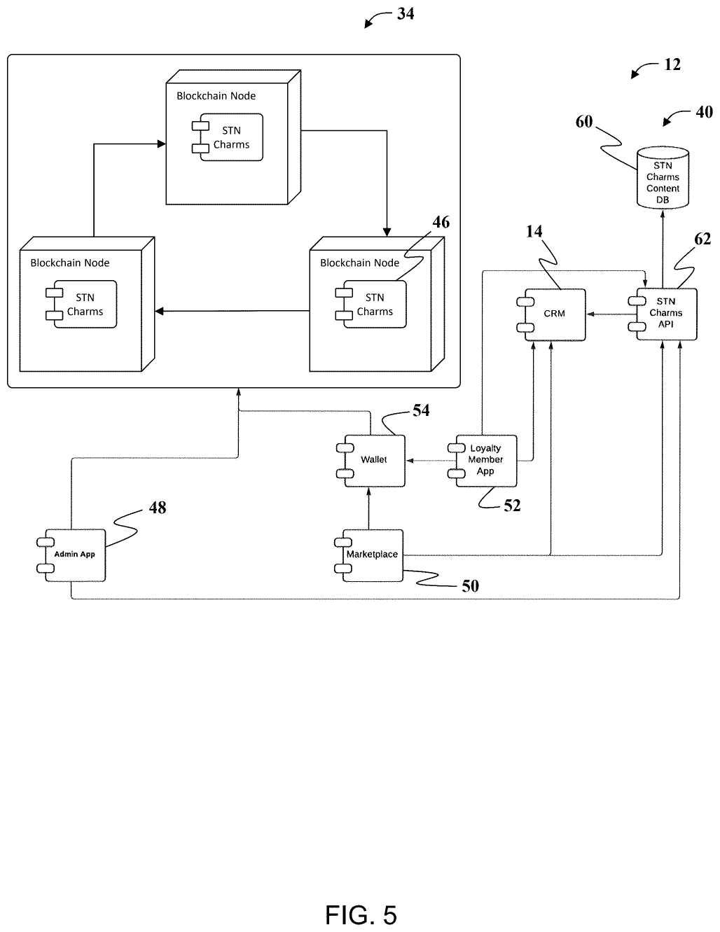

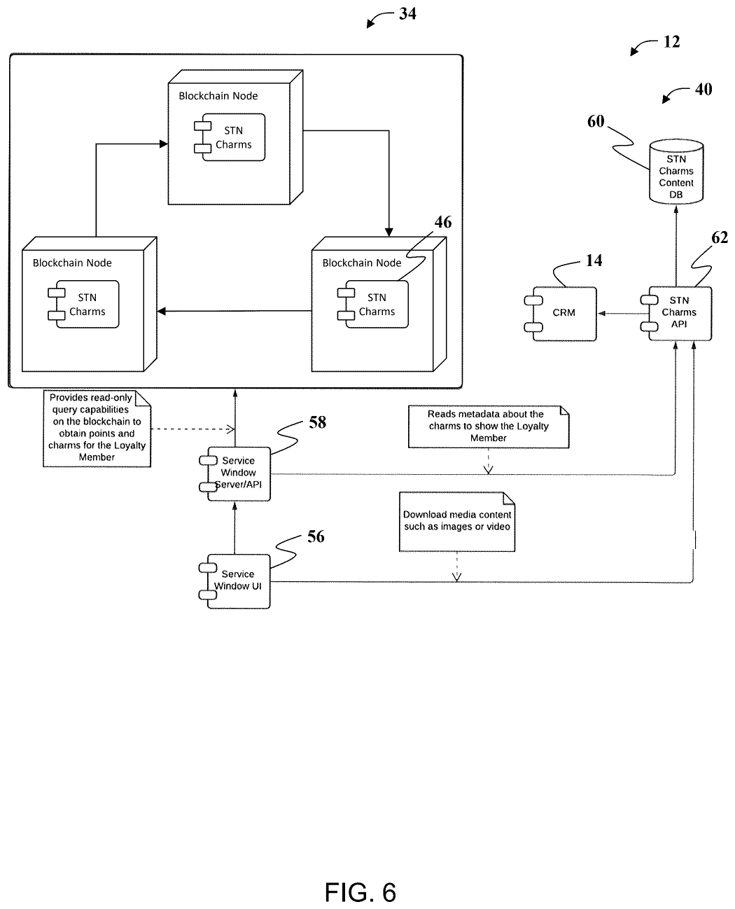

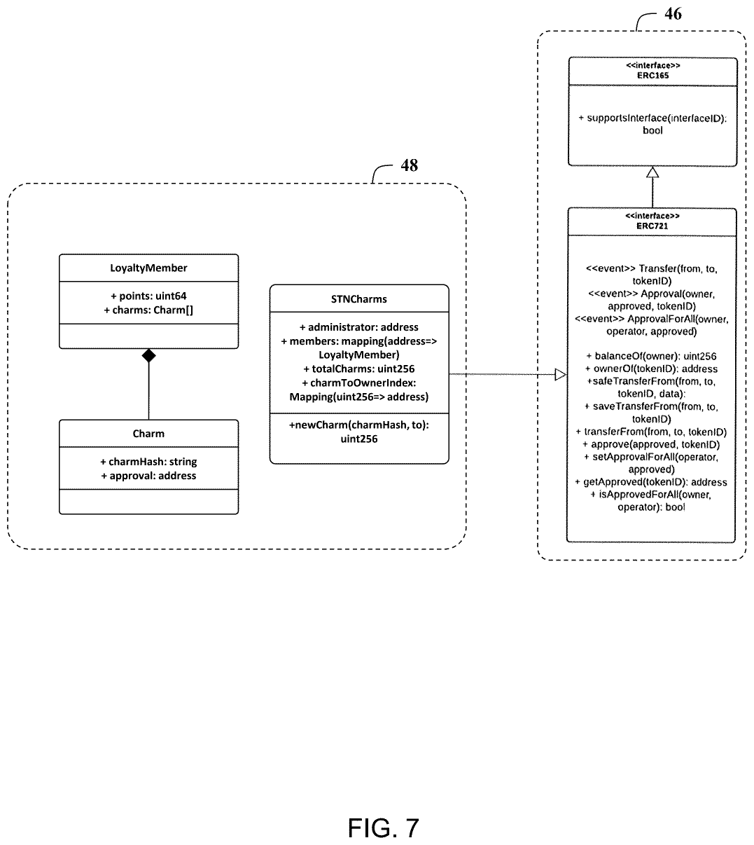

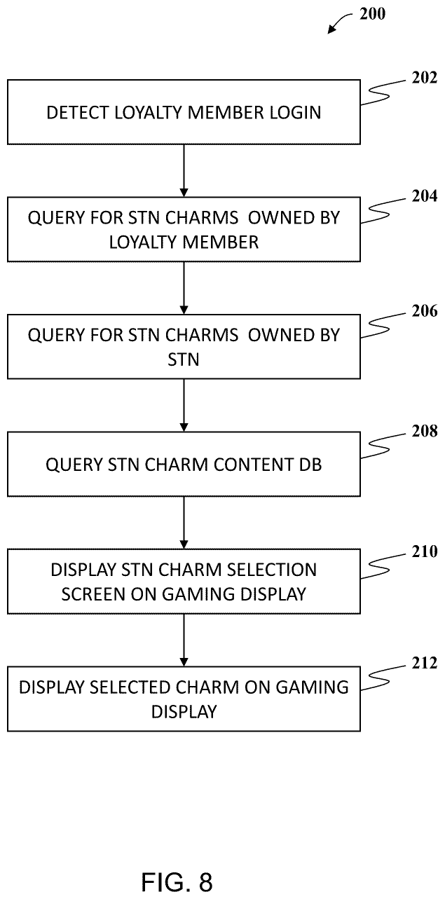

FIGS. 2-7 are schematic diagrams illustrating example components of the customer loyalty program computer system 12. FIGS. 8-12 illustrate the algorithms 200-600 executed by the customer loyalty program computer system 12. The algorithms include a plurality of steps. Each algorithm step may be performed independently of, or in combination with, other algorithm steps. Portions of the algorithms may be performed by any one of, or any combination of, the components of the system 10. The customer loyalty program computer system 12 includes one or more processors that are programmed to execute the algorithms shown in FIGS. 8-12 and described herein.

In the illustrated embodiment, the customer loyalty program computer system 12 communicates with a distributed blockchain ledger network system 34 to implement the STN Charms™ program. The distributed blockchain ledger network system 34 may include, for example, Ethereum™ blockchain, IBM Blockchain™, Tezos™, Stellar™, and/or any suitable distributed blockchain ledger system that support NFT deployment. The STN Charms program seeks to enhance the customer loyalty program using charms that are awarded to loyalty members for various purposes. Loyalty members will receive benefits based on the charms that they possess and can continue to earn more charms. The charms program is designed so that charms have scarcity that set or increase their value over time. Members will also be able to sell and/or buy casino charm NFTs in an online marketplace, with Station Casinos earning royalties on transactions.

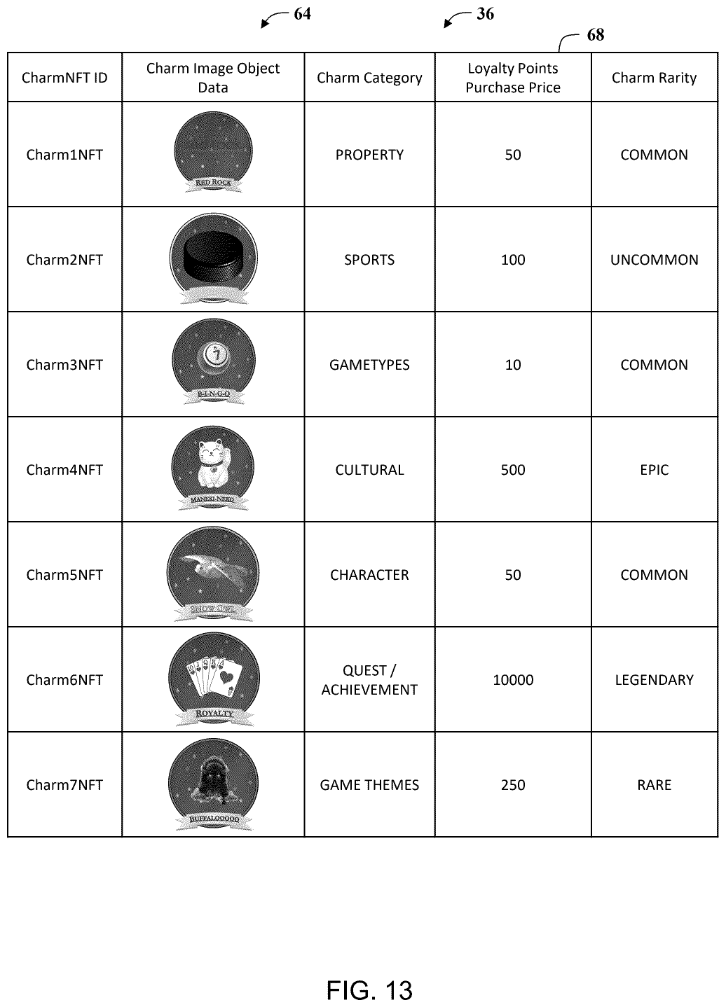

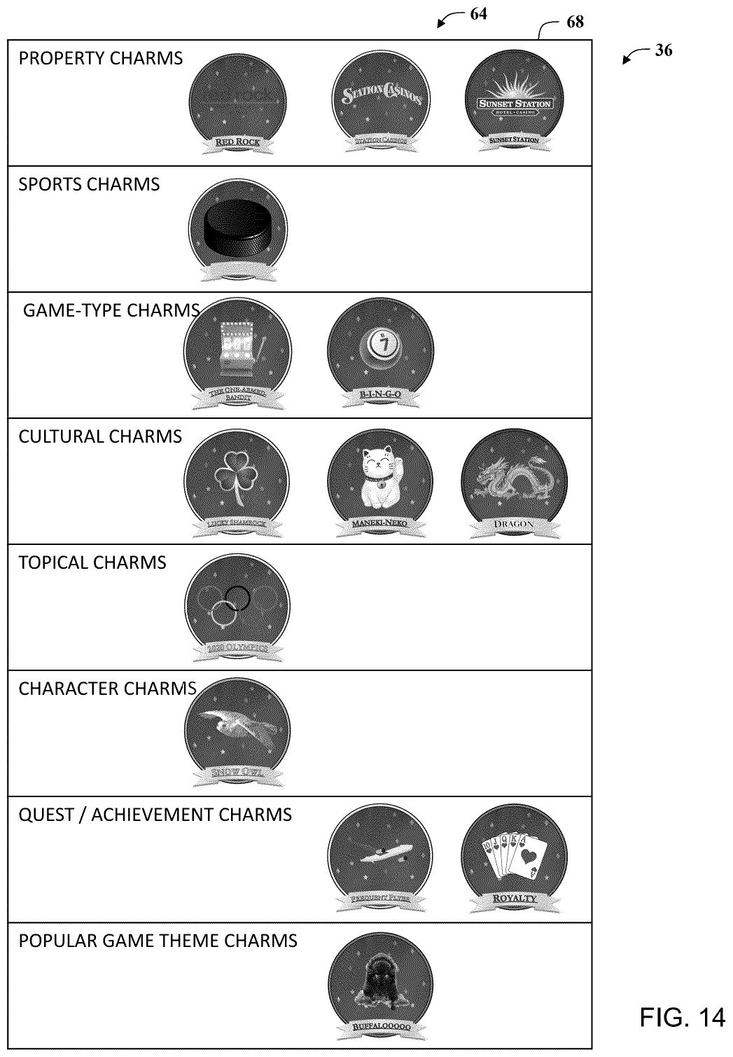

The STN Charms program is implemented using Blockchain technology. Casino charm NFTs 36 (shown in FIGS. 13-16) are modeled as non-fungible tokens (NFTs) that are registered with the blockchain. The customer loyalty program computer system 12 is programmed to mint new charms and award them to members through the blockchain. Transactions involving the charms will also occur using the blockchain. Using blockchain technology to implement STN Charms program brings trust and verifiability to the STN Charms program allowing the customer loyalty program computer system 12 to verify ownership of charms when members receive benefits and providing an audit trail for review.

One mechanism that charms will be awarded to customers is through the accumulation of points. Some channels through which points may be accumulated by members include gaming at a casino, staying at a hotel, or dining in a restaurant. The accumulation of points may be tracked in the blockchain for each member. As the member earns new points, they may cross a level threshold which will automatically award the member a new charm. Point acquisition are recorded in the blockchain.

Members may also earn charms through the completion of quests. A quest is a challenge with an associated goal that is set by the customer loyalty program computer system 12. Members may voluntarily accept a quest and progress through the quest towards achieving the goal. When the goal is achieved, then the desired charms is awarded to them. Quest achievements and rewards are recorded in the blockchain.

The customer loyalty program computer system 12 implements the STN Charms program using a dApp using the blockchain system 34, data stored in the blockchain, and data stored outside of the blockchain.

The STN Charms program includes two primary actors: Casino Operator 40 (e.g., Station Casinos) and Loyalty Members 42 (e.g., casino property guest).

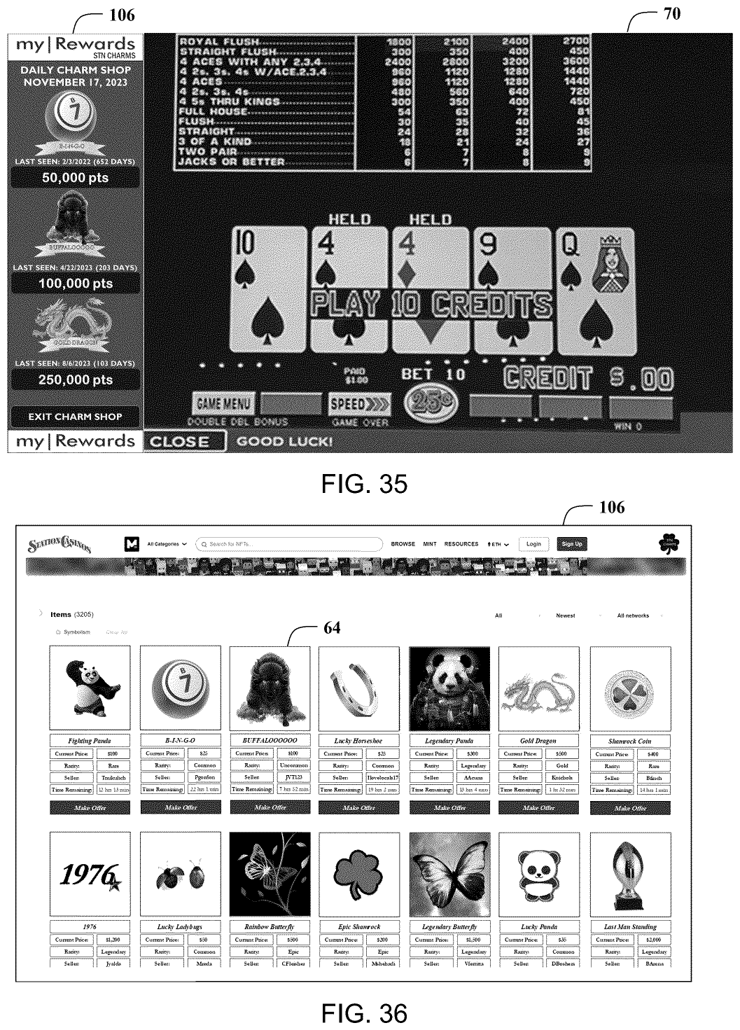

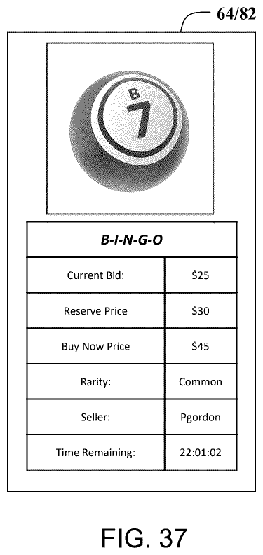

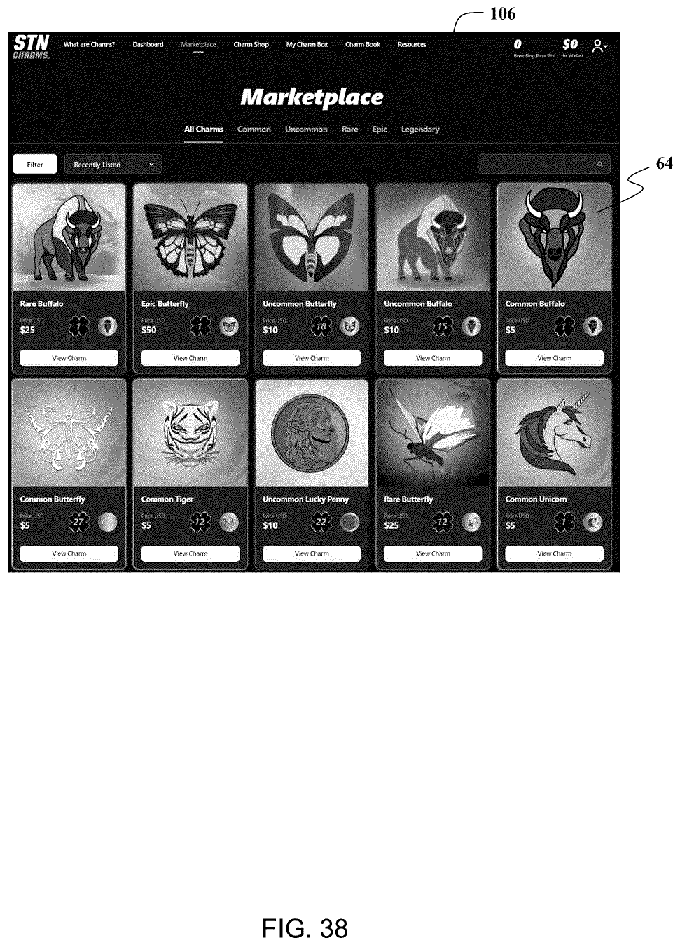

Station Casinos Actor: The Station Casinos actor includes one or more approved administrators that represent the interests of Station Casinos and who are authorized to mint and assign charms to Loyalty Members. The actions that Station Casinos can perform includes: Minting new charms to award to Loyalty Members or to be sold in the Marketplace (shown in FIGS. 35-40); Configuring achievement levels and the charms to be awarded when the Loyalty Member earns enough points; Creating quests that the Loyalty Member can perform and defining the charm that will be awarded to members that complete the quest; and Leveling-up charms and/or increasing a charm luck level; providing a charms shop marketplace to purchase and/or sell NFT charms; and providing additional NFT charms (e.g., charm drops at predefined intervals, e.g., monthly, weekly, daily, etc.) for purchase via the charms marketplace.

Loyalty Member Actor: A Loyalty Member is a customer of Station Casinos that enrolls in the STN Charms program. The Loyalty Member is a frequent customer who wishes to engage with Station Casinos in a richer way and receive benefits from the customer relationship. The Loyalty Member will earn charms by spending time and money in the casino, eating at a restaurant, staying at the hotel, or through other activities. The Loyalty Member is also interested in purchasing new charms to unlock casino benefits or buying and/or selling charms with other members in the Marketplace (shown in FIGS. 35-40).

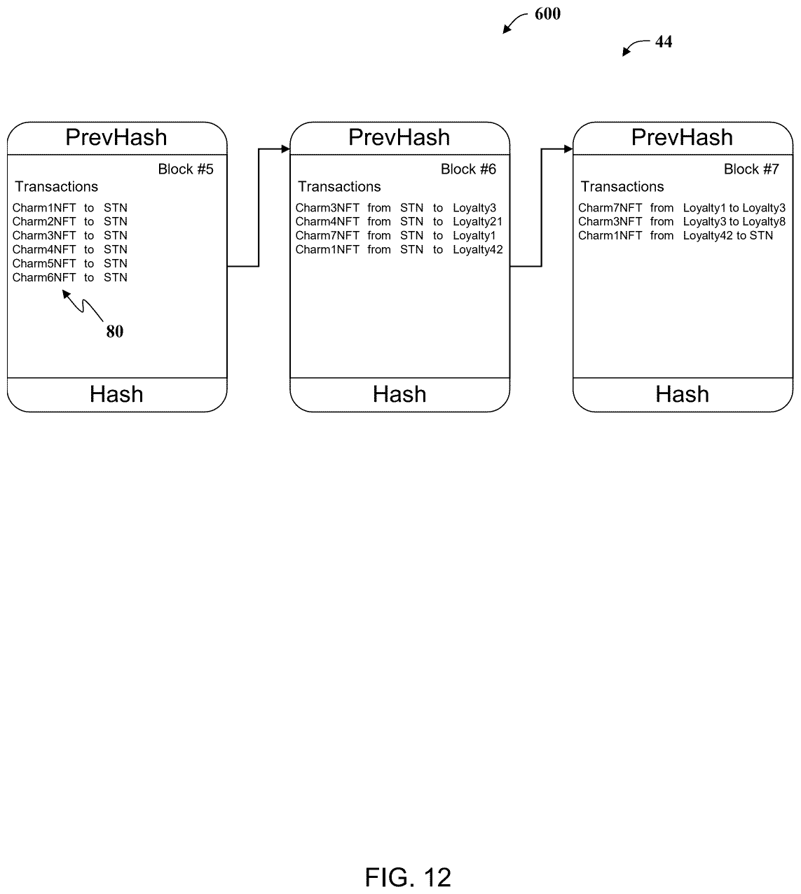

Architecture Overview: The customer loyalty program computer system 12 is programmed to implement the STN Charms program using blockchain technology provided by the blockchain system 34 such as, for example, Ethereum™ blockchain, IBM Blockchain™ Tezos™, Stellar™, and the like. For example, Ethereum™ is a blockchain network fueled by a cryptocurrency named ETH. The blockchain system 34 is a shared, immutable ledger that facilitates the process of recording transactions and tracking assets in a business network. An asset can be tangible (a house, car, cash, land) or intangible (intellectual property, patents, copyrights, branding). The blockchain system 34 includes distributed ledger technology in which all network participants have access to the distributed ledger and its immutable record of transactions. The blockchain system 34 includes a blockchain ledger 44 (shown in FIG. 12) of immutable records in which no participant can change or tamper with a transaction after it's been recorded to the shared ledger. The blockchain 44 acts as a log or ledger of transactions between parties. The blockchain 44, and Ethereum, are decentralized, meaning that there is no single source of failure. The blockchain is implemented by multiple distributed nodes that each control a complete and accurate copy of the ledger at all times. When transactions are added to the blockchain, all of the nodes in the blockchain agree on where in the ledger the transaction will be recorded using a consensus algorithm.

The STN Charms program is implemented using Smart Contract technology following standards established for non-fungible tokens. STN Charms may implement the ERC-721 standard, the ERC1155 multi token standard, and/or any suitable standard for deployment of non-fungible token types. For example, existing standards such as ERC-20 require deployment of separate contracts per token type; the ERC-721 standard's token ID is a single non-fungible index and the group of these non-fungibles is deployed as a single contract with settings for the entire collection; and the ERC-1155 Multi Token Standard allows for each token ID to represent a new configurable token type, which may have its own metadata, supply and other attributes. In one embodiment, the ERC-721 defines a standard contract for representing and transacting non-fungible tokens. STN Charms may specialize its implementation of ERC-721 for the purpose of issuing, managing, verifying, and performing transactions on charms.

The STN Charms smart contract 46 implements the API through which charms are created and managed. The STN Charms smart contract is deployed to the blockchain system 34. All interactions with the STN Charms smart contract 46 are recorded in the blockchain and are part of the public blockchain record where the transactions can be reviewed or audited by all parties. For example, as shown in FIG. 12, the STN Charms smart contract 46 may mint a plurality of casino charm NFTs that are deployed to the blockchain ledger 44 including transition records indicating each casino charm NFTs as originally minted and/or owned by a casino gaming entity such as, for example, Station Casinos™ (shown as “STN” in FIG. 12). In some embodiments, the blockchain ledger 44 may include unique charm NFT IDs (shown as “CharmINFT”, “Charm2NFT”, “Charm3NFT”, etc.) associated with each minted casino charm NFTs.

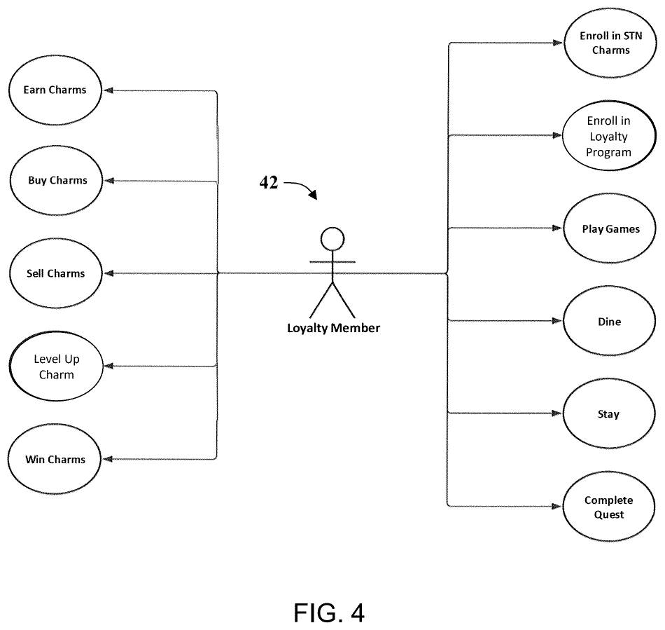

Application Architecture: Loyalty Member-facing applications are built to interact with the STN Charms smart contract (see FIG. 4). An administration application 48 is used by the Station Casinos actor to mint and award new charms to Loyalty Members. A Marketplace application is used to allow Loyalty Members to buy new charms from Station Casinos or other members and/or to sell charms that they own with other members. As the Loyalty Members play games or make use of other services provided by Station Casinos, other systems will use the STN Charms smart contract to award members.

Loyalty Members/Patrons may enroll in the program using a membership application 52 (e.g., a website, mobile application, mobile website, etc.). This application will be where Loyalty Members can come to manage their membership information and update it if necessary. Members are able to view the charms that they have received using information available from the blockchain. Loyalty Members will enroll into the STN Charms program using the membership application.

A marketplace application is created to allow members to buy and/or sell casino charm NFTs. Charms may be advertised on the marketplace for purchase either by Station Casinos or other members. All transactions made through the marketplace are recorded in the blockchain 44.

The marketplace and loyalty member application will make use of third-party wallet software 54 to connect to the blockchain and interact with the STN Charms smart contract to allow users to store and manage casino charm NFTs. In some embodiments, the wallet software 54 may implement a custodial wallet that is owned and maintained by a casino gaming entity for storing ownership information associated with casino charm NFTs. The use of a custodial wallets allows patrons to buy/sell/receive casino charm NFTs without using a personal crypto wallet. In other embodiments, ownership information associated with casino charm NFTs may be held in individual wallets.

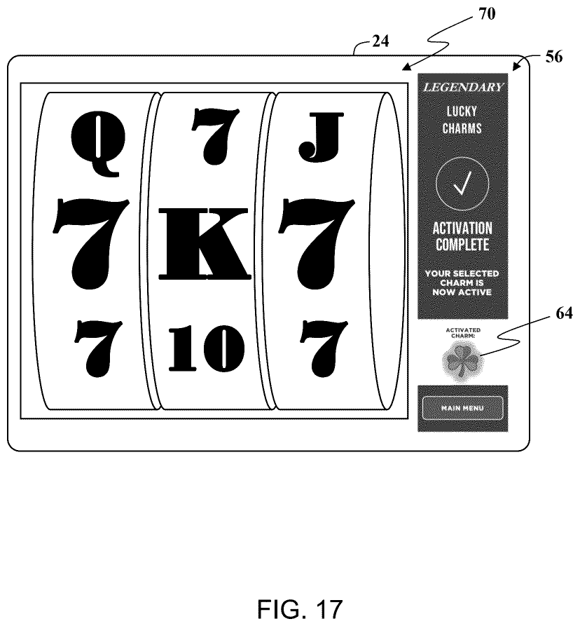

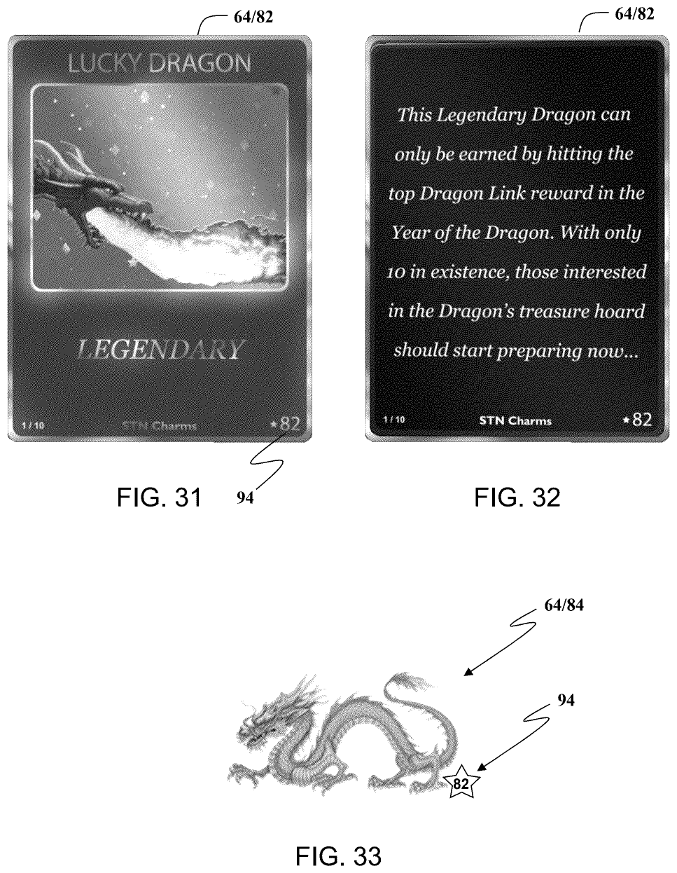

Service Window Architecture: In order to support displaying charm information on the service window 56 of gaming machines 24 (shown in FIGS. 17 and 27-30), a server-based web application 58 is created and deployed to serve HTML content to the service window. The server application will provide read-only query access to the blockchain to query charms awarded or points earned by the Loyalty Member. The information will also be used to query for detailed content about charms from a charm content database 60 using the STN Charms API 62. Images or other multimedia content (shown in FIGS. 13-16 and 31-33) are downloaded from the charm content database 60 over HTTPS through hyperlink URLs returned by the STN Charms API.

The Service Window Server 58 will authenticate to the blockchain using a limited account that supports read-only access, but not execution of transactions. The account will not have any assets of its own and will have limited funds if necessary for performing the query operations against the STN Charms service contract.

This architecture assumes that the Loyalty Member has been authenticated and can be identified using an external mechanism. For example, in some embodiments, the Loyalty Member's identifying information may be injected into the Service Window Server and UI using a mechanism such as a query string parameter when the Service Window initiates the request to the Service Window Server for the content to display in the window.

STN Charms Smart Contract: The STN Charms smart contract implements the backend for the blockchain solution. The smart contract implements operations that record transactions in the blockchain. Transactions include minting charms; awarding charms to members; and/or buying or selling charms.

The STN Charms smart contract is based on the ERC-721 standard for non-fungible tokens1. ERC-721 provides the basic functions for use by the marketplace to transfer ownership of charms as part of buying, selling, trading, or gifting operations. The STN Charms smart contract enhances ERC-721 to add additional options of awarding members points and minting new charms. In other embodiments, the STN Charms smart contract may implement the ERC1155 multi token standard, and/or any suitable standard for deployment of non-fungible token types.

Authentication with the STN Charms smart contract occurs using standard public key cryptographic technology. In one embodiment, both Station Casinos and Loyalty Members will have unique accounts (e.g., wallets) on the blockchain with associated private keys that are used to digitally sign requests sent to the smart contract. When interacting with the blockchain through a web application such as the marketplace, users may be required to have an acceptable third-party wallet application installed that provides an API for the web application to communicate with the blockchain on behalf of the Loyalty Member. In other embodiments, the system 10 may use a custodial wallet owned by the casino entity that may be used to facilitate transactions associated with NFTs on the blockchain system 34.

STN Charms API: The STN Charms API is used to manage charms-related content and other off-chain data for the STN Charms program. The STN Charms API is implemented as a REST API over the HTTP protocol. The STN Charms API is intended to augment and complete the STN Charms Smart Contract by storing and retrieving information that is not necessary to be persisted in the blockchain.

The primary responsibilities for the STN Charms API are: Serve data, images, and other media about charms to be displayed in client applications; Store marketplace data including which charms are for sale; and Store other Loyalty Member information not included in blockchain or CRM.

Authentication and authorization at the API level are performed through JSON Web Tokens (JWTs) that are issued by an (undetermined) authentication service supporting the OAuth 2.0 and OpenID Connect protocols. The authentication service should have a trust relationship with the STN Charms solution. The actual method of authenticating users is not specified in this document.

The STN Charms API should be considered secondary to the Smart Contract. The information stored in the blockchain ledger is the system of record. The information that is available through the STN Charms API is supplementary. For example, a charm is referenced by an ID that is created and managed through a blockchain transaction. The STN Charms API stores content about the charm that is intended for user consumption, but the data does not have its own identity apart from the blockchain representation of the charm.

Operations available from the STN Charms API include: downloading descriptions, logos, images, or links to videos related to charms that are awarded to users; the list of charms that are being offered for sale in the marketplace and at what price the charms are being offered for sale; additional profile information about a Loyalty Member that is kept in neither the blockchain nor CRM service; the list of levels and how many points are required to achieve each level; metadata about quests including content that should be presented to the Loyalty Member to help them to complete the quest.

Referring to FIGS. 13-16 and 31-33, in some embodiments, the system 12 is programmed to generate a plurality of casino charm NFTs 36. Each casino charm NFT 36 may be associated with one or more Charm Categories.

Property Charms: Property charms would be given as a reward for loyalty and play at a certain property, with companywide play earning Stations' charms.

Sports Charms: Sports charms would be earned via special events and by playing at casino properties on the team's gameday.

Gametypes Charms: Gametype charms are earned by earning different thresholds of experience on a certain gametype.

Cultural Charms: Cultural charms are earned through purchasing or by playing on certain ‘Charm Days’, such as St. Patrick's Day for a special shamrock charm.

Topical Charms: Topical charms range from a popular TV character to a pint of beer. These are typically earned as prizes by levelling up or by purchasing from the charm shop.

Quest/Achievement Charms: Charms earned from questing are the result of completing certain tasks and missions. These can vary from a certain number of visits, hitting a certain type of bet, playing various gametypes, etc. In the examples discussed herein, the first charm would be for playing a certain amount of times in a time frame and the second would be a charm earned for hitting various quantities of Royal Flushes.

Popular Game Theme Charms: These charms would be earned by playing a certain theme-such as Buffalo or Lightning Link.

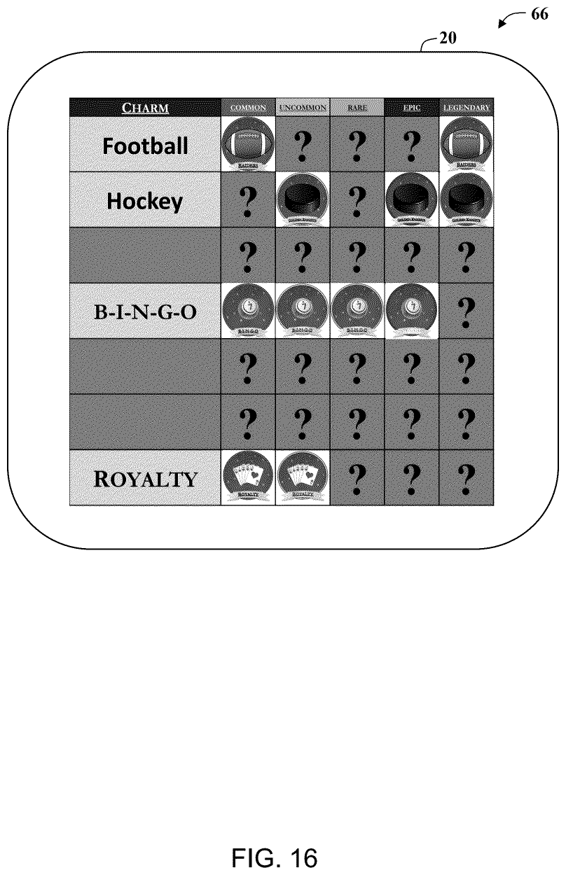

The system 12 may also implement a Charm Book (shown in FIG. 16). A guest's charm book is akin to their trophy room—it is a consolidation of all of the charms they have earned so far (and all of the charms they have yet to earn as well). The charm book serves as a great tool for bragging rights.

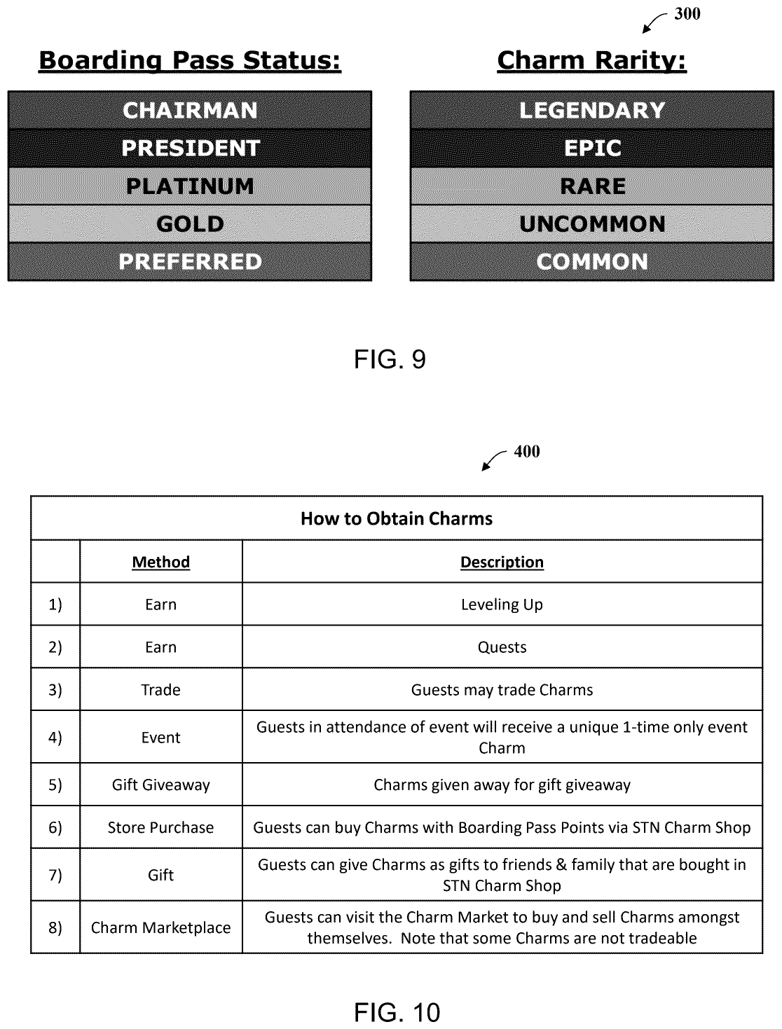

Charm Creation & Rarity: The foundation of Non-Fungible Tokens is that they are non-replaceable, indivisible, and virtually impossible to be tampered with. From the moment of their creation there is a finite number of that NFT, meaning they are not susceptible to inflation, which essentially guarantees their value can only increase over time. Upon creation, a first edition version of each Charm can be kept to strategically implement to maximize each Charm's potential value. For example, as shown in FIG. 9, the system 12 may generate Charms separated into five tiers of rarity that coincide with current Boarding Pass status levels and correspond with their respective color identifiers. Strategic scarcity is fundamental to the Charm economy to ensure incentives for all types of guests. A plethora of ‘Common’ Charms are needed to ensure new guests receive several Charms shortly after joining. After acquiring several lower level Charms and completing quests and achievements, guests would begin to receive fewer Charms as they become more scarce and sought after.

Earning Charms: The system 12 may be programmed to allow Charms to be obtained through a variety of methods shown in FIG. 10.

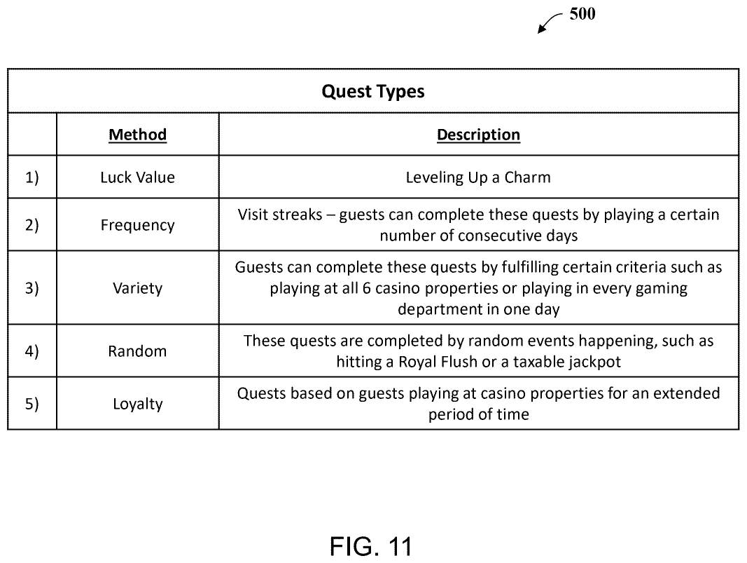

The system 12 may also allow guests to earn Charms through Quests. Quests can be structured in a variety of ways, as shown in FIG. 11.

Charm Scarcity: By ensuring the proper amount of scarcity of each Charm, the system 12 provides a vast spectrum of Charm value to ensure that no guest is priced out of the Charm Market. The Charm Market would be tied to their Charm Account and managed on their mobile devices. This allows guests to buy and sell Charms amongst themselves. Due to the finite nature of NFTs upon their creation, immediate scarcity may be created on Event Charms. An example of this would be giving away a Legendary Event Charm for Chairman guests that play a certain amount at special event. If only 100 Charms are issued, there would never be another chance to earn that Charm, ensuring that those 100 Charms would be rare for perpetuity. To actively promote and incentivize guests to buy/sell as frequently as possible, Quests that can only be completed by having a certain amount of buy/sell transactions completed may be used.

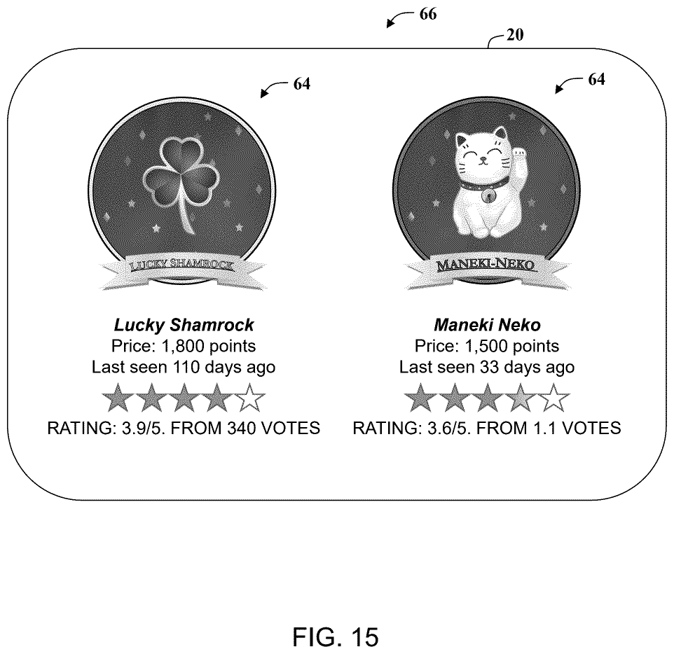

Charm Purchasing: In addition to earning and trading, guests can acquire charms by purchasing them through a daily gift shop using patron loyalty points, e.g., Boarding Pass™ points (shown in FIGS. 15 and 35). Five charms would be available for purchase in the shop for a 24-hour window before being rotated out for another set of five charms. By implementing a ‘last seen’ feature for each charm, demand may increase for charms that normally would not be heavily sought after. Newly minted casino charm NFTs may also be dropped into the daily gift shop for purchase by casino patrons via patron loyalty points.

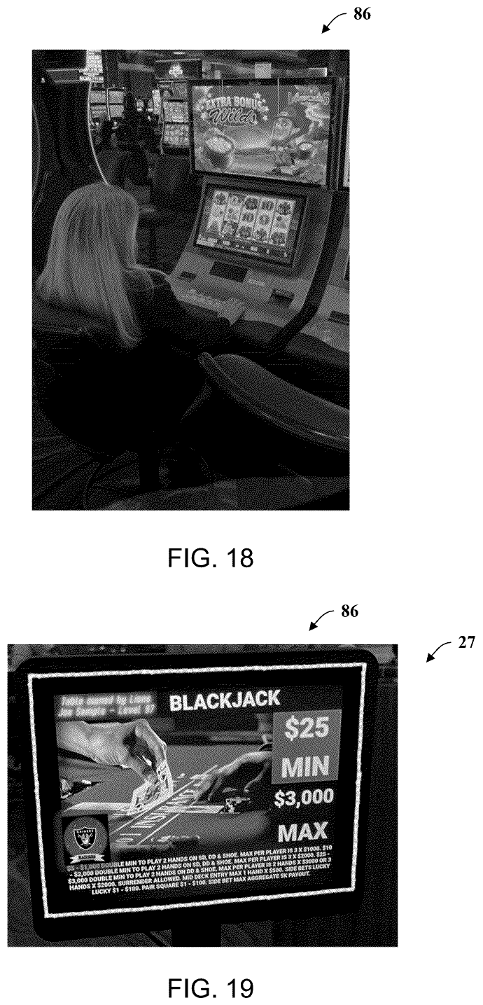

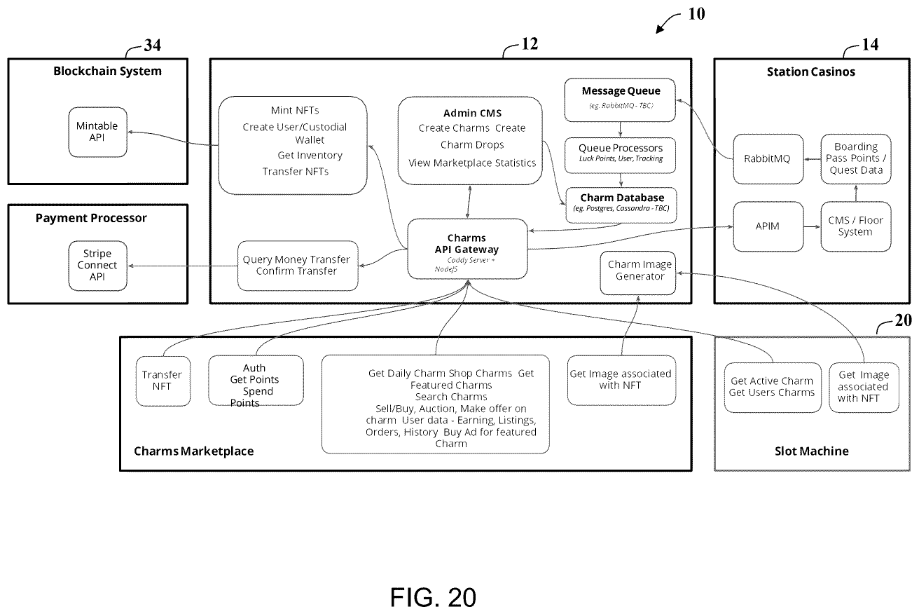

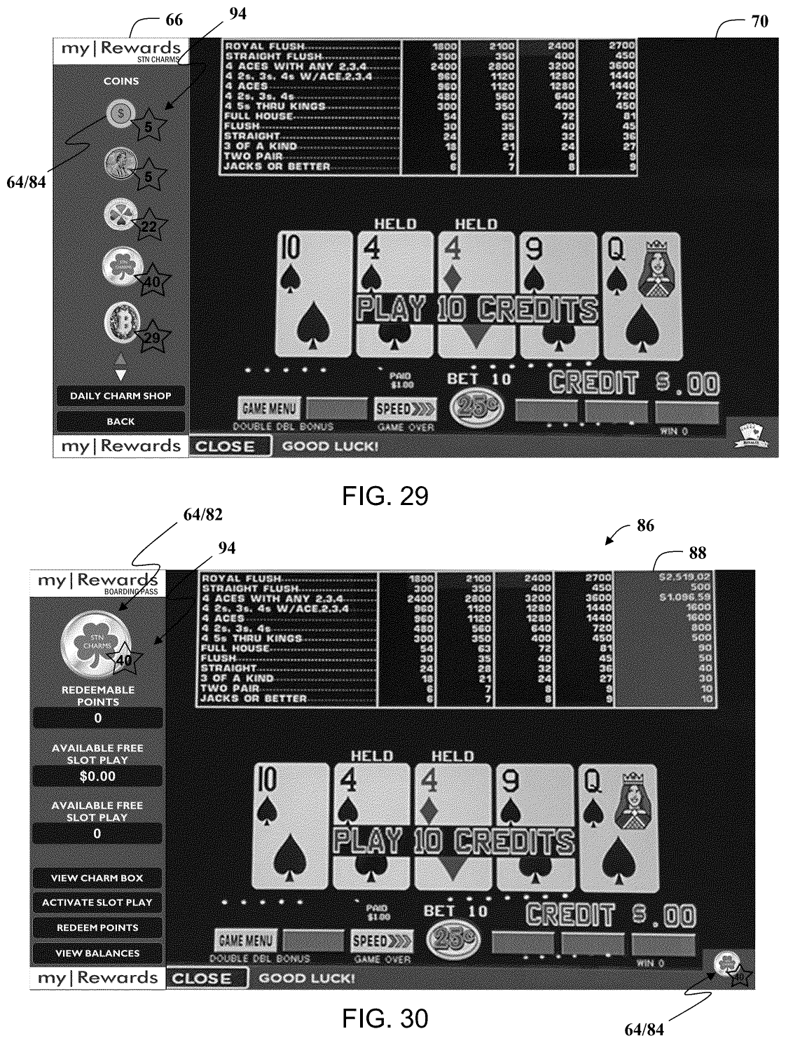

Charm Visibility: One of the keys to STN Charms' success is being able to tap into the psychology of ‘Keeping Up with the Joneses’. The more visibility on the Charms, the more likely guests will view Charms as a status symbol. This concept was effective for current loyalty program but over time there has been a status level inflation and being a Chairman does not provide the same sense of exclusivity as it used to. Some of the methods of promoting the social aspect of STN Charms through Charm visibility are: Charm Activation Visible on Machine (shown in FIGS. 18 and 29); and RGB Bulb in Candle-Color of Charm (shown in FIG. 18). By highlighting the ‘rarity’ of the guest's Charm through the candle, the system 12 can provide better guest service to high end guests while also driving a sense of aspiration for guests that do not have a Legendary Charm.

Guest Experience: The system 12 provides an enhanced guest experience by generating and displaying a User Interface to allow: Activating a charm on a slot machine; Buying/selling charms with another guest; and/or Purchasing charms from the daily shop.

The system 12 includes a Technical Architecture including: Service Window/Banner; Guests' NFT Wallet; Trading Platform; and Shop Platform.

The system 12 may also display Charms associated with Table Games-King of the Hill. Just as different guests gravitate towards certain games and gametypes, their motivations are different as well as the various levers that may be used to entice these guests to play. In Table Games, the ‘keeping up with the Jones’ is largely regulated by table limits. There is also significantly less space to work with as far as displaying any form of charm display. For a variety of reasons, a ‘King of the Hill’ style charm display is most likely the best path forward. The guest at the table who is playing the highest level charm will ‘own’ the table-every minute that the guest owns that table, they are earning luck points and/or increasing a luck value associated with their casino charm NFT. This will likely have a large impact on dead games that frequently sit without a single guest on them (since any guest that hops on one of those tables would automatically ‘own’ the table). For example, as shown in FIG. 19, the system 12 may display guest charms on table game limit signs. In some embodiments, the system 12 may display an image of the highest level casino charm NFT associated with a patron seated at a table game. In other embodiments, the system 12 may display a charm leader board on the table game display systems 27 showing a ranked list of casino charm NFTs associated the players seated at a gaming table.

### Benefits

I. Reduce Guest Reinvestment: Using Boarding Pass Points as the currency of STN Charms, significantly reduces point liability, and even have guests purchasing Boarding Pass Points outright solely for the ability to purchase a Charm that they desired.

II. Drive Incremental/Extended Play: Through various Quest completion criteria or Event Charms, the system can drive extra trips from guests. Guests would also be exposed to new gaming areas they might not typically visit.

III. Migrate Guests to Higher Hold Activity: Strategic Quest design would incentivize guests to play games or place bets that has a higher house advantage than what they might typically play. As an example, a Quest might require a guest to hit a ‘Panda’ Baccarat side bet.

IV. Platform to Reach Younger Guests: The success of social gaming has given clear indication of the value of micro-transactions. Guests around the age of 21 are impaired more by their wallet than their time. They might be unable to come in and spend $200-$300 in a night, but are much more willing to spend $5-$10 to buy a charm or some other micro-transaction. This is great method to introduce them to products and get those guests in the database.

V. Enhanced Data Capture: The system 12 may see an increased number of guests in the database through STN Charms, and benefit from enhanced data capabilities. If guests utilizing the App on their mobile device have location services enabled, the system 12 will be able to track guest locations as they move around the casino to offer greatly enhanced insight into guest behavior. This would be a cost-free way to track guests' non-gaming behavior as well.

VI. Increased, Unpaid Exposure of Casino Brand Via Social Channels: As part of the social aspect of STN Charms, many guests would likely post images of a new charm they acquired. Certain Quests could also require social media posts in order to be completed.

Technology: The STN Charms full functionality may include: Creation of mobile device Application to manage Charms with digital wallet; Integration of NFT (Blockchain) into the service window and/or TFT display on a slot machine; Integration of NFT (Blockchain) into the banner on a slot machine; Implementation of a Charm Economy; Slot Machine Graphics reflecting chosen Charm; RGB Candle light speaking to Charm selection; Numerous graphics needed for creation of Charm graphics, Charm Luck value graphics, and more; Establishing desired scarcity; and Designing Quests.

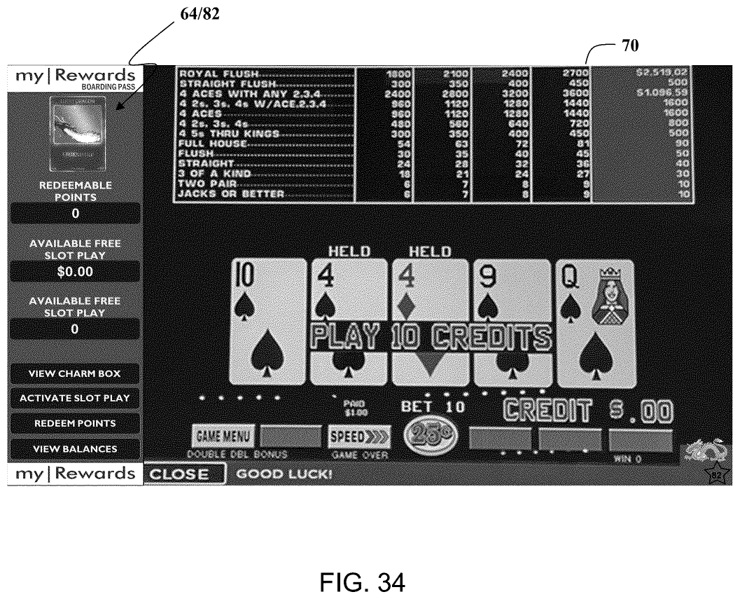

Referring to FIGS. 8-12, in one embodiment, the customer loyalty program computer system 12 includes computer server having a processor programmed to execute algorithms 200-600 to display animated sequences of computer generated images of casino charm NFTs 64 (shown in FIGS. 27-40) on the display devices of gaming devices 20. For example, in algorithm step 202, one or more processors of the customer loyalty program computer system 12 detects a loyalty member login request at a gaming device 20. In some embodiments, the processor 12 may receive a loyalty club member login request signal from a player tracking server 16 indicating a request from a patron to initiate a gaming session at a corresponding gaming device 20. For example, the player tracking server 16 may detect the insertion of a player loyalty club card into a card reader associated with an EGM 24 and receive a signal including a patron ID that is read by from the player loyalty club card from the card reader. In other embodiments, the player tracking server 16 may receive a login request from a player's mobile device 28 including a patron ID and/or a gaming device ID associated with a corresponding EGM 24. The player tracking server 16 may also receive the login request from the EGM 24 including a patron ID wirelessly received by the EGM 24 from a player's mobile device 28.

In algorithm step 204, upon receiving the loyalty club member login request from the patron, the processor 12 queries the blockchain system 34 to identify casino charm NFTs currently owned by the patron. For example, in some embodiments, the processor 12 may query the STN Charms smart contract 46 to identify transitions stored in the blockchain system 34 to identify casino charm NFTs 64 associated with the patron ID indicating ownership of the identified casino charm NFTs 64 by the patron. In other embodiments, the processor 12 may query the custodial wallet 54 to identify casino charm NFTs 64 associated with the patron ID

In algorithm step 206, the processor 12 queries the STN Charms smart contract 46 to identify transitions stored in the blockchain system 34 to identify casino charm NFTs 64 currently owned by the casino gaming entity (shown as “STN” in FIG. 12).

In algorithm step 208, the processor 12 queries the charm content database 60 to retrieve image data associated with identified casino charm NFTs 64 owned by the patron using the STN Charms API 62. The processor 12 may also query the charm content database 60 to retrieve image data associated with identified casino charm NFTs 64 owned by the casino gaming entity.

In algorithm step 210, the processor 12 uses the retrieved image data to render images of the casino charm NFTs 64 on a charm selection screens 66 (shown in FIGS. 15-16 and 27-30) displayed on the corresponding gaming device 20. In some embodiments, the processor 12 may access casino charm NFT data files 68 (shown in FIG. 23) stored in database 60 to retrieve additional information associated with the casino charm NFTs 64. For example, the casino charm NFT data files 68 may include a plurality of records associated with casino charm NFTs 64 including, but not limited to, corresponding charm NFT ID, charm luck value, charm categories, charm rarity, loyalty point purchase price, etc. The processor 12 may then render the charm selection screens 66 to include images of the casino charm NFTs 64 including a category, a rarity, and/or a loyalty point purchase price. The processor 12 may also enable a patron to purchase casino charm NFTs 64 owned by the casino gaming entity using loyalty points via the charm selection screen 66.

In algorithm step 212, the processor 12 receives a patron's selection of a casino charm NFTs 64 owned by the patron via the charm selection screen 66 and renders the image of the selected casino charm NFTs 64 on a game screen 70 (shown in FIGS. 27-30) being displayed on the gaming device 20. For example, the processor 12 may display the selected casino charm NFT 64 in the service window 56 of the gaming device 20.

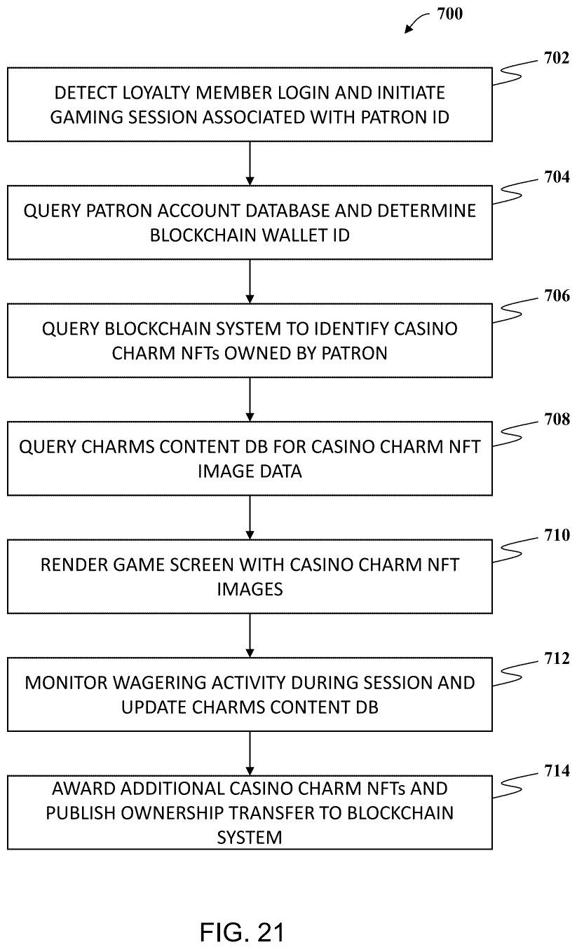

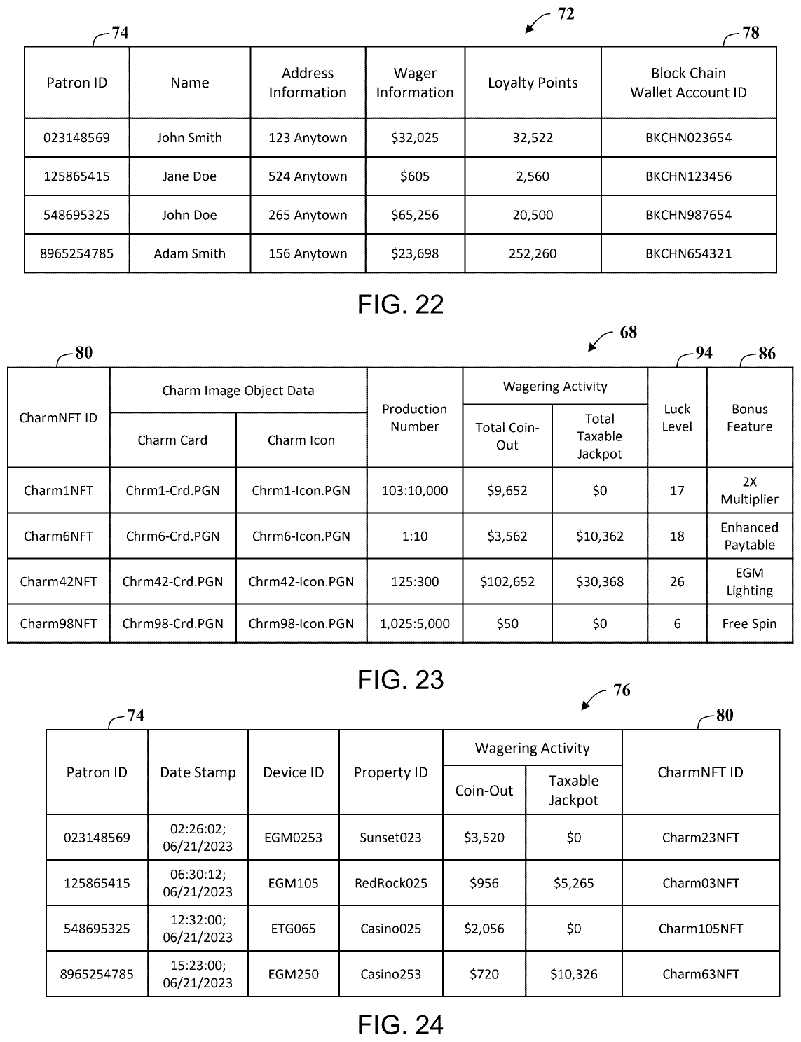

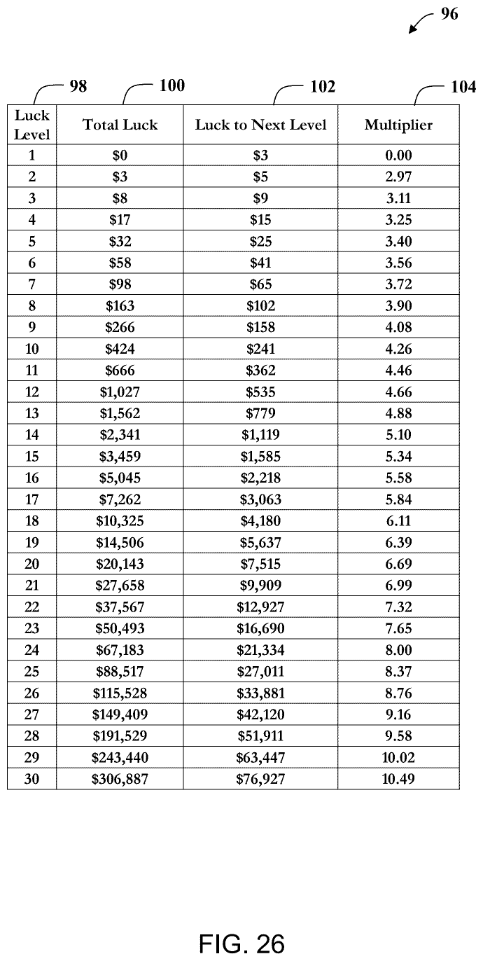

FIG. 21 illustrates algorithm 700 that may be executed by the customer loyalty program computer system 12 to display an animated sequence of computer-generated images of casino charm NFTs 64 on a display device of a corresponding gaming device 20. The algorithm include a plurality of steps. Each algorithm step may be performed independently of, or in combination with, other algorithm steps. Portions of the algorithms may be performed by any one of, or any combination of, the components of the system 10. FIGS. 22-26 illustrate exemplary data files that may be used by the customer loyalty program computer system when executing algorithm 700.

In algorithm step 702, a processor 12 receives a request to initiate a gaming session by a loyalty member/player/patron at a corresponding gaming device. For example, in some embodiments, the processor 12 may receive a gaming session request from a player tracking server 16 including a patron ID 74 read from a player loyalty club card or a mobile device 28 and a gaming device ID associated with a corresponding EGM 24. Upon receiving the patron ID, the processor 12 may query the casino management system server 14 to verify a patron account record 72 (shown in FIG. 22) associated with the received patron ID 74 is stored in a patron account database managed by the casino management system server 14. Upon receiving a verification of an associated patron account record 72, the customer loyalty program computer server may the initiate a gaming session at the corresponding EGM 24 and generate a corresponding gaming session record 76 (shown in FIG. 24).

In algorithm step 704, the processor 12 queries the patron account database to determine a blockchain user account ID 78 associated with the received patron ID. For example, the processor 12 may query the casino management system server 14 to retrieve the patron account record 72 associated with the received patron ID and identify the blockchain user account ID 78 associated with the received patron ID.

In algorithm step 706, upon receiving the identified blockchain user account ID 78 associated with the received patron ID, the processor 12 then queries the blockchain system 34 to identify a casino charm NFT 64 owned by the blockchain user account ID 78. For example, the processor 12 may query the STN Charms smart contract 46 to identify transitions stored in the blockchain system 34 to identify casino charm NFTs 64 owned by the identified blockchain user account ID 78. The blockchain user account ID 78 may include a blockchain wallet ID, Uniform Resource Indicator (URI), or similar identification code, to identify a unique user/owner on the blockchain system 34. In some embodiments, the blockchain user account ID 78 may include a private key that may be used to facilitate transactions via the custodial wallet 54 to facilitate transitions associated with the casino charm NFTs and/or verify ownership of casino charm NFTs.

In algorithm step 708, the processor 12 queries the charms content database 60 to retrieve object image data associated with the identified casino charm NFT 64. For example, in some embodiments, the processor 12 may query the charm content database 60 using the STN Charms API 62 to retrieve object image data associated with the identified casino charm NFT 64. The charm content database 60 may include casino charm NFT data files 68 that include information associated with each casino charm NFT 64 including, for example, a charm NFT ID 80 identifying the casino charm NFT 64, object image data associated with a charm card image 82 and a charm icon image 84 (shown in FIGS. 27, 30, and 31-33), a production number associate each casino charm NFT indicating a total number of minted charm NFTs included in a class or category and the production number of the corresponding casino charm NFT with the class/category, a wagering activity including total coin-out and/or total taxable jackpot amount, a luck level, and a bonus feature.

In some embodiments, the STN Charms smart contract 46 may mint each casino charm NFT 64 deployed to the blockchain ledger 44 to include metadata associated with corresponding object image data, production number, and/or luck level. For example, each STN Charms smart contract 46 may mint each casino charm NFT 64 to include a Uniform Resource Indicator (URI) that includes the corresponding charm NFT ID and points to corresponding information stored in the charm content database 60. For example, each casino charm NFT 64 may include a Uniform Resource Locator (URL) including a web address for locating and retrieving information resources from the charm content database 60 including object image data, production number, and/or luck level associated with the casino charm NFT 64. In some embodiments, when the processor 12 queries the blockchain system 34 to identify a casino charm NFT 64 owned by the blockchain user account ID 78, the processor 12 may then access the URI included with the identified casino charm NFT 64 and access the corresponding object image data, production number, and/or luck level from the charm content database 60 based on metadata included in the retrieved casino charm NFT 64.

In algorithm step 710, the processor 12 renders a game screen 70 on the corresponding EGM 24 including animated computer images of the identified casino charm NFT 64. For example, in some embodiments, the processor 12 may use the server-based web application 58 to serve HTML content to the EGM 24 to display the game screen 70 including a wagering game (e.g., slot reels, video poker, etc.) and the service window 56 being displayed on the EGM 24 (shown in FIGS. 27-30). The processor 12 uses the server application 58 to query detailed content about the casino charm NFTs 64 from the charm content database 60 using the STN Charms API 62. The charm image data 82 and 84 are downloaded from the charm content database 60 over HTTPS through hyperlink URLs returned by the STN Charms API 62 and used to render images associated with the identified casino charm NFT 64 on the service window 56 displayed ion the EGM 24. The processor 12 may also render the charm card image 82 of the casino charm NFT 64 on the service window 56 and render the charm icon image 84 of the casino charm NFT 64 overlaying a portion of the wagering game. In addition, during game play, the processor 12 may remove the service window 56 from the game screen 70 to enable more of the EGM display to be used to display the wagering game while continuing to display the charm icon image 84 of the casino charm NFT 64 on the game screen 70. By displaying an image of the casino charm NFT 64 on the game screen 70, the player is notified that the wagering activity incurred during the gaming session is being associated with the casino charm NFT 64 being displayed during the gaming session. In some embodiments, the charm icon image 84 may be displayed as an interactive 3-dimensional image that is responsive to a player's touch input on the touchscreen of the gaming device 20. For example, the charm card image 82 and/or the charm icon image 84 may be rendered as an animated Graphics Interchange Format (GIF) file, a Joint Photographic Experts Group (JPEG) file, Portable Network Graphic (PNG) file, and the like, which may animate (e.g., a 3D image spinning) when touched by a patron via the touchscreen.

The processor 12 may also implement the algorithm steps of querying the blockchain system 34 to verify the identified casino charm NFT 64 as originally owned by a casino gaming entity and rendering the image of the identified casino charm NFT 64 upon verifying the identified casino charm NFT 64 as originally owned by a casino gaming entity. In this way, the processor 12 implements additional security measures to ensure the casino charm NFT 64 being activated by the player was originally owned/minted by the casino gaming entity.

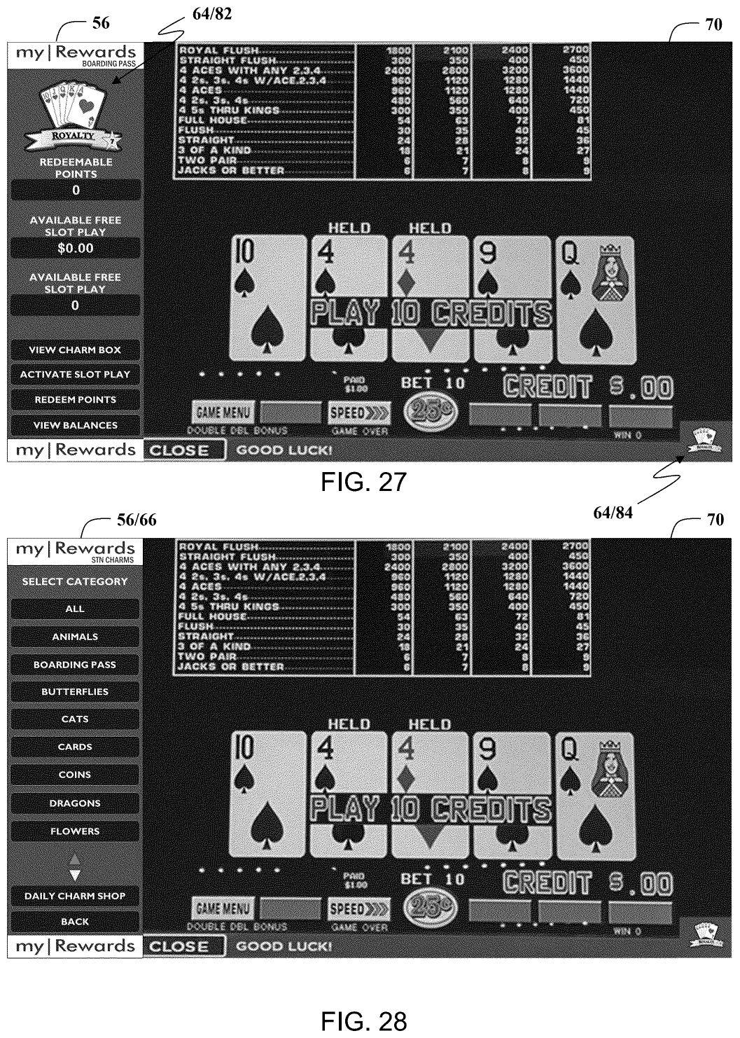

In some embodiments, the processor 12 may be programmed to execute the algorithm including the steps of querying the blockchain system 34 to identify a plurality of casino charm NFTs owned by the blockchain user account ID 78, querying the charms content database 60 to retrieve image data associated with each of the plurality of casino charm NFTs owned by the blockchain user account ID 78, and rendering a charm selection screens 66 (shown in FIGS. 28-30) on the corresponding EGM including images of each casino charm NFT 64. The processor 12 may then allow a player to activate a casino charm NFT 64 on the EGM by receiving a player selection of a casino charm NFT via the charm selection screen 66 and rendering the game screen 70 on the corresponding EGM 24 including an image of the player selected casino charm NFT 64. In some embodiments, the processor 12 may render charm card images 82 of the player selected casino charm NFT 64 on the charm selection screen 66 to notify the player of the currently selected casino charm NFT 64. The processor 12 may also render charm icon images 84 of the other casino charm NFT 64 available for selection by the player, as shown in FIG. 29. Upon receiving the selection of casino charm NFT 64 by the player, the processor 12 activates the selected casino charm NFT 64 on the EGM and renders the charm card image 82 of the casino charm NFT 64 on the service window 56 and the charm icon image 84 of the casino charm NFT 64 overlaying a portion of the wagering game to notify the player that the wagering activity incurred during the gaming session is being associated with the casino charm NFT 64.

The processor 12 may also implement steps to enhance security of the casino charm NFTs 64 when rendering the charm selection screens 66 by querying the blockchain system 34 to identify the plurality of casino charm NFTs 64 owned by the blockchain user account ID 78 and querying the blockchain system 34 to verify each casino charm NFT 64 as originally owned by the casino gaming entity. The processor 12 may then query the charms content database 60 to retrieve object image data associated with each verified casino charm NFTs 64 owned by the blockchain user account ID 78 and render the charm selection screen 66 on the corresponding EGM including images of each verified casino charm NFT 64. The processor 12 may then receive a player's selection of a verified casino charm NFT 64 via the charm selection screen 66 and render the game screen 70 on the corresponding EGM including an image of the player selected casino charm NFT 64.

In some embodiments, the processor 12 may determine a bonus feature associated with the identified casino charm NFT 64 and initiate the determine bonus feature via the EGM 24. For example, in some embodiments, upon receiving the player's selection of the casino charm NFT 64, the processor 12 may query the casino charm NFT data files 68 to determine a bonus feature associated with the player selected casino charm NFT 64. The bonus feature may include, for example, an enhanced paytable, an enhanced EGM lighting feature (e.g., modifying a color of the RGB Bulb in EGM candle, displaying a charm on a table game display, a bonus game, and/or similar enhancements to game play and/or visual/audio displays associated with the gaming device 20. For example, as shown in FIG. 30, upon receiving the player's selection of the casino charm NFT 64, the processor 12 may initiate a bonus feature 86 including an adjustment to the base paytable/return to player (RTP) for the wagering game being played on the EGM 24 such as, for example, modifying a video poker paytable 88, such as changing a Full House payout from 35 à 40 credits (at 5 credits). In addition, having certain casino charm NFTs 64 active would adjust a reward/bonus/RTP via a secondary game such as, for example, unlock a bonus game like the Wheel of Fortune™ which was separate from the base game. In some embodiments, certain casino charms NFTs 64 that are associate with certain categories of Charms that would kick off a bonus event. For example, a certain Charm category would increase a video poker paytable. A full house might pay 35 credits with no Charm active, 36 credits with that category's common charm active, 37 with uncommon charm active, and 40 credits with the Legendary Charm active. Another example might be during a VGK™ game if a VGK™ Charm is active during a gaming session, the processor 12 may render a random hockey themed bonus game on the EGM 24.

In algorithm step 712, the processor 12 associates the gaming session with the displayed casino charm NFT 64, monitors wagering activity occurring during the gaming session, and updates the charm content database 60 to modify casino charm NFT data files 68 associated with the displayed casino charm NFT 64 to include the monitored wagering activity. The wagering activity may include any activity conducted by the gaming device such as, for example, wagers placed/received, loyalty points used, games played, bonuses initiated and/or awarded, quest events such as hitting a Royal Flush or taxable jackpot, and the like. For example, in some embodiments, the processor 12 may initiate the gaming session by generating a unique gaming session record 76 (shown in FIG. 24) associated with the gaming session and associating the identified casino charm NFT 64 with the unique gaming session record 76. The gaming session record 76 may include the patron ID, date/time stamp, device ID identifying the EGM, property ID identifying the casino property in which the EGM is located, wagering activity and the charm NFT ID 80 identifying the casino charm NFT 64 activated during the gaming session. The processor 12 then monitors wagering activity conducted via the corresponding EGM during the gaming session and updates the charms content database 60 to include the monitored wagering activity conducting during the gaming session associated with the identified casino charm NFT. In some embodiments, the player tracking server 16 may monitor waging activity occurring during the gaming session and associate the monitored wagering activity with the casino charm NFT 64 being displayed on the game screen 70. The player tracking server 16 may then send information associated with the gaming session including the waging activity that occurred when the casino charm NFT 64 was displayed on the game screen 70 to the customer loyalty program computer server 12, which then updates the casino charm NFT data files 68 associated with the displayed casino charm NFT 64 to include the monitored wagering activity. In this way, the customer loyalty program computer server 12 monitors wagering activity that incurs when specific casino charm NFTs are displayed on the EGMs 24.

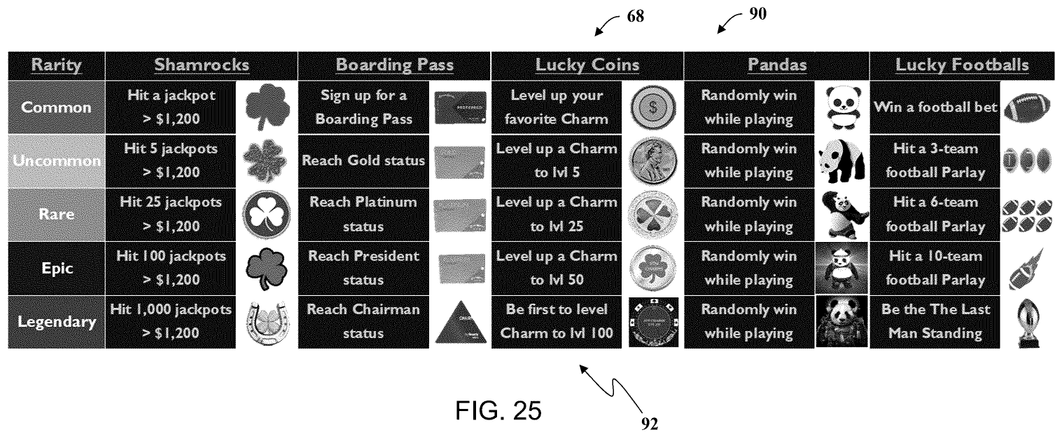

In algorithm step 714, the processor 12 awards additional casino charm NFTs 64 to the player based on wagering activity occurring during the gaming session or cumulative wagering activities being performed by the player. For example, during the gaming session, the processor 12 may execute algorithms 300-500 (shown in FIGS. 9-11) and query a charm award data file 90 (shown in FIG. 25) to determine whether additional casino charm NFTs 64 should be awarded to the player based on monitored wagering activity. For example, charm award data file 90 may include information associated with a variety of wagering activities 92 that may be performed by players/patrons and associated casino charm NFTs 64 that may be awarded if the corresponding wagering activity 92 is achieved by the player. Upon determining that the corresponding wagering activity 92 has been achieved by the player, the processor 12 may query the STN Charms smart contract 46 to initiate a transaction transferring ownership of the awarded casino charm NFT 64 from the casino gaming entity to the player and record the transaction on the blockchain ledger 44.

In the illustrated embodiment, the processor 12 is also programmed to execute the algorithm including the steps of determining a charm luck value 94 associated with the identified casino charm NFT 64 and rendering the images 82, 84 of the identified casino charm NFT 64 including the charm luck value 94. For example, the processor 12 may query the charms content database 60 including the casino charm NFT data files 68 to retrieve the charm luck value 94 associated with the identified casino charm NFT 64 and rendering the images 82, 84 of the identified casino charm NFT 64 including the retrieved charm luck value 94. In addition, when rendering the charm selection screen 66, the processor 12 may query the casino charm NFT data files 68 to retrieve the charm luck value 94 associated with each casino charm NFT 64 owned by the player and display each casino charm NFT 64 with the corresponding charm luck value 94 on the charm selection screen 66. In this way, the player is notified of the charm luck value 94 associated with each casino charm NFT 64 prior to making a selection.

In some embodiments, the processor 12 may also determine the charm luck value 94 based on the wagering activity associated with a corresponding casino charm NFT 64. The processor 12 may query the charms content database 60 including the casino charm NFT data files 68 to retrieve wagering activity associated with the identified casino charm NFT 64 and determine the charm luck value 94 based on the wagering activity associated with the identified casino charm NFT 64. For example, the processor 12 may query the charms content database 60 to retrieve a total coin-out amount associated with the identified casino charm NFT 64 and determine the charm luck value 94 based on the total coin-out amount associated with the identified casino charm NFT 64. The processor 12 may also query the charms content database 60 to determine a taxable jackpot amount associated with the identified casino charm NFT 64 and determine the charm luck value 94 based on the total coin-out amount and the taxable jackpot amount (e.g., $1,200 or more) associated with the identified casino charm NFT 64.

In some embodiments, the processor 12 may determine the charm luck value by querying a charm luck data file 96 being stored in the charms content database 60 including a plurality of ranked charm luck levels 98 with each ranked charm luck level 98 including a total luck value 100. The processor 12 then identifies a highest ranked charm luck level 98 having a corresponding total luck value 100 equal to or less than a sum of the total coin-out amount and the taxable jackpot amount associated with the identified casino charm NFT 64 and displays the determined charm luck value 94 including the identified highest ranked charm luck level 98.

For example, the processor 12 may generate the charm luck data file 96 including each ranked charm luck level 98 including a corresponding numeric luck level value 98, a corresponding total luck value 100, a luck-to-next-level (LNLv) value 102, and a multiplier value 104. The LNLv value may represent a monetary amount such as, for example, a coin-out amount measured in currency, and/or a non-monetary value such as, for example, luck points associated with a coin-out mount. The multiplier value is determined based on the corresponding numeric luck value. The LNLv value is determined based on the multiplier value. The corresponding total luck value is determined as a sum of LNLv values associated with each lower ranked charm luck level 98. In some embodiments, the processor 12 calculates the multiplier value using the following equation:

$$M = {e}^{1 + \text{.045} x} \qquad Equation 1$$

wherein:
M=the multiplier value;
x=the corresponding numeric luck value associated with the corresponding luck level.

The processor 12 may also calculate the corresponding LNLv value using the following equation:

$$LNLv = P * ( 1 + ( ( 1 / M ) * 2.2277 ) ) \qquad Equation 2$$

wherein:
LNLv=the corresponding LNLv value associated with the corresponding luck level;
P=a previous LNLv value associated with a next lower luck level; and
M=the multiplier value associated with the corresponding luck level.

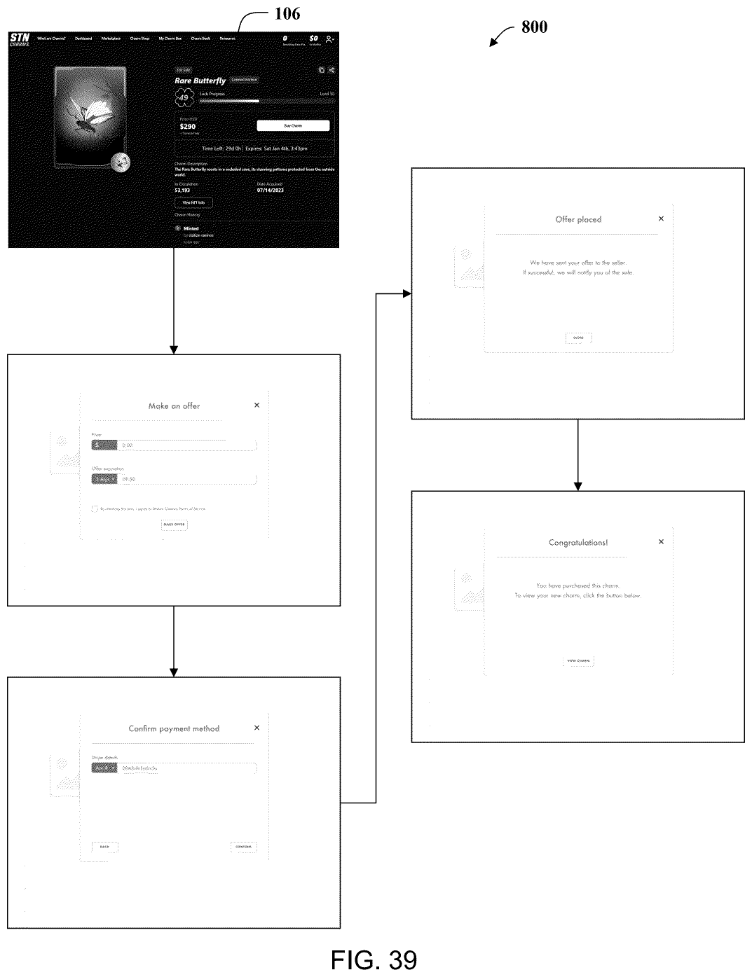

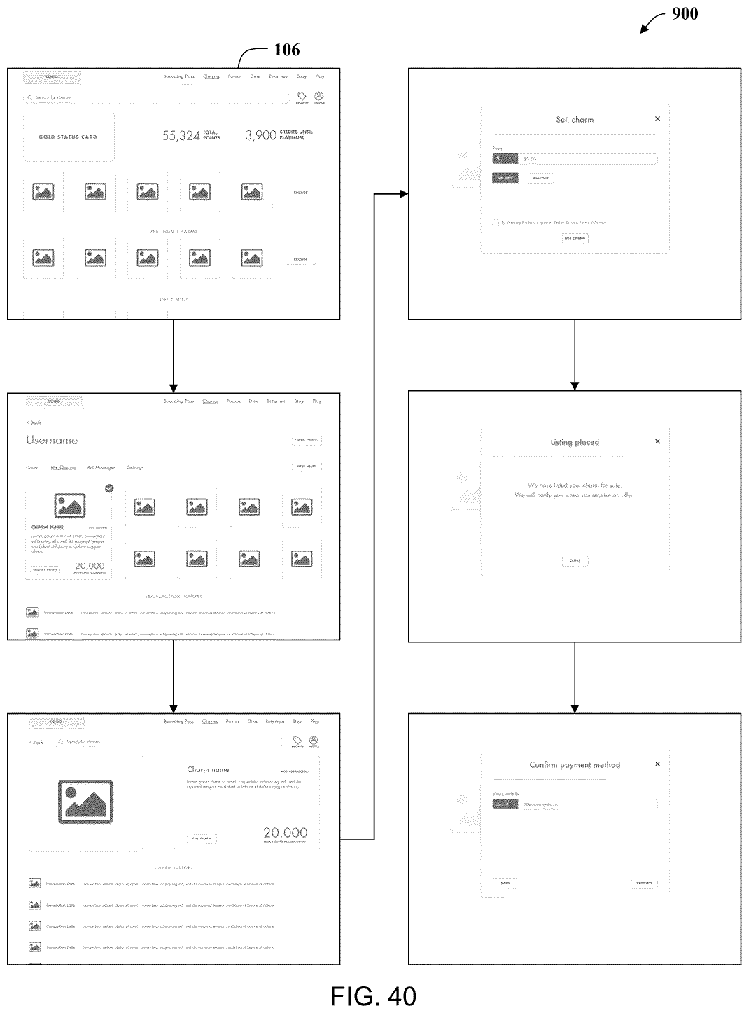

In some embodiments, the processor 12 may also execute the administration application 48 to render a charms marketplace interface screen 106 on gaming devices 20 to allow patrons to sell charms that they own, or buy charms from other members. As the Loyalty Members play games or make use of other services provided by Station Casinos and earn points, other systems will use the STN Charms smart contract to award earned points to members/patrons/players. For example, the processor 12 may render the charms marketplace interface screen 106 and implement algorithms 800 and 900 (shown in FIGS. 39 and 40) to enable members/patrons/players to buy and/or sell casino charm NFTs 64.

In some embodiments, the system 10 also executes algorithms to implement the Random Celebration™ promotions such as, for example, the Wheel-of-Fortune™ Big Time Bonus™ promotional award program, and STN Charms™ promotional award program provided by Station Casinos™ LLC. For example, when executing algorithms to implement the Random Celebration™ promotions and/or the STN Charm™ promotional award program, the system allows patrons to select gaming charms to associate with a patron's gaming session, randomly selects a promotional award charm and provides promotional awards to each patron having a patron selected gaming charm matching the randomly selected promotional award charm. The gaming charm may be, for example, an image of a character, an avatar, a coin, an object, an action, a building, a location, and/or any suitable computer-generated image.

In some embodiments, the system 10 initiates a promotional award period and monitors the gaming and purchasing activities of casino patrons as the patrons are physically located within a casino property to detect qualifying gaming and purchasing activities performed by patrons that qualify the patron for a promotional award. Upon detecting a qualifying promotional event performed by a patron, the system 10 randomly selects a promotional award and associates the randomly selected promotional award with the patron by generating an encrypted escrow account that includes information associated with the patron and the randomly selected promotional award. In addition, the escrowed award record includes a modifiable qualification flag that can be modified to indicate a qualified and unqualified state. The escrowed award record is included in an award escrow data file stored in a database. The system 10 allows patrons to select gaming charms to associated with a patron's gaming session at a gaming device and generates the escrowed award record to include a charm ID associated with the patron selected gaming charm. During the promotional award period, the system 10 continues to monitor the activities of the patron and modifies the qualification flag to the unqualified state upon detecting a disqualification activity performed by the patron.

The system 10 also detects a randomly occurring promotional award trigger event during the promotional period. Upon detecting the promotional award trigger event, the system 10 randomly selects a promotional award charm ID from a charm data file including a plurality of charm IDs, accesses the award escrow data file, and identifies escrowed award records having charm IDs matching the selected promotional award charm ID. The system 10 also identifies gaming devices associated with the identified escrowed award records having matching charm IDs, and displays a bonus game on each identified gaming device. In addition, for each identified escrowed award records having matching charm IDs, the system 10 may also identify those escrowed award records having the qualification flag in the qualified state, generate a notification message associated with each qualified escrow record including the corresponding promotional award, and transmit the notification messages to each patron associated with a qualified escrow account at each of the physical casino property locations. The system 10 accesses patron accounts associated with patrons receiving a promotional award and modifies the corresponding patron account to provide the promotional award to the patron.

The system 10 improves existing casino management systems by generating escrow account data files that include information that allows the system to associate randomly selected promotional awards to qualifying patrons before the promotional awards are provided and/or awarded to the patrons. Because the promotional awards are assigned to the patrons before the award trigger event has been detected, the amount of time and computer resources required to generate and transmit the award notification messages to the patrons is significantly reduced. In addition, the use of the escrow accounts enables the system 10 to simultaneously transmit award notifications to devices located at multiple casino properties, and enable a promotional award to occur simultaneously at each casino property. Moreover, the escrow accounts enables the system 10 to determine a total amount of promotional awards that may be awarded at any time during the promotional period. Only Players that have an active qualified session at the time of the event receive the prize. Awards are randomly selected from a weighted list of prizes. Different patron segments can be configured to allow for different prize configurations which get assigned to one or more marketing customer segmentations.

The system 10 is programmed to implement Flexible Event Triggers including, for example, 3rd Party Bonus Event such as Carded Lucky Coin; Random Selected card in event that hits play level; and/or Random Time Event. The system 10 may also be programmed to implement Patron Qualified Sessions that includes any type of session a player has can be used for the promotion including, for example, Carded Session on a Gaming Machine; Carded Session on a Table Game; Carded Session on a Kiosk; and/or Authenticated Session on a Mobile Device.

Patron Qualifications may include examples including a single or combination of the following: Player belongs to a specific Marketing List (group); Player Plays a Pre-determined level of play; Player begins session on a game that is qualified; Player begins session during a qualified date/time range; Player begins session at a property that is qualified; and/or Player is activity playing for a Pre-determined length of time.

During operation, the system selects a prize at the start of a qualified session to allow for maximum scalability across large number of machines and properties. For example, once a player becomes qualified for a given random celebration promotion, the player's prize is determined and securely escrowed at the time the qualifying event is detected, and will be awarded if the trigger event is hit. All prizes are encrypted and stored within a data store. If the player becomes unqualified before the trigger event, the record becomes unqualified but the system retains a history of all the qualifying sessions throughout the promotion period. Liability can be determined at any given point in time for all qualified players.

The system 10 also executes a Prize Delivery/Notification algorithm including, for example, when the qualified trigger event occurs all qualified players are immediately notified of their prize. Notification can occur as a Promotional Game on the Game Screen, a text message and or notification on their mobile device.

For clarity in discussing the various functions of the system 10, multiple computers and/or servers are discussed as performing different functions. These different computers (or servers) may, however, be implemented in multiple different ways such as modules within a single computer, as nodes of a computer system, etc., The functions performed by the system 10 (or nodes or modules) may be centralized or distributed in any suitable manner across the system 10 and its components, regardless of the location of specific hardware. Furthermore, specific components of the system 10 may be referenced using functional terminology in their names. The function terminology is used solely for purposes of naming convention and to distinguish one element from another in the following discussion. Unless otherwise specified, the name of an element conveys no specific functionality to the element or component.

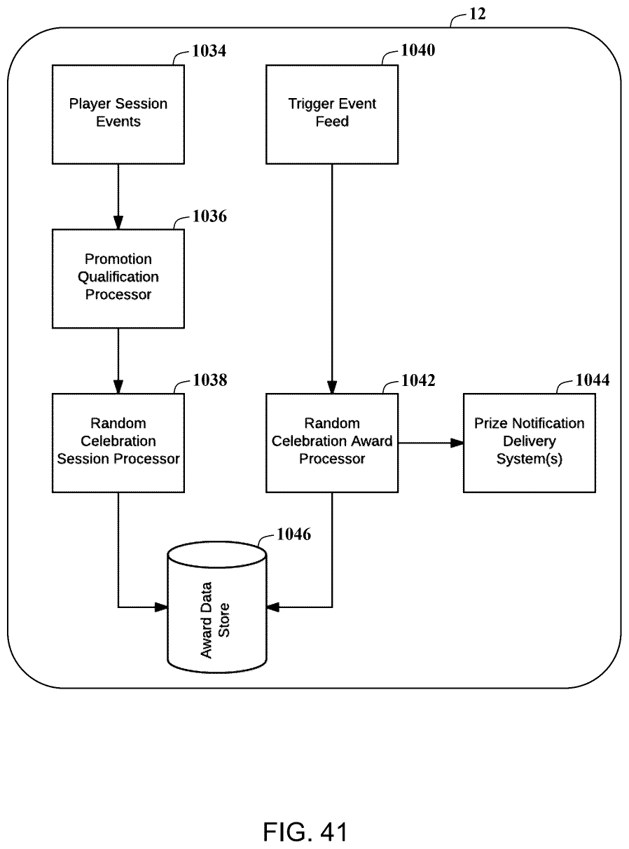

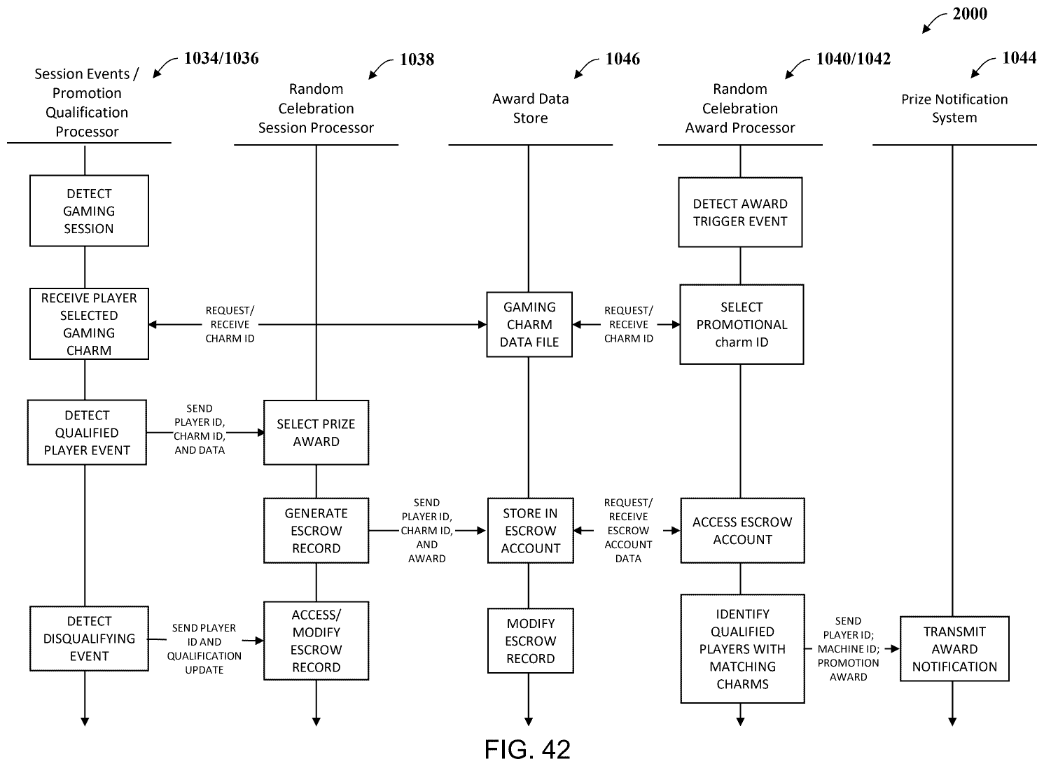

FIG. 41 is a schematic illustrating example components of the customer loyalty program computer system 12. FIGS. 42-45 are flowcharts illustrating the algorithms 2000, 3000, 4000, and 5000 executed by the customer loyalty program computer system 12. The algorithms include a plurality of steps. Each algorithm step may be performed independently of, or in combination with, other algorithm steps. Portions of the algorithms may be performed by any one of, or any combination of, the components of the system 10. The customer loyalty program computer system 12 includes one or more processors that are programmed to execute the algorithms shown in FIGS. 42-45 and 55-59F, and described herein. For example, in the illustrated embodiment, the customer loyalty program computer system 12 includes a player session events processor 1034, a promotion qualification processor 1036, and random celebration session processor 1038, a trigger event feed processor 1040, a random celebration award processor 1042, a prize notification delivery system processor 1044, and an award data store 1046.

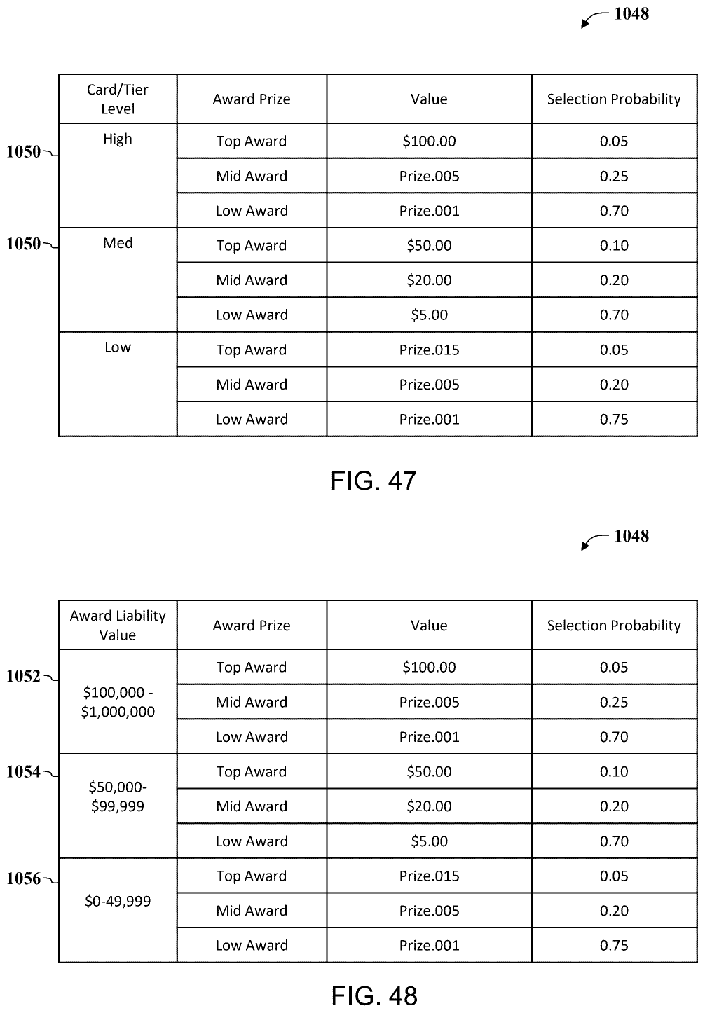

The award data store 1046 includes a memory device that is connected to a database to retrieve and store information contained in the database. In one embodiment, the award data store 1046 maintains a promotional award selection file 1048 (shown in FIGS. 47-48) that includes information associated with a plurality of promotional awards such as, for example, a plurality of promotional award values and corresponding selection probabilities associated with each promotional award value. In addition, promotional award selection file 1048 may include a plurality of tiered groups 1050 that include promotional awards associated with various player card levels. In one embodiment, the promotional award selection file 1048 may also include a plurality of promotional award paytables 1052, 1054, 1056 including a plurality of awards (shown in FIG. 48). In one embodiment, the plurality of promotional award paytables may include including a high-value award paytable 1052, medium-value award paytable 1054, and a low-value award paytable 1056. The high-value award paytable 1052 includes awards having a higher monetary value than awards included in the medium-value award paytable 1054, and the low-value award paytable 1056. The medium-value award paytable 1054 includes awards having a higher monetary value than awards included in the low-value award paytable 1056. In general, the term “award” may be a payout, in terms of gaming credits or money. However, it should be understood that the term award may also refer to other types of awards, including, prizes, e.g., meals, show tickets, etc. . . . , as well as in-game awards, such as free games.

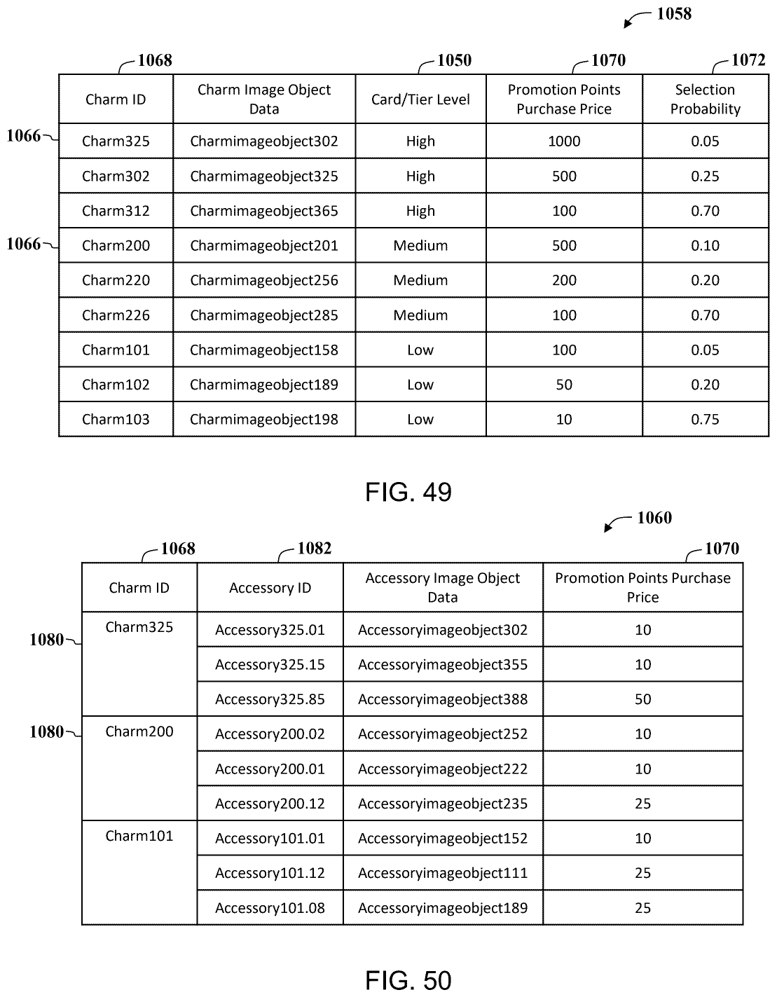

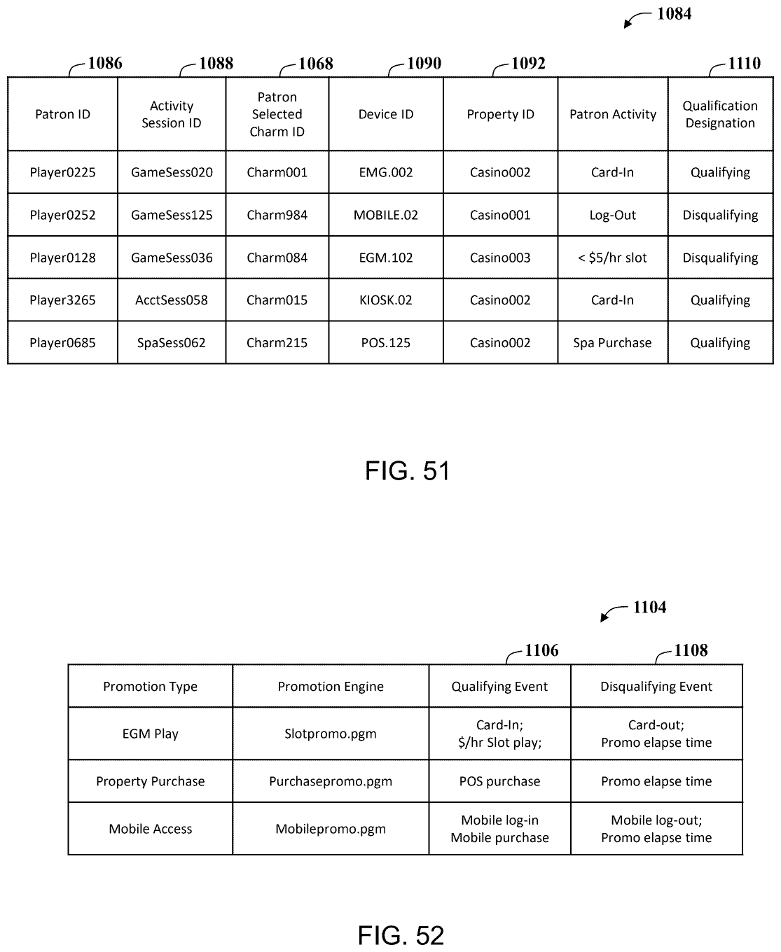

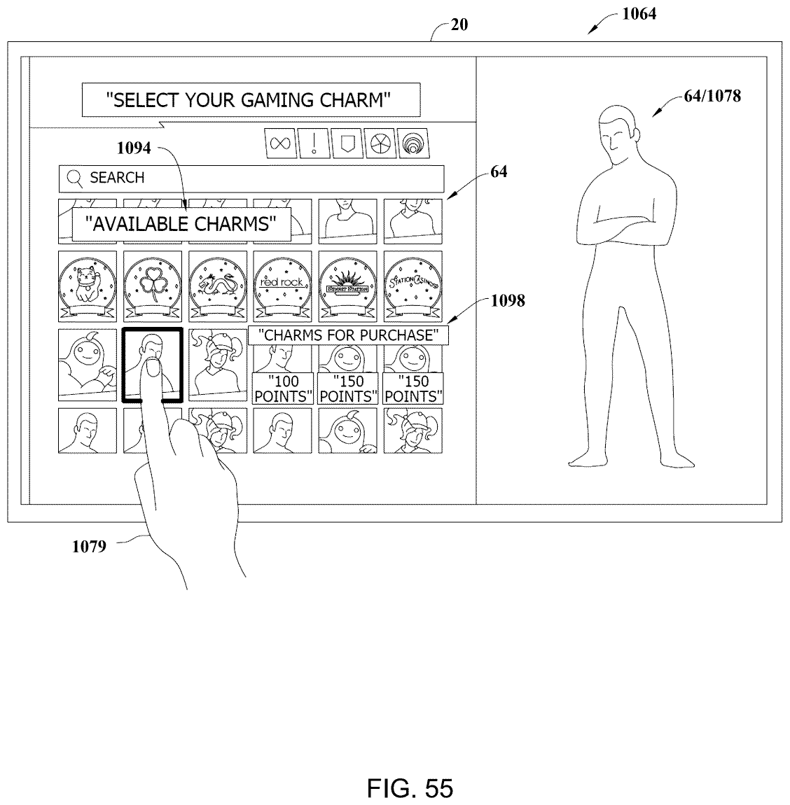

The award data store 1046 also maintains a charm data file 1058 and a charm accessories file 1060 (shown in FIGS. 49 and 50). The charm data file 1058 includes information and data for use in generating gaming charms 64 and a gaming charm selection screen 1064 (shown in FIG. 55) that may be used by a patron to select one or more gaming charms 64 for use during a gaming session. For example, the charm data file 1058 may include a plurality of gaming charm data records 1066 associated with gaming charms 64. Each gaming charm data record 1066 includes information associated with a corresponding gaming charm 64 including a charm ID 1068 and charm image object data for use in generating computer images of the corresponding gaming charm 64. Gaming charm data records 1066 may also include data indicating an associated patron card/tier level 1050, a promotional point value 1070, and a selection probability 1072. The patron card/tier level 1050 indicates gaming charms 64 associated with various player card/tier levels. The promotional point value 1070 indicates an amount of promotional points a patron may use to purchase a corresponding gaming charm 64. The selection probability 1072 indicates a probability the gaming charm 64 may be selected during a promotional award event.

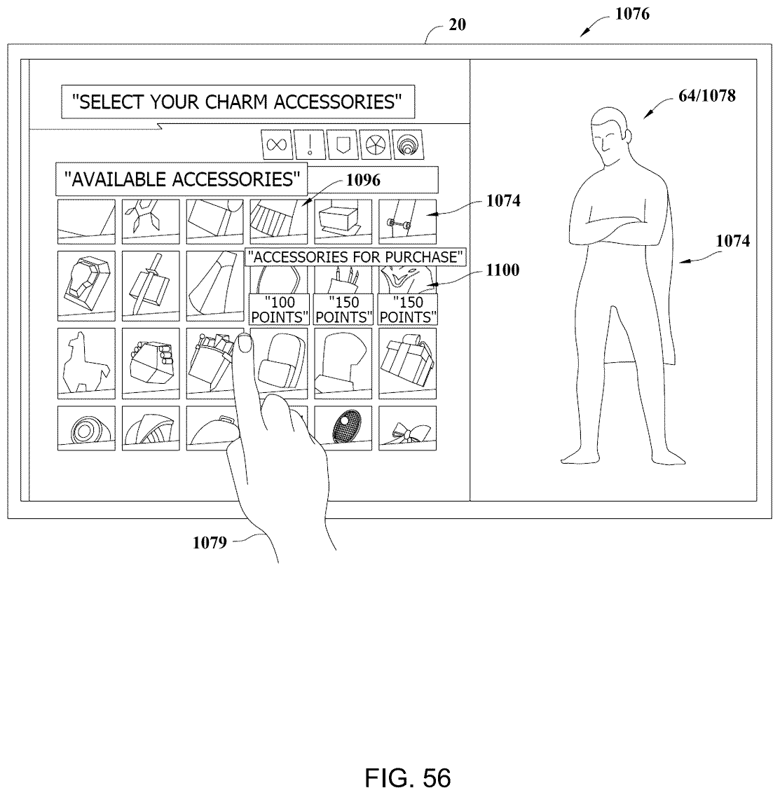

The charm accessories file 1060 includes information and data for use in generating charm accessories 1074 that may be used with gaming charms 64 and a charm accessory selection screen 1076 (shown in FIG. 56) that may be used by a patron to select one or more charm accessories 1074 that may be used with a gaming charm 64. The charm accessory selection screen 1076 may include, for example, a patron selected gaming charm 1078 and a plurality of charm accessories 1074 that may be selected by the patron 1079 for use with the patron selected gaming charm 1078. The image of the patron selected gaming charm 1078 may be modified to include one or more charm accessories 1074 after the patron has selected the corresponding charm accessory 1074. For example, the charm accessories file 1060 may include a plurality of charm accessory data records 1080 associated with gaming charms 64. Each charm accessory data record 1080 includes information associated with charm accessories 1074 including a corresponding charm ID 1068, and accessory ID 1082, and accessory image object data for use in generating computer images of the corresponding charm accessory 1074 and gaming charm 64 including the charm accessory 1074. Charm accessories 1074 may include, but are not limited to, images, objects, characters, actions, emotes, movements, skins, and/or any suitable computer-generated images that may be used to enhance and/or change a visual appearance of a gaming charm 64. Charm accessory data records 1080 may also include data associated with a promotional point value 1070 indicating an amount of promotional points a patron may use to purchase a corresponding charm accessory 1074 for use with a gaming charm 64.

Referring to FIGS. 1, 41, and 42, the player session events processor 1034 is programmed to communicate with the player tracking servers 16 to receive information associated with patron activities within the casino properties 18. In the illustrated embodiment, each player tracking server 16 detects an activity being performed by a patron using a patron tracking ID card and transmits information associated with the patron activity to the player session events processor 1034. For example, in one embodiment, a player tracking server 16 may receive a signal from an EGM 24 indicating a player logging into their player tracking account by inserting a patron tracking ID card into a player tracking device and inputting a corresponding player PIN. Upon receiving a signal from an EGM 24 indicating a player logging into their player tracking account, the player tracking server 16 may also transmit an initial gaming request signal to the player session events processor 1034 indicating a request from a patron to initiate a gaming session at a corresponding gaming device. The gaming request signal may include a patron activity data file 1084 including a Patron ID 74, 1086 received from patron tracking ID card, an activity session ID 1088, a device ID 1090 associated with the EGM 24, and/or a property ID 1092 indicating the corresponding casino property 18.

Upon receiving the initial gaming request signal, the player session events processor 1034 may cause the gaming charm selection screen 1064 (shown in FIG. 55) to be displayed on the corresponding gaming device 20 prompting the patron 1079 to select a gaming charm 64 to associate with the gaming session. The gaming charm selection screen 1064 may include for example, a plurality of gaming charms 64 that may be selected by the patron 1079 and a current patron selected gaming charm 64. For example, in one embodiment, the player session events processor 1034 may transmit a patron account record request to the casino management system server 14 to retrieve information included in a patron account record 1030 associated with the received Patron ID 74, 1086. The patron account record 1030 may include, for example, charm IDs 1068 indicating available gaming charms 1094 associated with the patron such as, for example, gaming charms 64 previously selected by the patron, previously purchased by the patron, awarded to the patron as a promotional award, and/or otherwise available for patron selection. The patron account record 1030 may also include accessory IDs 1082 indicating available charm accessories 1096 associated with available gaming charms 1094 such as, for example, charm accessories 1074 previously selected by the patron, previously purchased by the patron, awarded to the patron as a promotional award, and/or otherwise available for patron selection.

The player session events processor 1034 then retrieves a patron account record 1030 associated with the received Patron ID 74, 1086, determines the charm IDs 1068 included in the retrieved patron account record 1030, retrieves image object data and information associated with the charm IDs 1068 from the charm data file 1058 and displays the gaming charm selection screen 1064 including the available gaming charms 1094 associated with the charm IDs 1068 included in the retrieved patron account record 1030. The player session events processor 1034 may also access the charm data file 1058 to retrieve image object data and information associated with other gaming charms 1098 that are currently unavailable for selection by the patron such as, for example, gaming charms 64 having charm IDs 1068 that are not included in the retrieved patron account record 1030, gaming charms 64 that have not been previously purchased by and/or awarded to the patron. For example, in one embodiment, the player session events processor 1034 may access the charm data file 1058 to retrieve image object data and information indicating gaming charms 64 having a patron card/tier level 1050 matching the card/tier level included in the patron account record 1030, and display the other gaming charms 1098 in the gaming charm selection screen 1064. For example, in one embodiment, the player session events processor 1034 may display a plurality of gaming charms 64 on the gaming charm selection screen 1064 including the available gaming charms 1094 associated with the charm IDs 1068 included in the retrieved patron account record 1030 and unavailable gaming charms 1098. The player session events processor 1034 may also highlight images of the available gaming charms 1094 on the gaming charm selection screen 1064 to indicate the displayed gaming charms 64 that are available for selection by the patron 1079.

The player session events processor 1034 may also access the charm data file 1058 to determine the promotional points required to purchase the unavailable gaming charms 1098, and display one or more unavailable gaming charms 1098 with a corresponding amount of promotional points to purchase a corresponding unavailable gaming charm. In one embodiment, upon receiving a patron selection of an unavailable gaming charm 1098 from the gaming charm selection screen 1064, the player session events processor 1034 may transmit a purchase request signal to the casino management system server 14 including a charm ID and promotional point value associated with the patron selected unavailable gaming charm 1098. The casino management system server 14 may then modify the patron account record 1030 to include the received charm ID 1068 and modify a balance or promotional points included in the patron account record 1030 indicating a purchase of the patron selected unavailable gaming charm 1098. Upon receiving a verification of the purchase of the patron selected unavailable gaming charm 1098 from the casino management system server 14, the player session events processor 1034 may then modify the image of the gaming charm 64 to indicate that the gaming charm 64 is now an available gaming charm 1094 associated with the charm IDs 1068 included in the patron account record 1030, and highlight the image of the available gaming charm 1094 to indicate the gaming charm 64 is now available for selection by the patron 1079.

In one embodiment, player session events processor 1034 may also display the charm accessory selection screen 1076 upon receiving a signal indicating the patron's selection of a gaming charm 64 to prompt the patron to select one or more charm accessories 1074 for use with the selected gaming charm 64. For example, upon receiving a signal indicating the patron selected gaming charm 1078, the player session events processor 1034 may access the charm accessories file 1060 including information indicating a plurality of charm accessories associated with each gaming charm, and identify charm accessories 1074 associated with the patron selected gaming charm 1078. The player session events processor 1034 may, for example, determine the charm ID 1068 associated with the gaming charm 64 selected by the patron via the gaming charm selection screen 1064, access the charm accessories file 1060 to identify the charm accessory IDs 1082 associated with the patron selected charm ID 1068, retrieve image object data and information associated with the identified charm accessory IDs 1082 from the charm accessories file 1060, and display the charm accessory selection screen 1076 including the charm accessories 1074 associated with the identified charm accessory IDs 1082.

In some embodiments, the player session events processor 1034 may also access the patron account record 1030 to identify the charm accessory IDs 1082 included in the retrieved patron account record 1030 and associated with the patron selected charm ID 1068, retrieve image object data and information associated with the identified charm accessory IDs 1082 from the charm accessories file 1060, and display the charm accessory selection screen 1076 including the available charm accessories 1096 associated with the identified charm accessory IDs 1082 included in the retrieved patron account record 1030.

The player session events processor 1034 may also access the charm accessories file 1060 to retrieve image object data and information associated with other charm accessories 1100 that are associated with the patron selected charm ID 1068 and currently unavailable for selection by the patron such as, for example, charm accessories 1074 having charm accessory IDs 1082 that are not included in the retrieved patron account record 1030, and/or charm accessories 1074 that have not been previously purchased by and/or awarded to the patron.

For example, in one embodiment, the player session events processor 1034 may access the charm accessories file 1060 to retrieve image object data and information indicating charm accessories 1074 associated with the patron selected gaming charm 1078, and display the unavailable charm accessories 1100 in the charm accessory selection screen 1076. For example, in one embodiment, the player session events processor 1034 may display a plurality of charm accessories 1074 associated with the patron selected gaming charm 1078 on the charm accessory selection screen 1076 including the available charm accessories 1096 associated with the charm accessory IDs 1082 included in the retrieved patron account record 1030 and unavailable gaming charms 1098 indicating other charm accessory IDs that are associated with the patron selected gaming charm 1078 but are not included in the retrieved patron account record 1030. The player session events processor 1034 may also highlight images of the available charm accessories 1096 on the charm accessory selection screen 1076 to indicate the displayed charm accessories 1074 that are available for selection by the patron 1079.

The player session events processor 1034 may also access the charm accessories file 1060 to determine the promotional points required to purchase the unavailable charm accessories 1100, and display one or more unavailable charm accessories 1100 with a corresponding amount of promotional points to purchase a corresponding unavailable charm accessory. In one embodiment, upon receiving a patron selection of an unavailable charm accessory 1100 from the charm accessory selection screen 1076, the player session events processor 1034 may transmit a purchase request signal to the casino management system server 14 including a charm accessory ID and promotional point value associated with the patron selected unavailable charm accessory 1100. The casino management system server 14 may then modify the patron account record 1030 to include the received charm accessory ID 1082 and modify a balance or promotional points included in the patron account record 1030 indicating a purchase of the patron selected unavailable charm accessory 1100. Upon receiving a verification of the purchase of the patron selected unavailable charm accessory 1100 from the casino management system server 14, the player session events processor 1034 may then modify the image of the charm accessory 1074 to indicate that the charm accessory 1074 is now an available charm accessory 1096 associated with the charm accessory IDs 1082 included in the patron account record 1030, and highlight the image of the available charm accessory 1096 to indicate the charm accessory 1074 is now available for selection by the patron 1079.

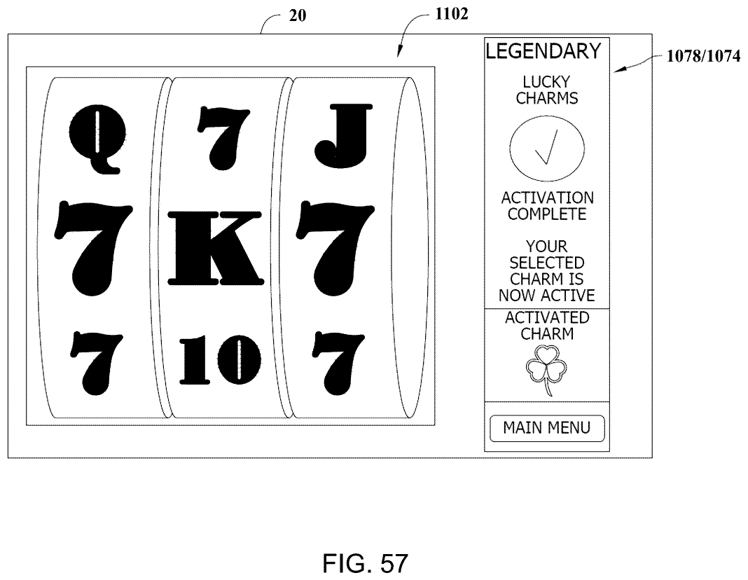

In some embodiments, upon receiving a patron's selection of a gaming charm 64 and/or one or more charm accessories 1074, the player session events processor 1034 may generate instructions including image object data that causes the corresponding gaming device 20 to display a game screen 1102 (shown in FIG. 57) that includes images of the patron selected gaming charm 1078 and/or one or more charm accessories 1074, and transmit the generated instructions including the charm ID 1068 associated with the patron selected gaming charm 1078 to the player tracking server 16 for use in generating and/or modifying the patron activity data file 1084 to include the patron selected charm ID 1068.

In some embodiments, the player tracking server 16 may monitor patron wagering activity at the EGM 24 and transmit information associated with the monitored patron wagering activity to customer loyalty program computer system 12. In one embodiment, for example, the player tracking server 16 may transmit the patron activity data file 1084 associated with the monitored patron activity including the Patron ID 74, 1086 received from patron tracking ID card, the activity session ID 1088 associated with the gaming session, the device ID 1090 associated with the EGM 24, the property ID 1092 indicating the corresponding casino property 18, the charm ID 1068 associated with the patron selected gaming charm 1078 and information associated with the wagering activity such as, for example, an amount of time at the EGM and/or an amount wagered over time. In another example, the player tracking server 16 may detect patron activities including accessing a kiosk 22 or mobile application via a mobile computing device, and/or purchasing goods and/or services via a POS terminal 26, and transmit information associated with the monitored patron activity to the customer loyalty program computer system 12.

The promotion qualification processor 1036 receives the data associated with the monitored patron activity from the player session events processor 1034 and determines whether the monitored patron activity is a qualifying promotional event or a disqualifying promotional event. For example, the promotion qualification processor 1036 may generate and store one or more promotional event data files 1104 in the award data store 1046 with each promotional event data file 1104 including information associated with a promotional event including a list of qualifying events 1106, a list of disqualifying events 1108, and a predefined period of time associated with promotional event. For each monitored patron activity received from the player session events processor 1034, the promotion qualification processor 1036 accesses the promotional event data files 1104 to determine which promotions are currently active, and whether the monitored patron activity is a qualifying event or a disqualifying event associated with a currently active promotion. A qualifying event includes patron activities that qualifies the patron as being eligible to receive an award associated with the corresponding promotion. A disqualifying event includes patron activities that disqualify the patron from being eligible to receive an award associated with the corresponding promotion. For example, in one embodiment a promotion may include qualifying events such as a predefine level of play at a slot machine over a predefined period of time and include disqualifying event such as terminating play at the slot machine or waging less than the predefined level of play. The promotion qualification processor 1036 then designates the monitored patron activity as either qualifying or disqualifying, and transmits information associated with the designated monitored patron activity to the random celebration session processor 1038. In some embodiments, the promotion qualification processor 1036 modifies the received patron activity data file 1084 to generate a designated patron activity data file 1084 that includes a qualification designation tag 1110 and transmits the designated patron activity data file 1084 to the random celebration session processor 1038 that includes a qualification designation tag 1110 indicating whether the patron activity data file 1084 includes a qualifying or disqualifying activity.

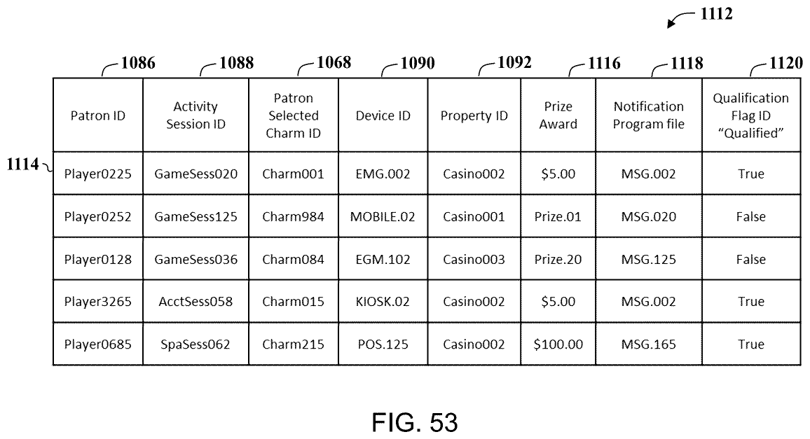

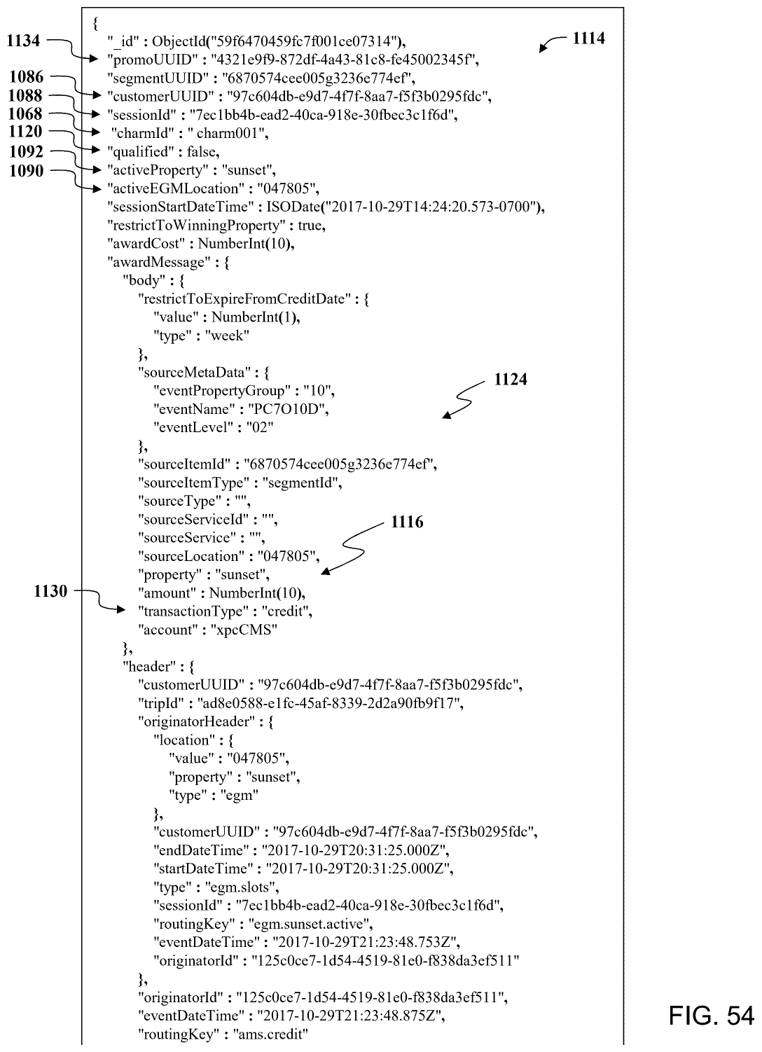

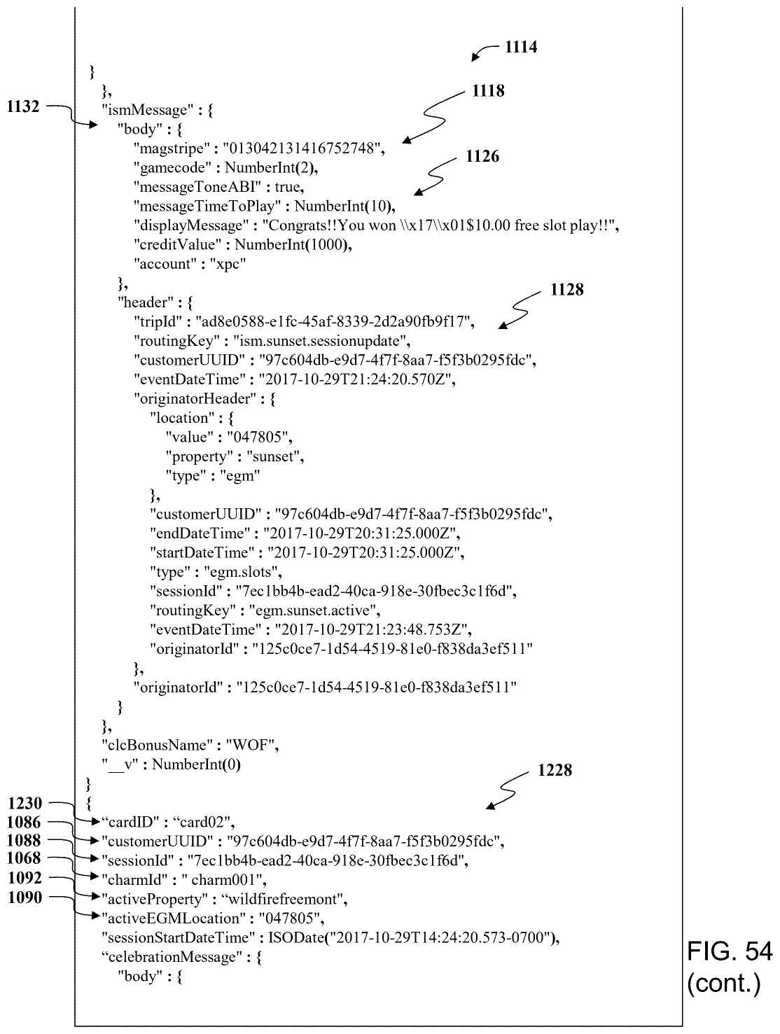

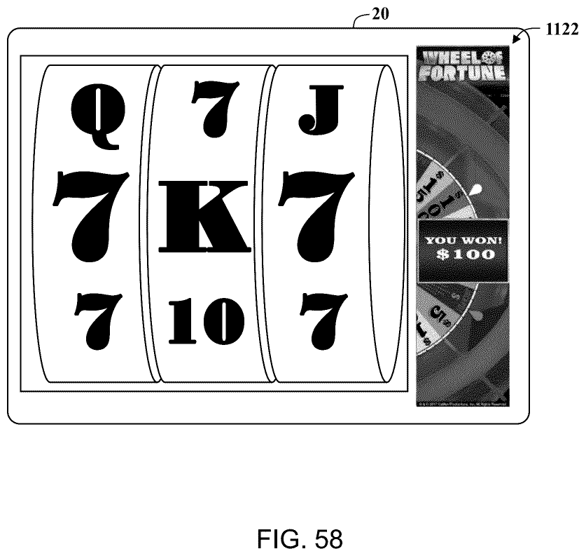

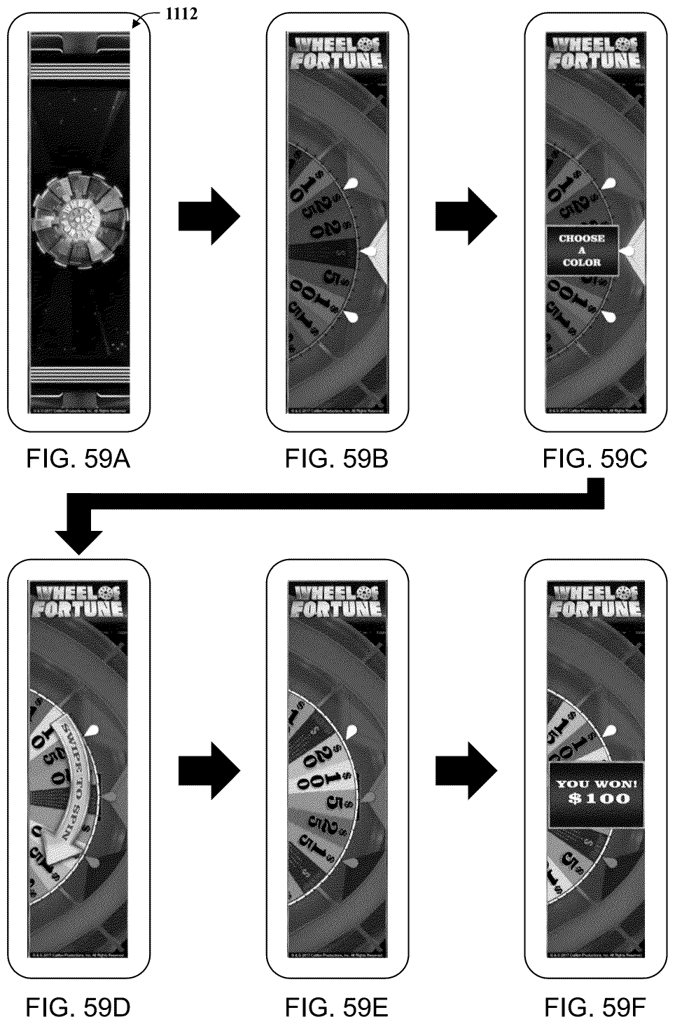

The random celebration session processor 1038 is configured to generate and store encrypted award escrow data files 1112 (shown in FIGS. 53-54) based on the information associated with the designated patron activity data file 1084 that is received from the promotion qualification processor 1036. The award escrow data files 1112 includes a plurality of escrowed award records 1114 that are associated with a promotional award associated with a patron. In one embodiment, the escrowed award records 1114 may include a Patron ID 74, 1086 associated with a patron, a unique activity session ID 1088 associated with the patron activity, a device ID 1090 associated with a corresponding patron computing device, a property ID 1092 associated with a casino property 18, an charm ID 1068 associate with a patron selected gaming charm 1078 used during the gaming session and/or associated with the patron activity, a promotional prize award 1116, a notification program file 1118, and a qualification flag ID 1120. The qualification flag ID 1120 is modifiable to indicate a “qualified” status or a “unqualified” status. The notification program file 1118 may include computer executable instructions for displaying notification images 1122 (shown in FIGS. 58 and 59A-59F) and/or messages on the various gaming devices 20.

In one embodiment, as shown in FIG. 54, the random celebration session processor 1038 is programmed to generate an escrowed award record 1114 in JSON™ programming language including the Patron ID 74, 1086, the session ID 1088, award fulfilment instructions 1124 including the selected promotional award 1116, the property ID 1092, and the device ID 1090, the charm ID 1068 associate with a patron selected gaming charm 1078, the notification program file 1118 including corresponding messaging instructions 1126 including an award notification message 1122, and a corresponding qualification status indicator 1092, i.e., the qualification flag ID, indicating a qualified status. For example, the escrowed award record 1114 may include software code including primary contents: Routing code 1128 for routing to the device and/or property; Prize Fulfillment code 1130 including instructions for How the prize gets processed for the customer; Channel Display code 1132 including instructions for How the delivery will be presented to the customer; and Award Source code 1134 including instruction for determining the source that the prize originated from, e.g., a promotion hit Id.

In the illustrated embodiment, the random celebration session processor 1038 is programmed to receive data associated with a designated patron activity data file 1084 from the promotion qualification processor 1036 and identify the designated patron activity data file 1084 as being qualifying or disqualifying. Upon determining the designated patron activity data file 1084 to be a qualifying activity, the random celebration session processor 1038 accesses a promotional award selection file 1048 being stored in the award data store 1046, selects a promotional award using promotional award selection file 1048, and generates an escrowed award record 1114 to associate the selected promotional award to the patron.

For example, in one embodiment, the random celebration session processor 1038 accesses the patron account records 1030 using the patron ID associated with the designated patron activity data file 1084 and determines a card tier level associated with the patron ID. The random celebration session processor 1038 then accesses the award selection file 1084, determines the tiered group 1050 associated with the determined card tier level, and randomly selects a promotional award included in the determined tiered group.

In one embodiment, the random celebration session processor 1038 may be programmed to determine an award liability value based on qualified escrowed award records include in the award escrow data file 1112, and select a promotional award based on the determine award liability value. For example, as shown in FIG. 48, the award data store 1046 may include the promotional award selection file 1048 having the high-value award paytable 1052, the medium-value award paytable 1054, and the low-value award paytable 1056. Each of the award paytables 1052, 1054, 1056 may be associated with a different award liability value range. When generating the escrowed award record, the random celebration session processor 1038 may be programmed to access the award escrow data file 1112 and calculate the award liability value equal to a sum of the promotional awards included in escrowed award records having qualification status indicator indicating qualified status. The random celebration session processor 1038 then identifies the award paytable having an award liability value range associated with the calculated award liability value, and randomly select a promotional award from the identified award paytable. For example, the random celebration session processor 1038 may select the promotional award from the low-value award paytable 1056 if the determined award liability value is greater than a predefined liability award liability value. In this manner, the random celebration session processor 1038 may adjust subsequent award liability values, and thus adjust the total amount of promotional awards that may be awarded at any given time.

In the illustrated embodiment, upon selecting the promotional award, the random celebration session processor 1038 generates a corresponding escrowed award record 1114 including a qualification flag ID 1120 identifying the corresponding escrowed award record as “qualified”, and stores the corresponding escrowed award record in the award escrow data files 1112. In addition, in one embodiment, the random celebration session processor 1038 generates a notification program file 1118 including instructions for displaying the notification sequence of images shown in FIGS. 59A-59F, and stores the notification program file with the corresponding escrowed award record. For example, the random celebration session processor 1038 may determine a type of patron computing device based on the device ID included with designated patron activity data file 1084 that is received from the promotion qualification processor 1036, and generates and caches the notification program file 1118 including instructions that are executable by the processing device of the corresponding patron computing device. For example, in one embodiment, the notification program file may include software code written in HTML and/or JavaScript for use in generating the notification sequence via webpages being displayed on the kiosk 22 or mobile computing device. In addition, the notification program file may include instruction for display a bonus wheel game (shown in FIGS. 59A-59F) that displays a bonus wheel on a display screen, such as, for example, an EGM display, and prompts the player to select a color and spin the wheel to reveal the promotional prize. In some embodiments, the notification program file includes the property ID and device ID.

In some embodiments, the random celebration session processor 1038 may receive a designated patron activity data file 1084 from the promotion qualification processor 1036 indicating a disqualifying patron activity. Upon determining the designated patron activity data file 1084 to be a disqualifying event, the random celebration session processor 1038 accesses the award escrow data files 1112 and selects an escrowed award record 1114 that includes a Patron ID and/or activity session ID matching the Patron ID and/or activity session ID included in the received designated patron activity data file 1084 and modifies the qualification flag ID included in the selected escrowed award record to indicate a “unqualified” status.

In one embodiment, upon receiving the patron activity data file 1084, the promotion qualification processor 1036 may access the award escrow data files 1112 to identify any existing escrowed award record 1114 having a “qualified” stats and including a Patron ID matching the Patron ID included in the received patron activity data file 1084. The promotion qualification processor 1036 then modifies the received patron activity data file 1084 to include a qualification flag ID indicating a “unqualified” status based on the identified “qualified” existing escrowed award record 1114, and the random celebration session processor 1038 generates a linked escrowed award record 1114 having qualification flag ID indicating the “unqualified” status based on the previously identified “qualified” existing escrowed award record 1114. If, at a later time, the identified “qualified” existing escrowed award record 1114 is modified to “unqualified” status, the random celebration session processor 1038 may also modify the linked escrowed award record 1114 to a “qualified” status. By generating linked escrowed award records 1114, the customer loyalty program computer system 12 may be programmed to prevent an patron from having multiple “qualified” escrowed award records 1114.

In the illustrated embodiment, the trigger event feed processor 1040 is configured to randomly generate a trigger event signal and transmit the trigger event signal to the random celebration award processor 1042. For example, in some embodiments, the trigger event feed processor 1040 may be configured to execute a mystery trigger algorithm that includes randomly selecting a trigger event number from a range of numbers, initiating a counter, and transmitting the transmit the trigger event signal when the counter matches the randomly selected trigger event number. The trigger event feed processor 1040 may also transmit the trigger event signal upon detecting a designated activity such as, for example, a randomly selected period of time, a detected patron activity, or a predefined activity.

In some embodiments, upon receiving the trigger event signal from the trigger event feed processor 1040, the random celebration award processor 1042 is programmed to access the charm data file 1058 and randomly select a promotional award charm ID 1068 from the charm data file 1058. The random celebration award processor 1042 then accesses the award escrow data files 1112 and selects escrowed award records 1114 having patron selected charm IDs 1068 matching the selected promotional award charm ID 1068. The random celebration award processor 1042 then retrieves the notification program files and corresponding device IDs from each selected escrowed award record 1114 and transmits a notification data file including the notification program files and the device IDs to the prize notification delivery system processor 1044.

The random celebration award processor 1042 may also select escrowed award records 1114 having patron selected charm IDs 1068 matching the selected promotional award charm ID 1068 and having a qualification flag ID indicating a “qualified status”. The random celebration award processor 1042 then retrieves the notification program files and corresponding device IDs from each selected escrowed award record having patron selected charm IDs 1068 matching the selected promotional award charm ID 1068 and having a qualification flag ID indicating a “qualified status”, and transmits a notification data file including the notification program files and the device IDs to the prize notification delivery system processor 1044. Upon receiving the notification data files from the random celebration award processor 1042, the notification delivery system processor 1044 is programmed to identify each patron computing device based on the corresponding device IDs, and transmit the notification program files to each identified patron computing device which cause each patron computing device to display a prize notification to the corresponding patron. The notification delivery system processor 1044 is also programmed to transmit the notification program files to each identified patron computing device such that each prize notification is displayed substantially simultaneously to each corresponding patron location at each casino property 18.

In some embodiments, upon receiving the trigger event signal from the trigger event feed processor 1040, the random celebration award processor 1042 is programmed to access the award escrow data files 1112, identify escrowed award records 1114 having patron selected charm IDs 1068 matching the selected promotional award charm ID 1068 and having qualification flag ID indicating a “qualified status”, and generate a promotion award file including each selected escrowed award records 1114 having qualification flag ID indicating a “qualified status”. The promotion award file may then be used to generate and/or transmits a notification data file including the notification program files and the device IDs to the prize notification delivery system processor 1044, without affecting the award escrow data files 1112. This allows the random celebration session processor 1038 to continually update the award escrow data files 1112 to include new escrowed award records 1114 and/or modify existing escrowed award records 1114 as the prize notification delivery system processor 1044 delivers the notification messages. In some embodiment, upon receiving the trigger event signal the random celebration award processor 1042 queries notification program files associated with escrowed award records 1114 having patron selected charm IDs 1068 matching the selected promotional award charm ID 1068 and having qualification flag ID indicating a “qualified status”, and transmits the queried notification program files to the prize notification delivery system processor 1044, which then uses the property ID included in each notification program file to route the notification program files to the corresponding player tracking servers 16 for use in distributing the notification program files to the corresponding user devices based on the device ID included in each notification program file.

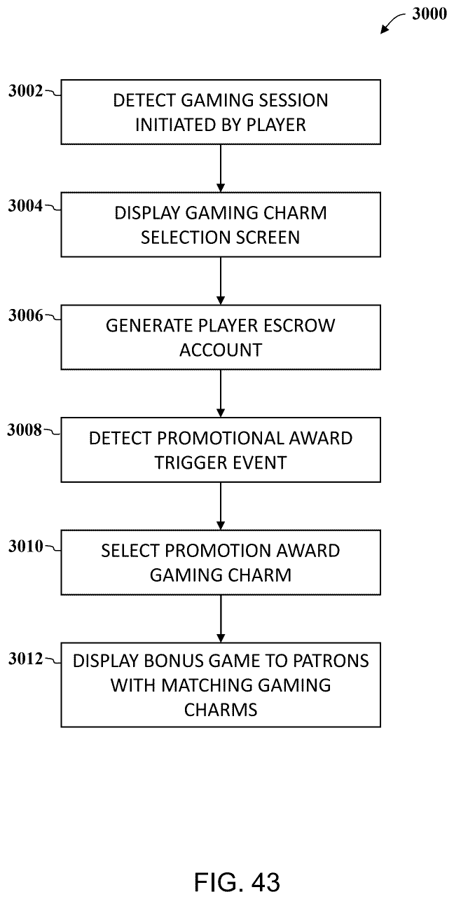

With reference to FIGS. 43-45, in the illustrated embodiment, the customer loyalty program computer system 12 may be programmed to execute the algorithms 3000, 4000, and 5000 for providing promotional awards to casino property patrons. The algorithms include a plurality of steps that may be performed independently of, or in combination with, other algorithm steps. Portions of the algorithms may be performed by any one of, or any combination of, the components of the customer loyalty program computer system 12.

In the illustrated embodiment, the customer loyalty program computer system 12 is coupled to a plurality of player tracking servers 16. Each player tracking server 16 is located at a different casino gaming property and is coupled to a plurality of gaming devices 20. Each player tracking server 16 is configured to detect patron activity at the gaming devices 20 and transmit data indicating the patron activity to the customer loyalty program computer system 12. One or more processors of the customer loyalty program computer system 12 are programmed assign promotion awards to the patron based on the patron activity and to generate and store the award escrow data file 1112 in the award data store data store 1046. The award escrow data file 1112 includes the plurality of escrowed award records 1114. Each escrowed award record 1114 includes patron information including a patron ID and a unique session ID, award fulfilment instructions, messaging instructions, and a qualification status indicator indicating at least one of a qualified status and an unqualified status. The award escrow data file 1112 is used to provide the escrowed promotional awards to patrons that are then awarded to patron when a trigger event is later detected.

In algorithm step 3002, one or more processors of the customer loyalty program computer system 12 detect a gaming session being initiated by a patron. For example, the processor may receive a gaming request signal from a player tracking server 16 indicating a request from a patron to initiate a gaming session at a corresponding gaming device 20. The gaming request signal may include a Patron ID 74, 1086 associated with the patron, a device ID 1090 associated with the corresponding gaming device, and a session ID 1088 associated with the gaming session.

In algorithm step 3004, the processor 12 transmits instructions to cause a gaming charm selection screen 1064 to be displayed on the gaming device to prompt the patron to select a gaming charm 64 to associate with the gaming session. For example, the processor may retrieve a patron account record 1030 associated with the corresponding Patron ID 74, 1086, determine charm IDs 1068 that are included in the retrieved patron account record 1030, retrieve image object data from a charm data file 1058 indicating available gaming charms 1094 associated with the charm IDs 1068 included in the retrieved patron account record, and display available gaming charms 1094 on the gaming charm selection screen 1064.

In some embodiments, the processor 12 may display a plurality of gaming charms 64 on the gaming charm selection screen 1064 including the available gaming charms 1094 associated with the charm IDs 1068 included in the retrieved patron account record 1030 and unavailable gaming charms 1098. The processor may also highlight images of the available gaming charms 1094 on the gaming charm selection screen 1064. The processor may also display one or more unavailable gaming charms 1098 with a corresponding amount of promotional points to purchase a corresponding unavailable gaming charm 1098.

The processor 12 may also transmit instructions to cause a charm accessory selection screen 1076 to be displayed on the gaming device upon receiving a signal indicating the patron selected gaming charm 1078. For example, the processor may, upon receiving the patron selected gaming charm 1078, access a charm accessories file 1060 including information indicating a plurality of charm accessories 1074 associated with each gaming charm 64, and identify charm accessories 1074 associated with the patron selected gaming charm 1078. The processor may then display the charm accessory selection screen 1076 including the identify charm accessories 1074 associated with the patron selected gaming charm 1078 prompting the patron to select one or more of the identified charm accessories 1074 for use with the selected gaming charm 64. In some embodiments, the processor may display the charm accessory selection screen 1076 including available charm accessories 1096 and unavailable charm accessories 1100 associated with the selected gaming charm 64. The processor may also highlight images of the available charm accessories 1096 and/or display unavailable charm accessories 1100 with a corresponding amount of promotional points to purchase a corresponding unavailable charm accessory 1100.

In algorithm step 3006, the processor 12 receives a patron selected gaming charm 1078 and responsively generates an escrowed award record 1114 in the award escrow data file 1112 stored in a data store 1046. The escrowed award record 1114 may include the session ID, the patron ID, the device ID, and a charm ID associated with the patron selected gaming charm 1078.

In algorithm step 3008, the processor of the customer loyalty program computer system 12 is programmed to detect a promotional award trigger event and initiation a promotional award event algorithm to simultaneously display a bonus game on each gaming device having a patron selected gaming charm 1078 matching a randomly selected promotional award gaming charm.

In algorithm step 3010, upon detecting the promotional award trigger event, the processor 12 randomly selects a promotional award charm ID 1068 from the charm data file 1058 that includes a plurality of charm IDs.

In algorithm step 3012, the processor 12 accesses the award escrow data file 1112 and identifies escrowed award records 1114 having patron selected charm IDs 1068 matching the randomly selected promotional award charm ID 1068. The processor then identifies gaming devices having device IDs 1090 associated with the identified escrowed award records 1114 and displays a bonus game on each of the identified gaming devices. For example, in one embodiment, for each identified escrowed award records having patron selected charm IDs matching the randomly selected promotional award charm ID, the processor executes the corresponding messaging instructions to display the bonus game on each corresponding gaming device.

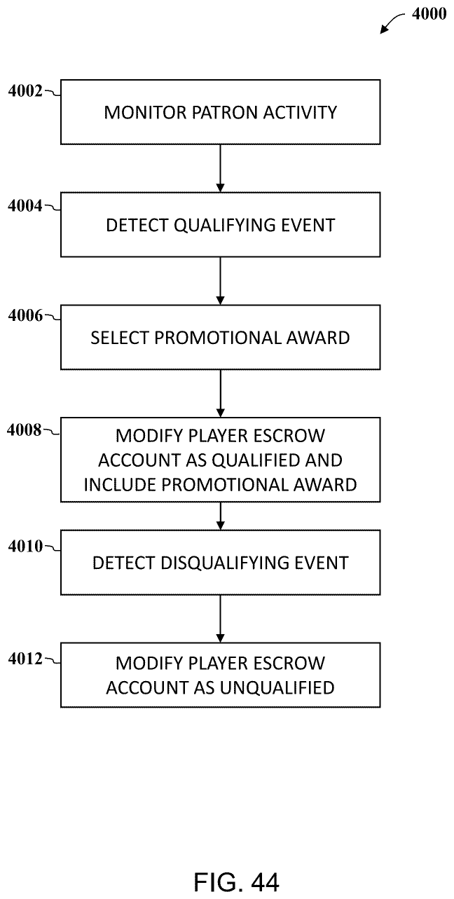

Referring to the algorithm 4000 illustrated in FIG. 44, in some embodiments, the processor of the customer loyalty program computer system 12 receives monitored patron activity from a player tracking server 16 and determines whether the monitored patron activity is a qualifying promotional event or a disqualifying promotional event.

For example, in algorithm step 4002 one or more processors of the customer loyalty program computer system 12 may receive monitored patron activity included in a patron activity data file 1084 transmitted by the player tracking server 16 that includes the Patron ID 74, 1086 received from patron tracking ID card, the activity session ID 1088 associated with the gaming session, the device ID 1090 associated with the EGM 24, the property ID 1092 indicating the corresponding casino property 18, the charm ID 1068 associated with the patron selected gaming charm 1078 and information associated with the wagering activity such as, for example, an amount of time at the EGM and/or an amount wagered over time.

In algorithm step 4004, the processor 12 determines whether the patron activity data indicates a qualifying promotional event. For example, in one embodiment, the processor accesses the promotional event data files 1104 to determine which promotions are currently active, and whether the patron activity data is a qualifying event or a disqualifying event associated with a currently active promotion.

In algorithm step 4006, upon determining the patron activity data indicates a qualifying promotional event, the processor 12 selects a promotional award. For example, in one embodiment, the processor accesses the promotional award selection file 1048 being stored in the data store 1046 and selects a promotional award using promotional award selection file 1048.

In one embodiment, the promotional award selection file 1048 includes a plurality of promotional awards and selection probabilities associated with each promotional award. The processor 12 may be programmed to randomly select the promotional award using the promotional award selection file. The promotional award selection file 1048 may also include a plurality of tiered groups of promotional awards. Each tiered group is associated with a different patron ranking level. The processor may be programmed to identify a patron ranking level associated with the corresponding patron, and select the promotional award from the corresponding tiered group of promotional awards associated with the identified patron ranking level.

The processor 12 may also be programmed to determine an award liability value upon determining the patron activity data indicates a qualifying promotional event and select the promotional award based on the determined award liability value. For example, the processor may determine the award liability value by accessing the award escrow data file and calculating the award liability value equal to a sum of the promotional awards included in escrowed award records having qualification status indicator indicating qualified status. The processor may then select the promotional award from the award paytables 1052, 1054, 1056 (shown in FIG. 48) based on the determined award liability value. For example, the data store 1046 may include a plurality of promotional award paytables including a plurality of awards. The plurality of promotional award paytables may include a high-value award paytable 1052 and a low-value award paytable 1056, with the high-value award paytable including awards having a higher monetary value than awards included in the low-value paytable. The processor may select the promotional award from the high-value award paytable or the low-value award paytable based on the determined award liability value. For example, the processor may select the promotional award from the low-value award paytable if the determined award liability value is greater than a predefined liability award liability value.

In algorithm step 4008, the processor 12 is programmed to modify the escrowed award record 1114 associated with the corresponding patron activity to include corresponding award fulfilment instructions including the selected promotional award, corresponding messaging instructions including an award notification message, and a corresponding qualification status indicator indicating a qualified status. In one embodiment, the corresponding award fulfilment instructions cause the casino management system server 14 to identify each patron account record associated with each patron ID and modify each patron account record to include the promotional awards. The messaging instructions cause each gaming device to display a corresponding award notification message.

For example, in some embodiments, the award escrow data file includes a plurality of escrowed award records with each escrowed award record including patron information including a corresponding patron ID and a corresponding gaming session ID, award fulfilment instructions, messaging instructions, and a qualification status indicator indicating at least one of a qualified status and an unqualified status. The processor 12 may be programmed to receive patron activity data associated with the session ID from the least one player tracking server indicating corresponding patron activity and determine whether the patron activity data indicates a qualifying promotional event. Upon determining the patron activity data indicates a qualifying promotional event, the processor may select a promotional award and modify the escrowed award record associated with the session ID to include the selected promotional award, corresponding award fulfilment instructions including the selected promotional award, and a corresponding qualification status indicator indicating a qualified status.

In algorithm step 4010, the processor 12 receives a subsequent signal from the least one player tracking server including the corresponding session ID and subsequent patron activity data associated with corresponding patron activity. The processor accesses the award escrow data file, identifies the escrowed award record associated with the corresponding session ID, and determines whether the subsequent patron activity data indicates a disqualifying promotional event.

In algorithm step 4012, upon determining the subsequent patron activity data indicates a disqualifying promotional event, the processor 12 modifies the identified escrowed award record to change the qualification status indicator to unqualified status.

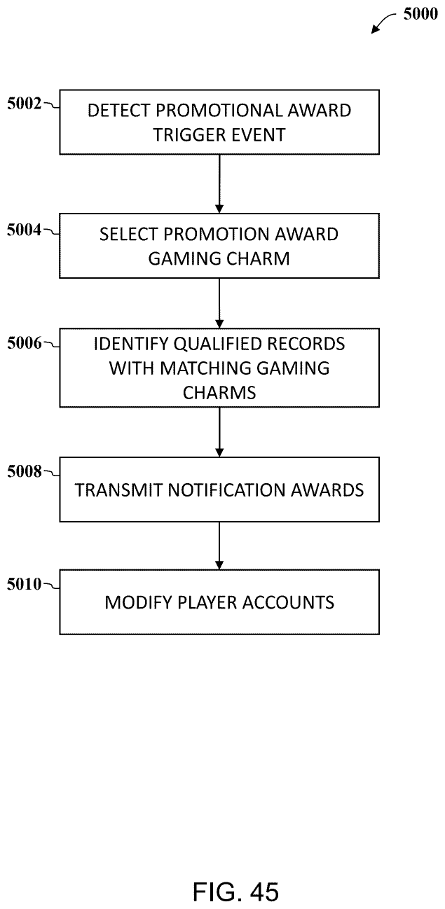

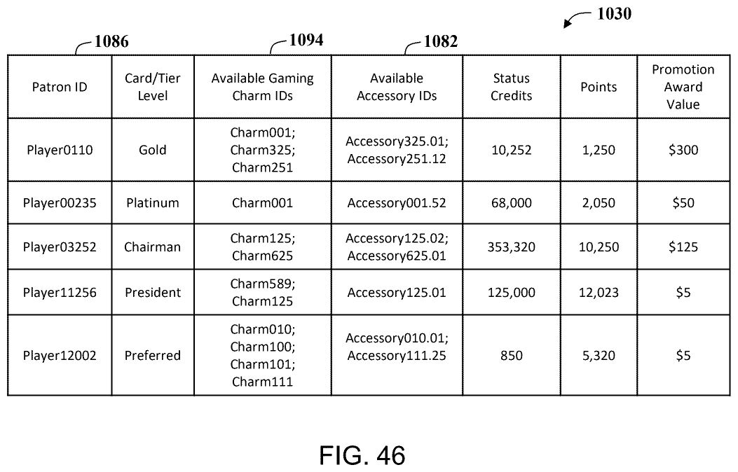

Referring to the algorithm 5000 illustrated in FIG. 45, in algorithm step 5002, one or more processors of the customer loyalty program computer system 12 is programmed to detect a promotional award trigger event and initiation a promotional award event algorithm to simultaneously notify patrons of the escrowed promotional awards. For example, the processor may receive a triggering event signal from one of the plurality of player tracking servers and execute the promotional award event algorithm upon detecting the triggering event signal.

In algorithm step 5004, upon detecting the triggering event, the processor 12 randomly selects a promotional award charm ID 1068 from the charm data file 1058 that includes a plurality of charm IDs.

In algorithm step 5006, the processor 12 accesses the award escrow data file 1112 and identifies escrowed award records 1114 having patron selected charm IDs matching the randomly selected promotional award charm ID and having qualification status indicators indicating qualified status.

In algorithm step 5008, for each identified escrowed award records having patron selected charm IDs matching the randomly selected promotional award charm ID and having qualification status indicator indicating qualified status, the processor 12 executes the corresponding award fulfilment instructions to provide the selected promotional award to each patron, and executes the corresponding messaging instructions to display the award notification message on each corresponding gaming device. The processor executes the promotional award event algorithm to transmit the messaging instructions 1126 to each gaming device associated with each device ID to cause each gaming device to display a corresponding award notification message substantially simultaneously.

In algorithm step 5010, the processor 12 transmits the award fulfilment instructions 1124 to the casino management system server 14 to cause the casino management system server 14 to identify each patron account record 1030 associated with each patron ID and modify each patron account record 1030 to include the promotional awards.

For example, in some embodiments, upon receiving the triggering event signal, the processor is programmed to determine each identify escrowed award records having charm IDs matching the selected promotional award charm ID and having qualification status indicators indicating qualified status. For each identified escrowed award records having qualification status indicator indicating qualified status, the processor executes the corresponding award fulfilment instructions to provide the selected promotional award to each patron.

In general, when executing algorithms to implement the Random Celebration™ promotions and/or the STN Charm™ promotional award program, the system 10 allows patrons to select gaming charms to associate with a patron's gaming session, randomly selects a promotional award charm and provides promotional awards to each patron having a patron selected gaming charm matching the randomly selected promotional award charm. The customer loyalty program computer system 12 improves existing casino management systems by generating escrow account data files that includes randomly selected promotional awards associated with casino patrons. The escrow account data files are generated to include modifiable qualification flag IDs to enable the customer loyalty program computer system 12 to change an escrow account record from “qualified” status to a “unqualified” status during as promotions period. The customer loyalty program computer system 12 also uses the escrow accounts to transmit award notifications to gaming devices 20 located at multiple casino properties, to enable a promotional award notification to occur nearly simultaneously at each casino property. Moreover, the escrow accounts enables the system 10 to determine a total amount of promotional awards that may be awarded at any time during the promotional period. By generating escrow account data files with modifiable qualification status indicators, the system is able to associate randomly selected promotional awards to qualifying patrons before the promotional awards are provided and/or awarded to the patrons, which reduces the amount of time and computer resources required to transmit the award notification messages upon detecting a random trigger event, and enables the system to determine a total amount of promotional awards that may be awarded at any time during a promotional period, which are features not currently available in existing casino management systems.

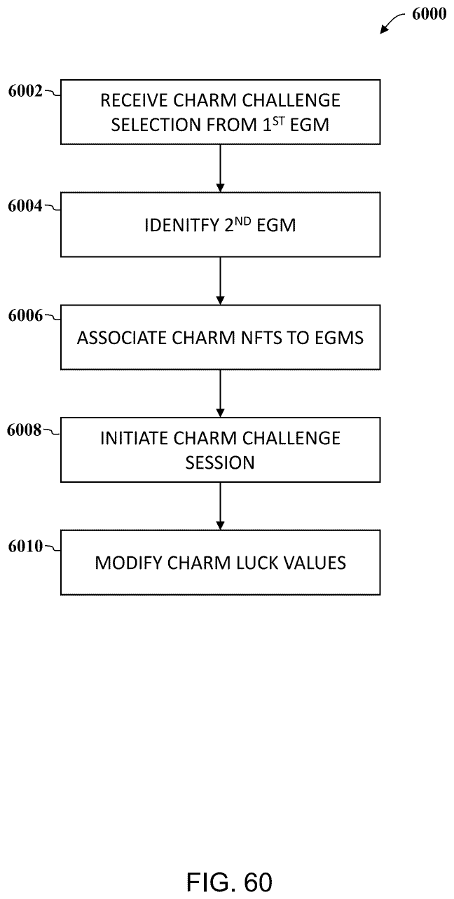

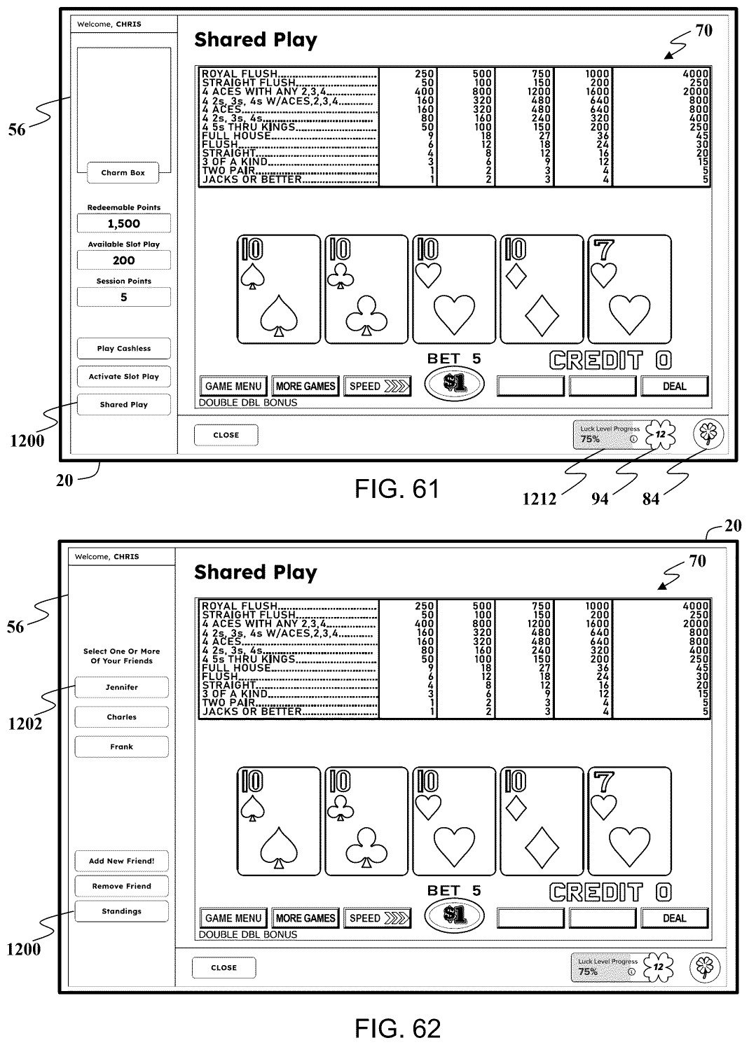

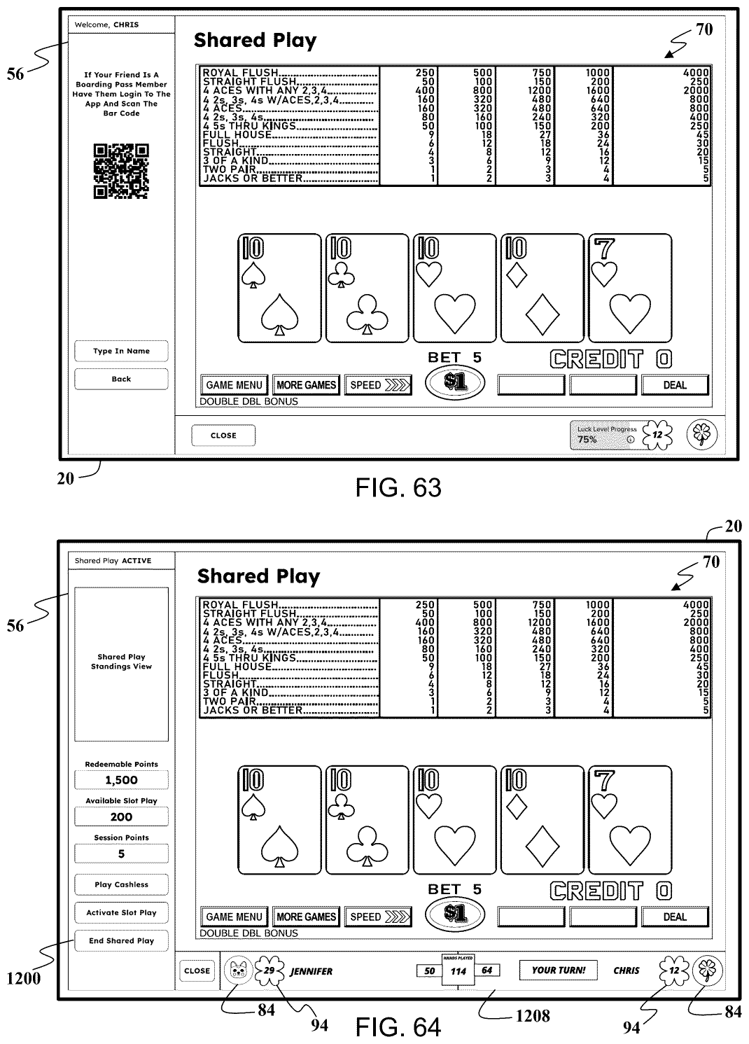

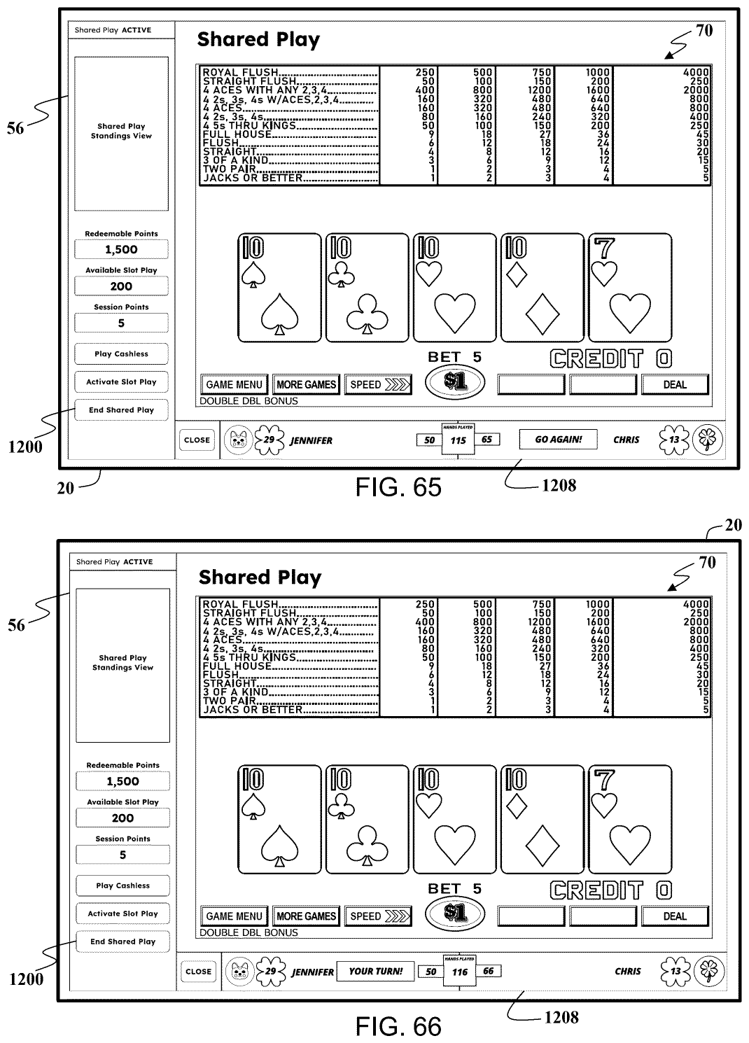

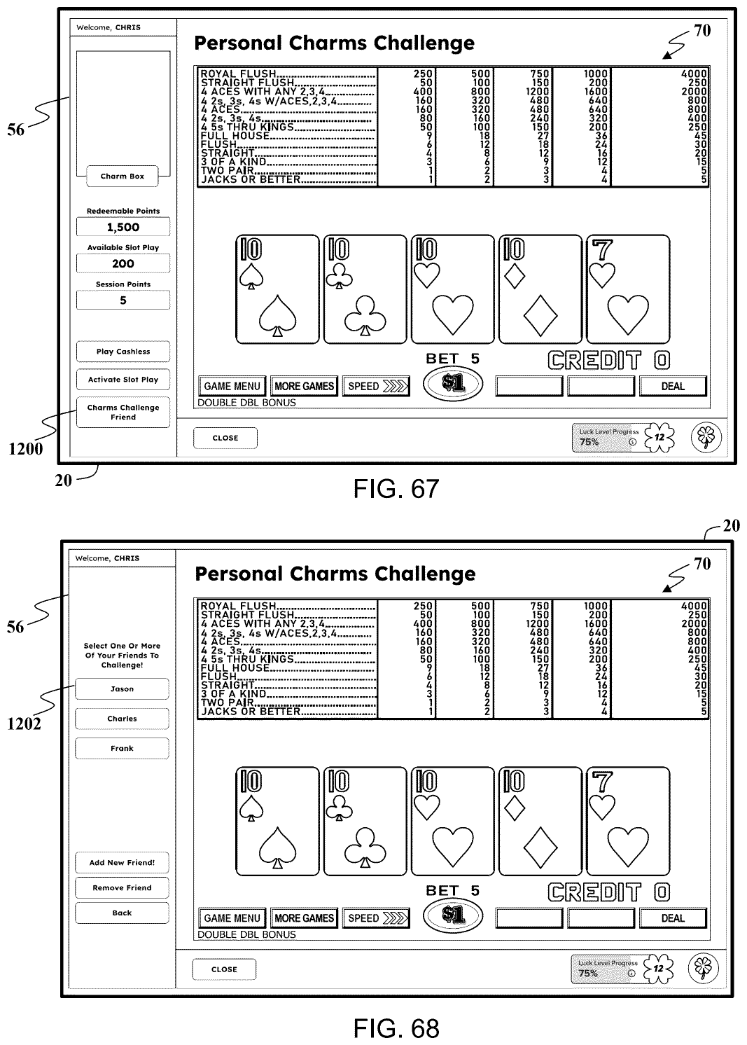

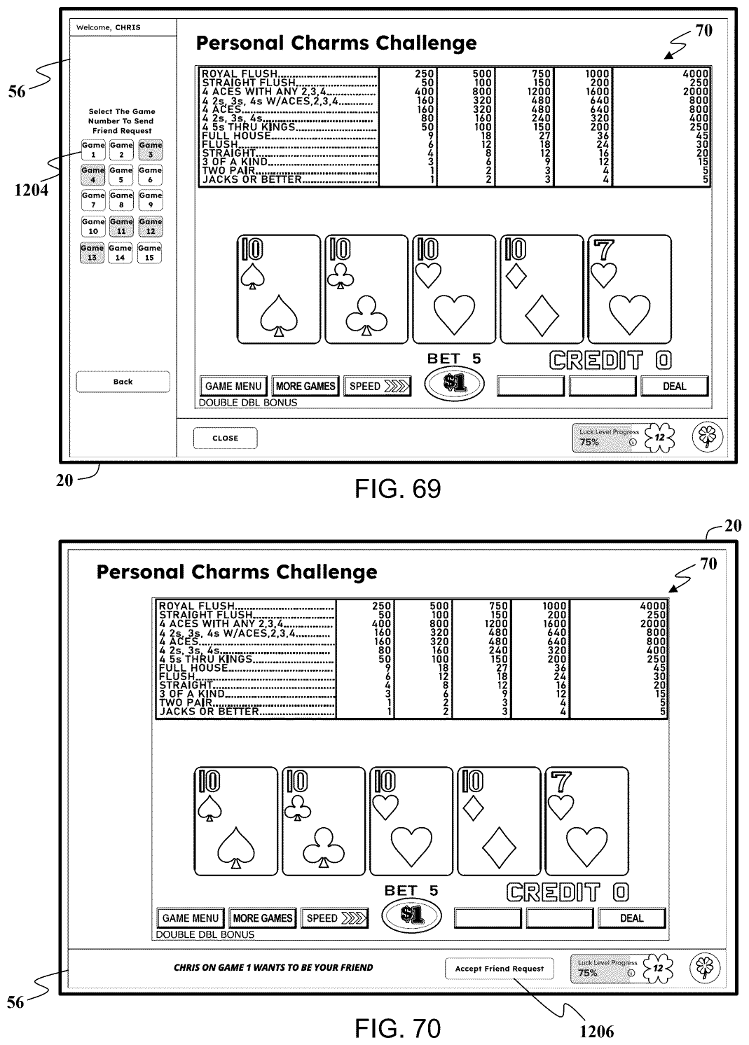

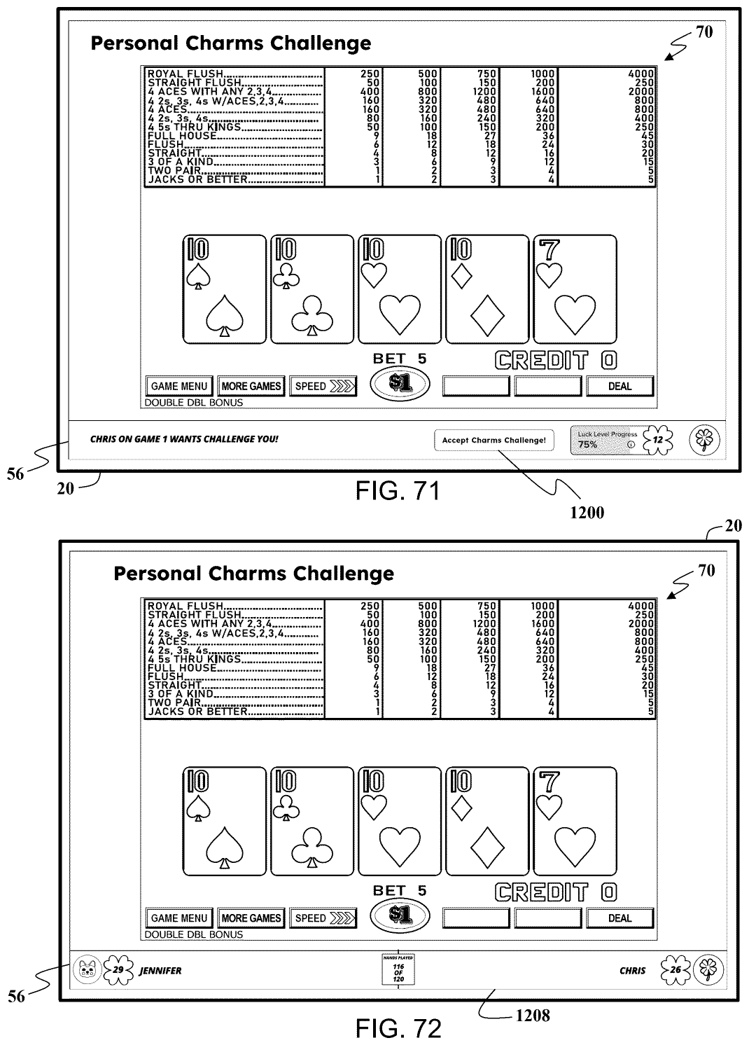

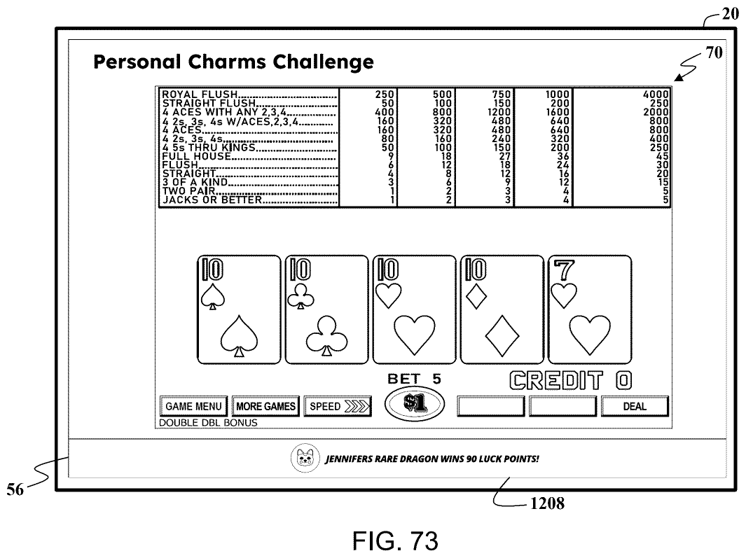

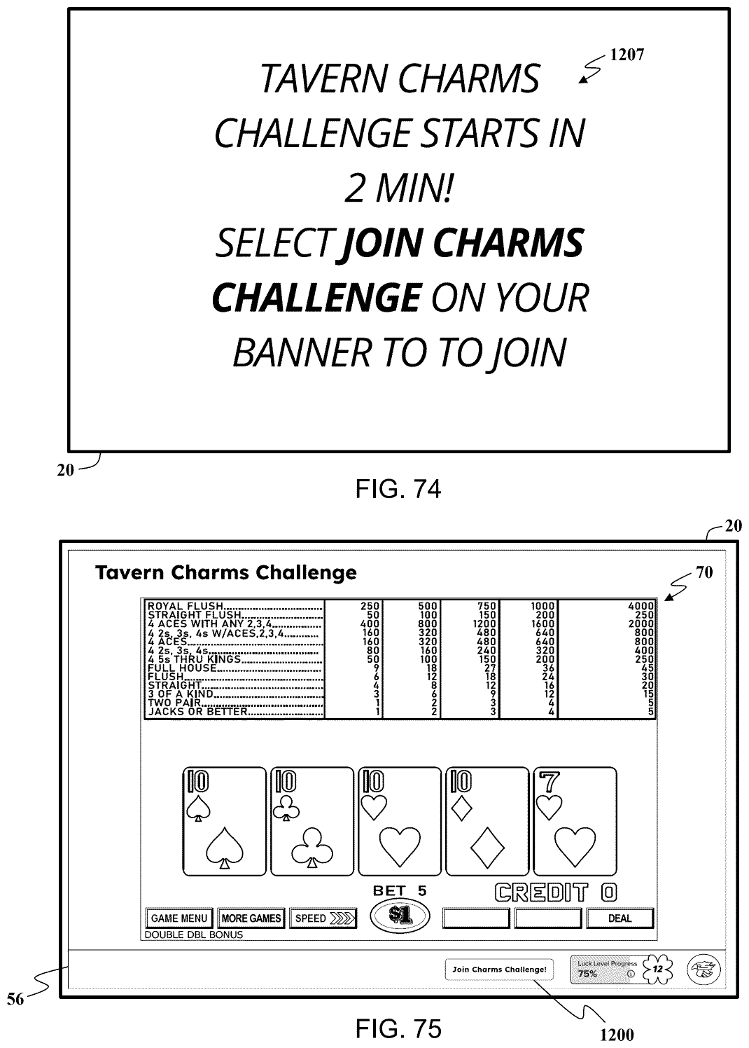

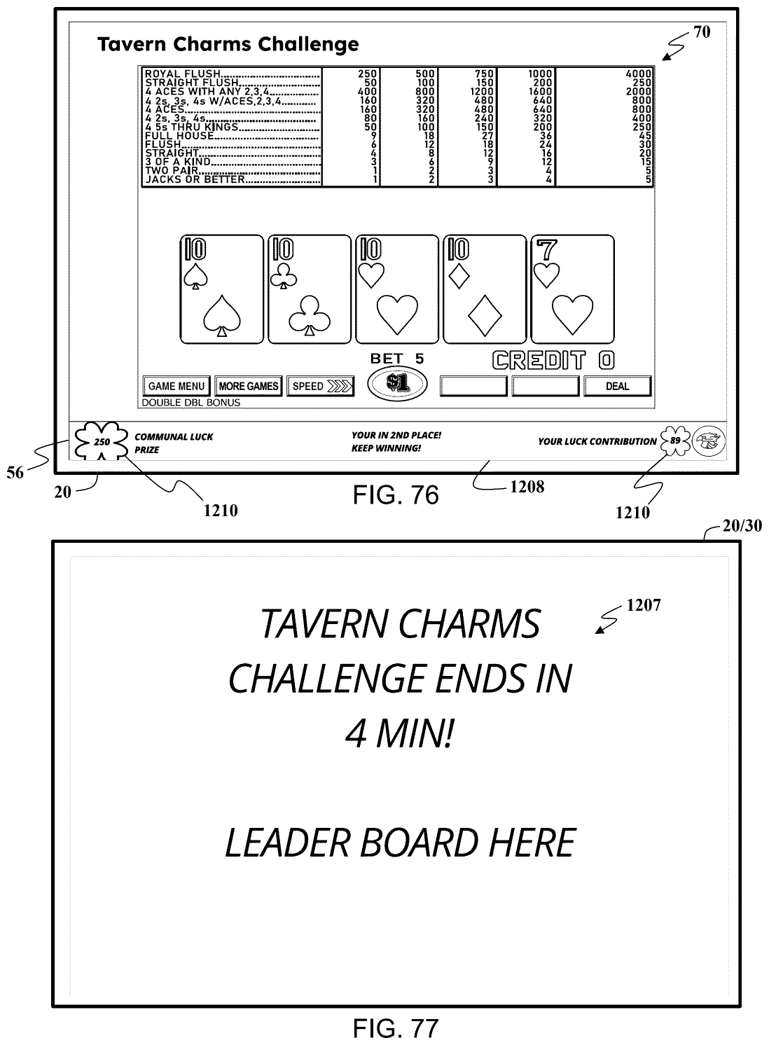

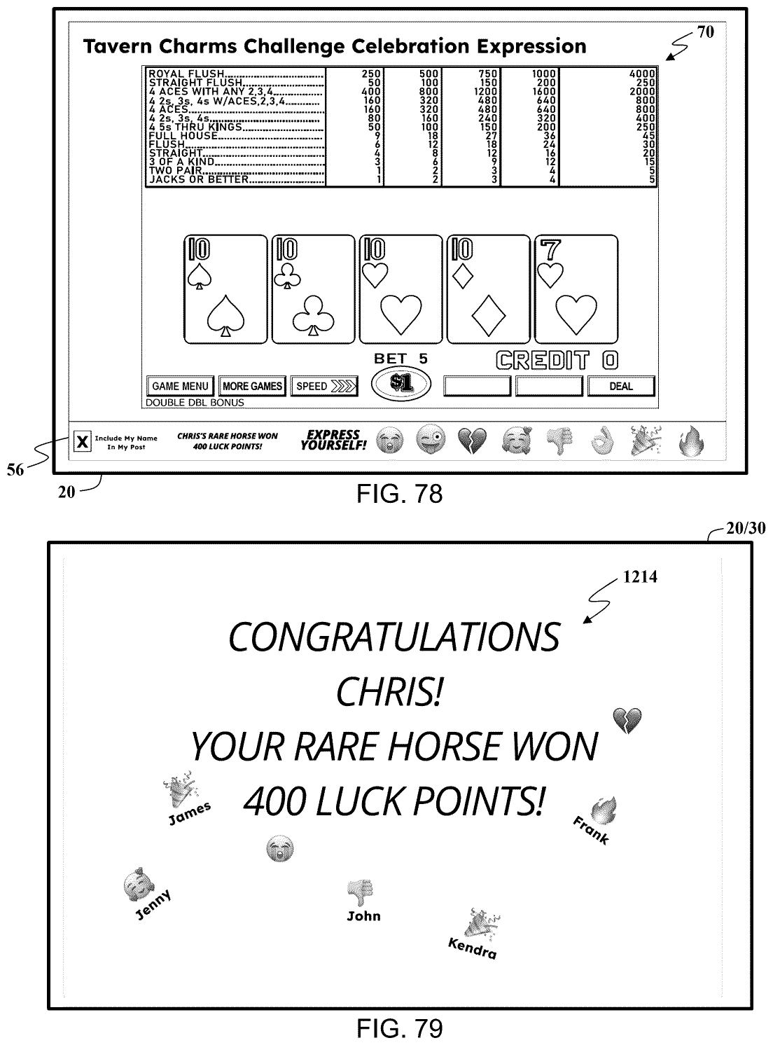

Referring to FIGS. 60-79, in some embodiments, the customer loyalty program computer system 12 may be programmed to execute algorithm 6000 for displaying an animated sequence of computer-generated images on the display screens of corresponding EGMs displaying a charm challenge session. The charm challenge sessions allow patrons playing EGMs located within the same casino property to compete and/or cooperate to accumulate charm luck points that may be associated with a patron selected charm NFT. For example, patrons playing EGMs at a gaming tavern may invite other patrons playing EGMs at the same gaming tavern to participate together in the charm challenge sessions to accumulate charm luck points. The algorithm includes a plurality of steps that may be performed independently of, or in combination with, other algorithm steps. Portions of the algorithms may be performed by any one of, or any combination of, the components of the customer loyalty program computer system 12.

In algorithm step 6002, one or more processors of the customer loyalty program computer system 12 displays a game screen window 70 and a patron service window 56 on a first EGM 24 including a user selectable charms challenge selection icon 1200 in the patron service window 56, and receives a charms challenge gaming session request from the first EGM 24 initiated by a patron selection of the charms challenge selection icon 1200 and conducting a charms challenge session by executing algorithm steps 6004-6010.

In algorithm step 6004, the processor 12 identifies a second EGM 24 to participate in the charms challenge session with the first EGM 24. For example, in some embodiments, the processor 12 may select the second EGM 24 from a patron friend list associated with the patron playing at the first EGM and identify the second EGM by receiving the charms challenge gaming session request from the first EGM 24 including a patron ID 74, 1086 identifying a first patron at the first EGM 24 and a property ID 1092 identifying the gaming property. The processor 12 then queries a gaming session data file 76, and/or a patron activity data file 1084, to identify active friend-patron IDs 74, 1086 associated with the received patron ID 74, 1086 and having active gaming sessions at EGMs 24 associated with the property ID 1092. The processor 12 then displays user selectable friend icons 1202 associated with identified active friend-patron IDs 74, 1086 in the patron service window 56 of the first EGM 24 and identifies the second EGM 24 based on the patron's selection of one of the friend icons 1202 associated with identified active friend-patron IDs 74, 1086.

In some embodiments, the processor 12 may identify the patron friend list associated with the first patron by querying a patron account data file 72, 1030 to identify a list of friend-patron IDs 74, 1086 associated with the received patron ID 74, 1086 and query the gaming session data file 76 to identify the active friend-patron IDs 74, 1086 from the list of friend-patron IDs 74, 1086 associated with the received patron ID 74, 1086.

In other embodiments, the processor 12 may create a patron friend list by receiving the charms challenge gaming session request from the first EGM 24 including a patron ID 74, 1086 identifying the first patron at the first EGM 24 and a property ID 1092 identifying the gaming property. The processor 12 then queries a gaming session data file 76 to identify active EGMs 24 within the gaming property operating with active patron IDs 74, 1086 having active gaming sessions and display user selectable EGM icons 1204 associated with each identified active EGM 24 in the patron service window 56 of the first EGM 24. The processor 12 then displays a friend request message 1206 in each EGM 24 associated with a patron selected EGM icon 1204. The processor 12 receives a friend request confirmation message from a corresponding EGM 24 including an associated patron ID 74, 1086 and modifies the patron account data file 72, 1030 identifying the associated patron ID 74, 1086 as a friend-patron ID 74, 1086.

In other embodiments, the processor 12 may identify the second EGM 24 by receiving the charms challenge gaming session request from the first EGM 24 including a property ID 1092 identifying the gaming property, querying a gaming session data file 76 to identify patron IDs 74, 1086 having active gaming sessions at EGMs 24 associated with the property ID 1092, and displaying a user selectable charms challenge selection icon 1200 in the patron service window 56 of each active EGM 24 in the gaming property associated with patron IDs 74, 1086 having active gaming sessions. The processor 12 then identifies the second EGM 24 upon receiving a patron selection of the charms challenge selection icon 1200 on an active EGM 24.

In some embodiments, the processor 12 may display a charms challenge notification message 1207 on the central display device 30 and each EGM 24 located at a gaming property 18 such as, for example, a gaming tavern, and initiate a charms challenge gaming sessions on each EGM 24 associated with a patron selection of the charms challenge selection icon 1200 on corresponding EGMs 24.

In algorithm step 6006, the processor 12 associates a first casino charm NFT 64 with the first EGM 24 and a second casino charm NFT 64 with the second EGM 24 with each of the first and second casino charm NFTs having corresponding charm luck values. For example, the processor 12 may initiate algorithm 200, 2000, and 3000 to allow patrons to select associated casino charm NFTs to the charms challenge session.

In algorithm step 6008, the processor 12 initiates the charms challenge session by establishing a number of game plays associated with the charms challenge session, displaying a charms challenge game screen 1208 on the first and second EGMs 24 including casino charm icons 84 associated with the first and second casino charm NFTs 64 and the corresponding charm luck values 94, monitoring wagering activity at the first and second EGMs 24 for each of the number of game plays, determining a number of charm luck points accumulated during the charms challenge session based on the monitored wagering activity at the first and second EGMs 24, and animating a charms luck points icon 1210 on the first and second EGMs displaying the accumulated number of charm luck points. In some embodiments, the processor 12 determines the amount of accumulated charm luck points based on an amount of coin-out monitored during the charms challenge session from each participating EGM 24.

In algorithm step 6010, the processor 12 modifies the corresponding charm luck values of the first and second casino charm NFTs based on the accumulated number of charm luck points and animates corresponding casino charm icons 84 on the charms challenge game screen 1208 of the first and second EGMs 24 to display the modified charm luck values 94 of the first and second casino charms NFTs 64. The processor 12 may animate each corresponding casino charm icon to include an image associated with the casino charm NFT 64, the modified charm luck level 94, and a luck level progress bar 1212 indicating a percentage of luck points required to reach a next charm luck level.

In some embodiments, the processor 12 may conduct a shared charms challenge session and modify the corresponding luck values of the first and second casino charm NFTs 64 by assigning half of the accumulated number of charm luck points to each of the first and second casino charm NFTs 64 equally.

In other embodiments, the processor 12 may conduct a personal competitive charms challenge session and modifying the corresponding luck values of the first and second casino charm NFTs by determining a winning EGM based on the monitored wagering activity; and assigning a total amount of the accumulated number of charm luck points to a corresponding casino charm NFT 64 associated with the winning EGM 24. For example, the processor 12 may modify the corresponding luck values of the first and second casino charm NFTs by determining the winning EGM by determining a first number of accumulated charm luck points based on the monitored wagering activity at the first EGM, determining a second number of accumulated charm luck points based on the monitored wagering activity at the second EGM, and determining the winning EGM having a greater number of accumulated charm luck points.

In some embodiments, the processor 12 may conduct a tavern charms challenge session with multiple EGMs located within the same property. For example, the processor 12 may display a personal charm luck points icon 1210 on each corresponding EGM indicating a corresponding number of accumulated charm luck points associated with the monitored wagering activity at the corresponding EGM, and displaying a total charm luck points icon 1210 on each corresponding EGM indicating the total amount of the accumulated number of charm luck points. The processor 12 may determine the winning EGM having a greater number of accumulated charm luck points, display a winning banner notification 1214 each the first and second EMGs displaying a patron name associated with the winning EGM, total amount of the accumulated number of charm luck points, the corresponding casino charm NFT, and an emoticon selected from a patron via a non-winning EGM. The processor 12 may also display the winning banner notification 1214 on the central display device 30 of the gaming property 18.

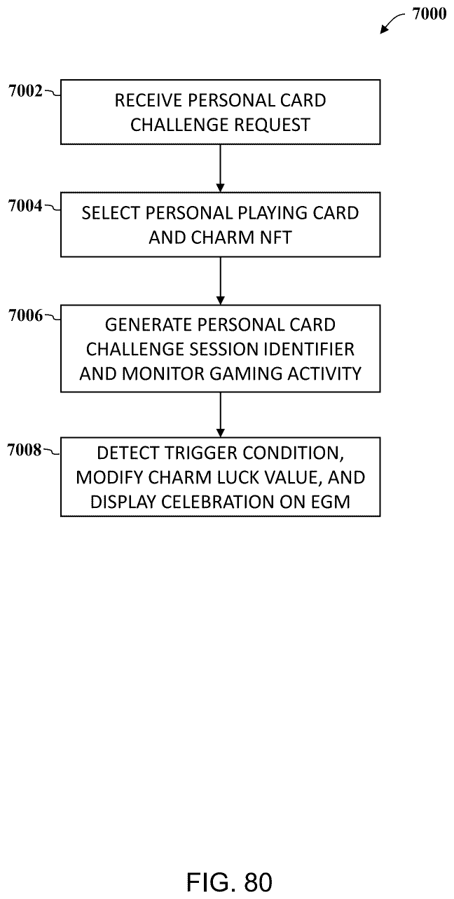

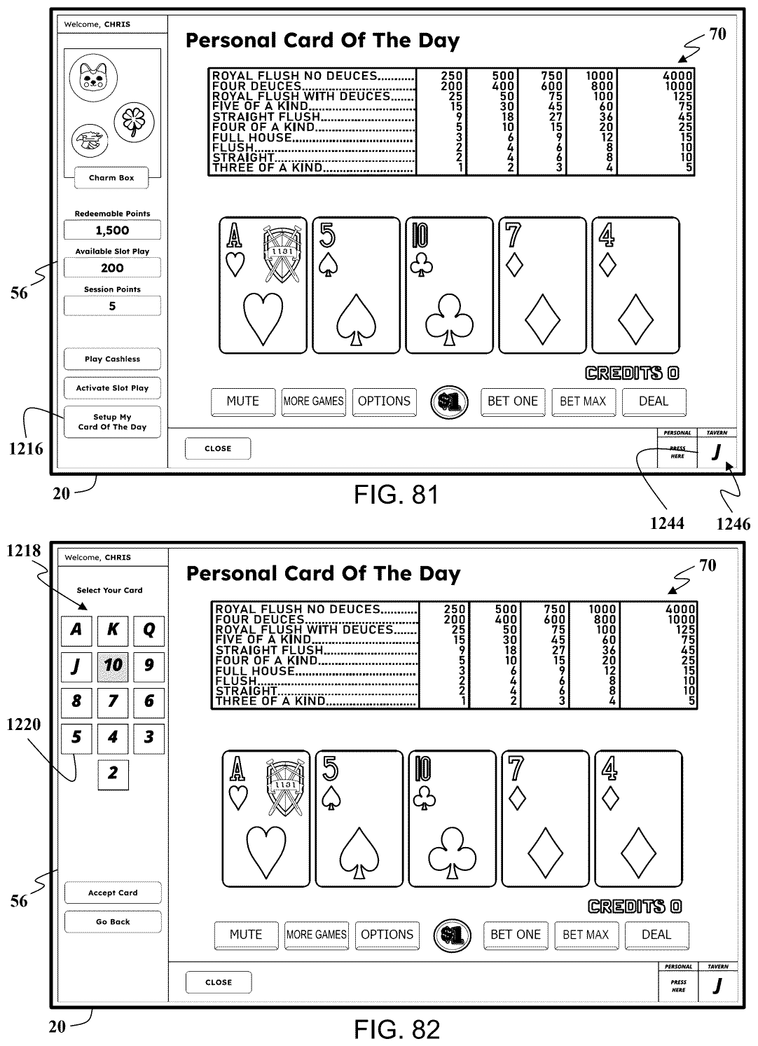

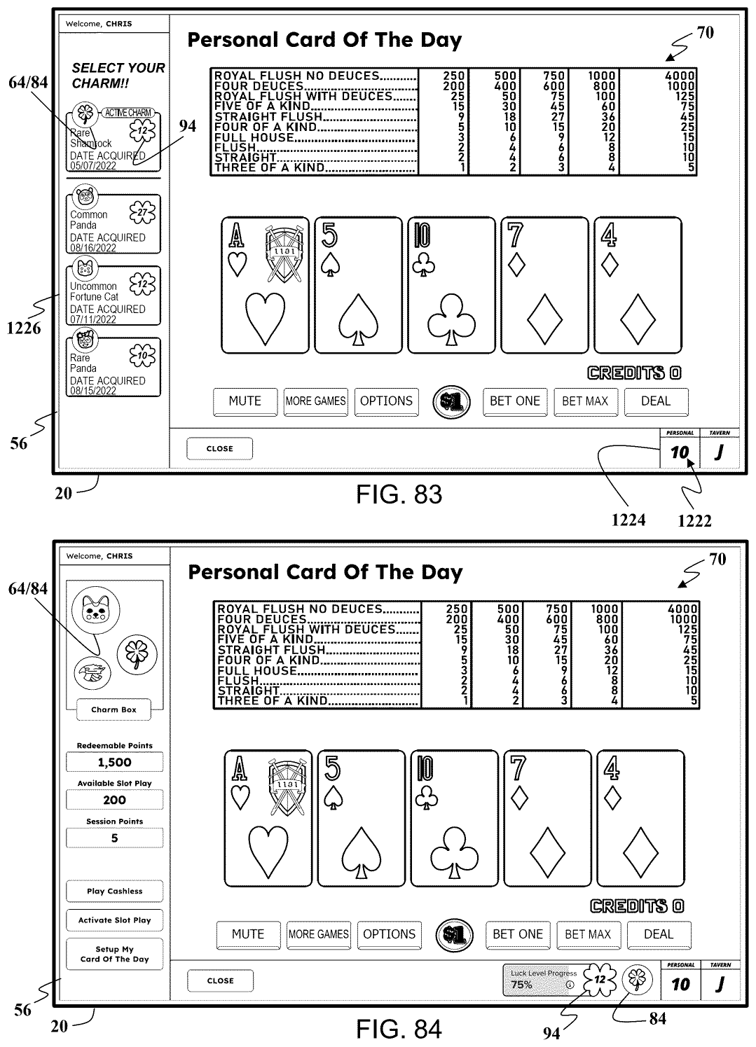

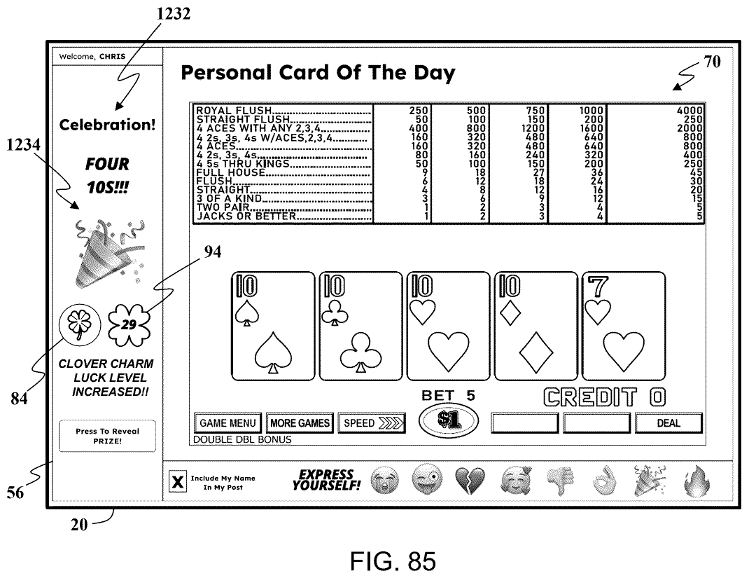

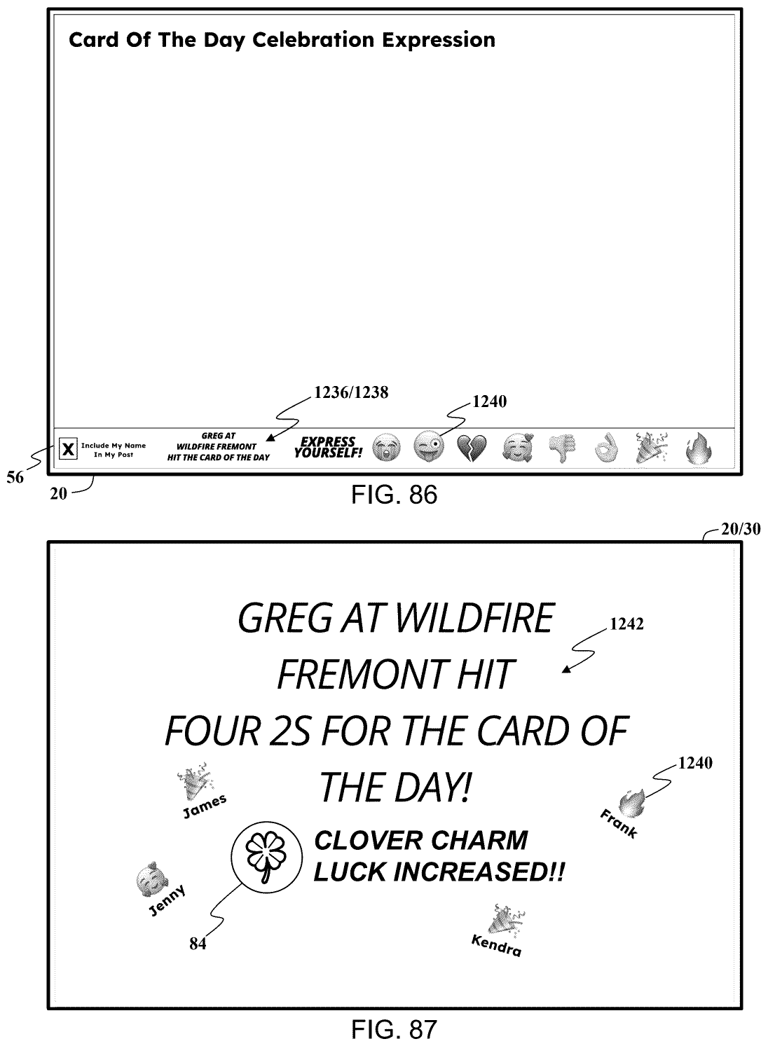

Referring to FIGS. 80-87, in some embodiments, the customer loyalty program computer system 12 may be programmed to execute algorithm 7000 for displaying a computer-animated sequence of computer-generated images on the GUI display screens of corresponding EGMs displaying a personal card challenge gaming session. The personal card challenge gaming sessions allow patrons playing EGMs located within the same casino property to compete and/or cooperate to accumulate charm luck points that may be associated with a patron selected charm NFT. The algorithm includes a plurality of steps that may be performed independently of, or in combination with, other algorithm steps. Portions of the algorithms may be performed by any one of, or any combination of, the components of the customer loyalty program computer system 12.

In algorithm step 7002, one or more processors of the customer loyalty program computer system 12 displays a game screen window 70 and a patron service window 56 on a first EGM 24 including a user selectable personal card challenge selection icon 1216 in the patron service window 56, and receives a personal card challenge gaming session request from the EGM 24 initiated by a patron selection of the personal card challenge selection icon 1216. The personal card challenge gaming session request includes a patron ID 74, 1086 identifying a patron at the EGM 24, a device ID 1090 identifying the EGM 24, and a property ID 1092 identifying the gaming property. Upon receiving the personal card challenge gaming session, the one or more processors of the customer loyalty program computer system 12 conduct a personal card challenge gaming session by executing algorithm steps 7004-7008.

In algorithm step 7004, the processor 12 renders a card selection window 1218 within the patron service window 56 including a plurality of playing cards icons 1220 that are selectable by the patron. For example, the processor 12 may render the card selection window 1218 including playing card rank icons arranged in a grid having three columns. The processor 12 then receives a patron selection of a playing card 1222 via the card selection window 1218 and displays a personal card window 1224 within the patron service window 56 including an image of the patron selected playing card 1222. The processor 12 then identifies casino charm NFTs 64 associated with the received patron ID 74, 1086 and renders a charm selection window 1226 within the patron service window 56 including icons 84 of each identified casino charm NFT 64 and associated charm luck values 94. The processor 12 receives a patron selection of a casino charm NFT 64 via the charm selection window 1226 and renders an icon 84 of the patron selected casino charm NFT 64 and a corresponding charm luck value 94 within the patron service window 56.

In algorithm step 7006, the processor 12 generates a personal card challenge session identifier 1228 (shown in FIG. 54) including a unique session ID 1088, the patron ID 74, 1086, the property ID 1092, a charm ID 1068 associated with the patron selected casino charm NFT 64, and a card ID 1230 associated with the patron selected playing card 1222. The processor 12 then modifies a patron account data file 72, 1030 to include the personal card challenge session identifier 1228, and receives monitored wagering activity data associated with the EGM 24 from the corresponding player tracking device.

In algorithm step 7008, the processor 12 detects a triggering condition in the received monitored wagering activity data including a game outcome including a game playing card matching the patron selected playing card 1222, modifies the luck value 94 associated with the patron selected casino charm NFT 64 based on the game outcome including the game playing card matching the patron selected playing card 1222, and displays a celebration image 1232 within the patron service window 56 including a celebration icon 1234 and the patron selected casino charm NFT 64 with the increased luck value 94. For example, the processor 12 may modify the luck value associated with the patron selected casino charm NFT 64 by increasing a luck value of the patron selected casino charm NFT 64 by a predefined amount. The processor 12 may also detect the triggering condition including a four-of-a-kind poker hand including four game playing cards matching the patron selected playing card 1222.

In some embodiments, the processor 12 may query a gaming session data file 76 (shown in FIG. 24) to identify active EGMs 24 associated with patron IDs having active gaming sessions at EGMs associated with the property ID, and display a celebration window 1236 in the patron service window 56 of each active EGM 24 including a celebration notification 1238.

The processor 12 may also display the celebration window 1236 in the patron service window 56 of each active EGM 24 including the celebration notification 1238 and a plurality of patron selectable emoticons 1240, receive patron selected emoticons 1240 from the active EGMs 24, and display a celebration banner notification 1242 on the central display device 30 located at the gaming tavern including a name of the patron associated with the triggering condition, the corresponding casino charm NFT 64, and the received patron selected emoticons 1240 from the active EGMs 24.

In some embodiments, the processor 12 may also randomly select a tavern playing card 1246 associated with the gaming property and displaying a tavern card window 1244 within the patron service window 56 including an image of the randomly selected tavern playing card 1246. For example, the processor 12 may query a gaming session data file 76 to identify active EGMs 24 associated with patron IDs having active gaming sessions at EGMs associated with the property ID, and display the tavern card window 1244 on a corresponding patron service window 56 of each active EGM 24 including an image of the randomly selected tavern playing card 1246. The processor 12 may then detect a triggering condition including a four-of-a-kind poker hand including four game playing cards matching the randomly selected tavern playing card 1246 and modify a corresponding luck value associated with each casino charm NFT 64 associated with each active EGM 24.

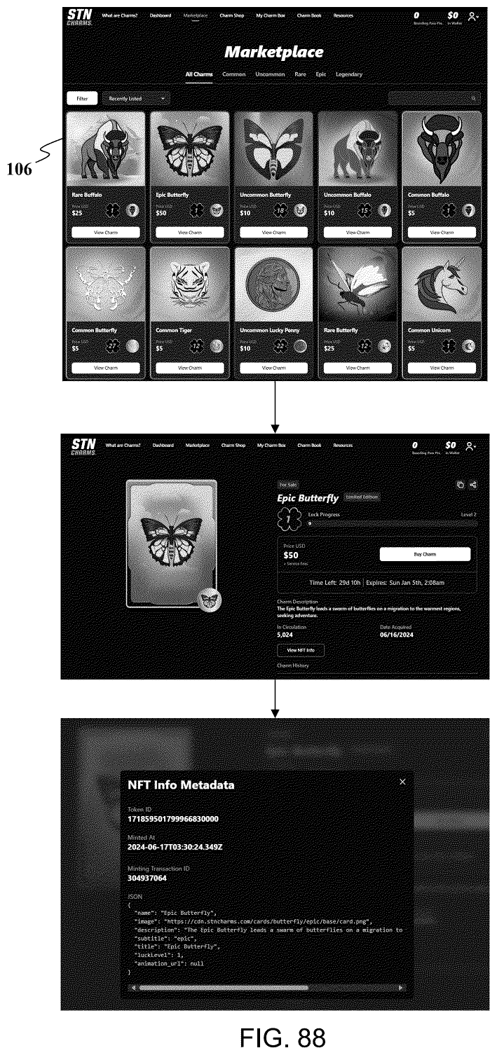

In some embodiments, as shown in FIG. 88, the processor 12 may display a charms marketplace window on the EGM GUI display screen including a plurality of selectable casino charm NFT icons 64, 84, and allow a patron to select one or more casino charm NFT icons 64, 84 and display NFT info Metadata associated with the patron selected casino charm NFT 64. For example, the processor 12 receive a patron selection of a casino charm NFT icons 64, 84 from the charms marketplace interface screen 106, identify a charm ID associated with the patron selected casino charm NFT 64, query the blockchain ledger network system 34 to retrieve metadata associated with the identified charm ID, and display the retrieved casino charm NFT info Metadata on the charms marketplace interface screen 106.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed herein, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, MongoDB™ database engines which is a document storage solution, Oracle® Database, MySQL, IBM® Db2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

The above description of illustrated examples of the present invention, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

What is claimed is:

1. A networked computer system for displaying computer-animated images on electronic gaming machines (EGMs), comprising:
a plurality of EGMs located at a gaming property, each EGM including:
a display device including a graphical user interface (GUI) display screen displaying computer-generated icon images thereon; and
a corresponding player tracking device configured to monitor wagering activity associated with the EGM; and
a gaming property management server coupled to each EGM and including one or more processors programmed to execute an algorithm to display a computer-animated sequence of computer-generated images on the GUI display screens of corresponding EGMs including the steps of:
displaying a game window and a patron service window on a first EGM including a user selectable charms challenge selection icon in the patron service window;
receiving a charms challenge gaming session request from the first EGM initiated by a patron selection of the charms challenge selection icon and conducting a charms challenge session by:
identifying a second EGM;
associating a first casino charm with the first EGM and a second casino charm with the second EGM, each of the first and second casino charms having corresponding charm luck values;
establishing a number of game plays associated with the charms challenge session;
displaying a charms challenge game screen on the first and second EGMs including casino charm icons associated with the first and second casino charms and the corresponding charm luck values;
monitoring wagering activity at the first and second EGMs for each of the number of game plays;
determining a number of charm luck points accumulated during the charms challenge session based on the monitored wagering activity at the first and second EGMs;
animating a charms luck points icon on the first and second EGMs displaying the accumulated number of charm luck points;
modifying the corresponding charm luck values of the first and second casino charms based on the accumulated number of charm luck points; and
animating corresponding casino charm icons on the charms challenge game screen of the first and second EGMS to display the modified charm luck values of the first and second casino charms.

2. The networked computer system of claim 1, wherein the one or more processors is programmed to execute the algorithm including the steps of:
animating each corresponding casino charm icon including an image associated with the casino charm, the modified charm luck level, and a luck level progress bar indicating a percentage of luck points required to reach a next charm luck level.

3. The networked computer system of claim 1, wherein the one or more processors is programmed to execute the algorithm including the steps of:
modifying the corresponding luck values of the first and second casino charms by:
assigning half of the accumulated number of charm luck points to each of the first and second casino charms.

4. The networked computer system of claim 1, wherein the one or more processors is programmed to execute the algorithm including the steps of:
modifying the corresponding luck values of the first and second casino charms by:
determining a winning EGM based on the monitored wagering activity; and
assigning a total amount of the accumulated number of charm luck points to a corresponding casino charm associated with the winning EGM.

5. The networked computer system of claim 4, wherein the one or more processors is programmed to execute the algorithm including the steps of:
modifying the corresponding luck values of the first and second casino charms by:
determining the winning EGM by:
determining a first number of accumulated charm luck points based on the monitored wagering activity at the first EGM;
determining a second number of accumulated charm luck points based on the monitored wagering activity at the second EGM; and
determining the winning EGM having a greater number of accumulated charm luck points.

6. The networked computer system of claim 5, wherein the one or more processors is programmed to execute the algorithm including the steps of:
displaying a personal charm luck points icon on each corresponding EGM indicating a corresponding number of accumulated charm luck points associated with the monitored wagering activity at the corresponding EGM; and
displaying a total charm luck points icon on each corresponding EGM indicating the total amount of the accumulated number of charm luck points.

7. The networked computer system of claim 6, wherein the one or more processors is programmed to execute the algorithm including the steps of:
displaying a winning banner notification each the first and second EMGs displaying:
a patron name associated with the winning EGM,
total amount of the accumulated number of charm luck points; and
the corresponding casino charm; and
an emoticon selected from a patron via a non-winning EGM.

8. The networked computer system of claim 1, wherein the one or more processors is programmed to execute the algorithm including the steps of:
identifying the second EGM by:
receiving the charms challenge gaming session request from the first EGM including a property ID identifying the gaming property;
querying a gaming session data file to identify patron IDs having active gaming sessions at EGMs associated with the property ID;
displaying a user selectable charms challenge selection icon in the patron service window of each active EGM in the gaming property associated with patron IDs having active gaming sessions; and
identifying the second EGM upon receiving a patron selection of the charms challenge selection icon on an active EGM.

9. The networked computer system of claim 1, wherein the one or more processors is programmed to execute the algorithm including the steps of:
identifying the second EGM by:
receiving the charms challenge gaming session request from the first EGM including a patron ID identifying a first patron at the first EGM and a property ID identifying the gaming property;
querying a gaming session data file to identify active friend-patron IDs associated with the received patron ID and having active gaming sessions at EGMs associated with the property ID;
displaying user selectable friend icons associated with identified active friend-patron IDs in the patron service window of the first EGM; and
identifying the second EGM based on the patron's selection of one of the friend icons associated with identified active friend-patron IDs.

10. The networked computer system of claim 9, wherein the one or more processors is programmed to execute the algorithm including the steps of:
querying a patron account data file to identify a list of friend-patron IDs associated with the received patron ID; and
querying the gaming session data file to identify the active friend-patron IDs from the list of friend-patron IDs associated with the received patron ID.

11. The networked computer system of claim 10, wherein the one or more processors is programmed to execute the algorithm including the steps of:
receiving the charms challenge gaming session request from the first EGM including a patron ID identifying a first patron at the first EGM and a property ID identifying the gaming property;
querying a gaming session data file to identify active EGMs within the gaming property operating with active patron IDs having active gaming sessions;
displaying user selectable EGM icons associated with each identified active EGM in the patron service window of the first EGM;
displaying a friend request message in each EGM associated with a patron selected EGM icon;
receiving a friend request confirmation message from a corresponding EGM including an associated patron ID; and
modifying the patron account data file identify the associated patron ID as a friend-patron ID.

12. The networked computer system of claim 1, wherein the one or more processors is programmed to execute the algorithm including the steps of:
displaying a user selectable personal card challenge selection icon in the patron service window of the first EGM;
receiving a personal card challenge gaming session request from the EGM initiated by a patron selection of the personal card challenge selection icon, the personal card challenge gaming session request including a patron ID identifying a patron at the EGM, a device ID identifying the EGM, and a property ID identifying the gaming property; and
conducting a personal card challenge gaming session by:
rendering a card selection window within the patron service window including a plurality of playing cards icons selectable by the patron;
receiving a patron selection of a playing card via the card selection window;
displaying a personal card window within the patron service window including an image of the patron selected playing card;
identifying casino charms associated with the received patron ID;
rendering a charm selection window within the patron service window including icons of each identified casino charm and associated charm luck values;
receiving a patron selection of a casino charm via the charm selection window;
rendering an icon of the patron selected casino charm and a corresponding charm luck value within the patron service window;
generating a personal card challenge session identifier including a unique session ID, the patron ID, the property ID, a charm ID associated with the patron selected casino charm, and a card ID associated with the patron selected playing card;
modifying a patron account data file to include the personal card challenge session identifier;
receiving monitored wagering activity data associated with the EGM from the corresponding player tracking device;
detecting a triggering condition in the received monitored wagering activity data including a game outcome including a game playing card matching the patron selected playing card;
modifying the luck value associated with the patron selected casino charm based on the game outcome including the game playing card matching the patron selected playing card; and
displaying a celebration image within the patron service window including a celebration icon and the patron selected casino charm with the increased luck value.

13. The networked computer system of claim 12, wherein the one or more processors is programmed to execute the algorithm including the steps of:
detecting the triggering condition including a four-of-a-kind poker hand including four game playing cards matching the patron selected playing card.

14. The networked computer system of claim 12, wherein the one or more processors is programmed to execute the algorithm including the steps of:
randomly selecting a tavern playing card associated with the gaming property and displaying a tavern card window within the patron service window including an image of the randomly selected tavern playing card.

15. The networked computer system of claim 14, wherein the one or more processors is programmed to execute the algorithm including the steps of:
querying a gaming session data file to identify active EGMs associated with patron IDs having active gaming sessions at EGMs associated with the property ID; and
displaying the tavern card window on a corresponding patron service window of each active EGM including an image of the randomly selected tavern playing card.

16. The networked computer system of claim 14, wherein the one or more processors is programmed to execute the algorithm including the steps of:
detecting the triggering condition including a four-of-a-kind poker hand including four game playing cards matching the randomly selected tavern playing card.

17. The networked computer system of claim 16, wherein the one or more processors is programmed to execute the algorithm including the steps of:
modifying a corresponding luck value associated with each casino charm associated with each active EGM.

18. The networked computer system of claim 12, wherein the one or more processors is programmed to execute the algorithm including the steps of:
modifying the luck value associated with the patron selected casino charm by increasing a luck value of the patron selected casino charm by a predefined amount.

19. The networked computer system of claim 12, wherein the one or more processors is programmed to execute the algorithm including the steps of:
querying a gaming session data file to identify active EGMs associated with patron IDs having active gaming sessions at EGMs associated with the property ID; and
displaying a celebration window in the patron service window of each active EGM including a celebration notification.

20. The networked computer system of claim 19, wherein the one or more processors is programmed to execute the algorithm including the steps of:
displaying the celebration window in the patron service window of each active EGM including the celebration notification and a plurality of patron selectable emoticons.

21. The networked computer system of claim 20, wherein the one or more processors is programmed to execute the algorithm including the steps of:
receiving patron selected emoticons from the active EGMs;
displaying a celebration banner notification on a central display device located at the gaming tavern including a name of the patron associated with the triggering condition, the corresponding casino charm, and the received patron selected emoticons from the active EGMs.

22. The networked computer system of claim 12, wherein the one or more processors is programmed to execute the algorithm including the steps of:
rendering the card selection window including playing card rank icons arranged in a grid having three columns.

23. A method of operating a networked computer system including a plurality of EGMs located at a gaming property with each EGM including a display device including a graphical user interface (GUI) display screen displaying computer-generated icon images thereon and a corresponding player tracking device configured to monitor wagering activity associated with the EGM, and a gaming property management server including one or more processors coupled to each EGM, the method including the one or more processors performing an algorithm to display a computer-animated sequence of computer-generated images on the display screens of corresponding EGMs including the steps of:
displaying a game window and a patron service window on a first EGM including a user selectable charms challenge selection icon in the patron service window;
receiving a charms challenge gaming session request from the first EGM initiated by a patron selection of the charms challenge selection icon and conducting a charms challenge session by:
identifying a second EGM;
associating a first casino charm with the first EGM and a second casino charm with the second EGM, each of the first and second casino charms having corresponding charm luck values;
establishing a number of game plays associated with the charms challenge session;
displaying a charms challenge game screen on the first and second EGMs including casino charm icons associated with the first and second casino charms and the corresponding charm luck values;
monitoring wagering activity at the first and second EGMs for each of the number of game plays;
determining a number of charm luck points accumulated during the charms challenge session based on the monitored wagering activity at the first and second EGMs;
animating a charms luck points icon on the first and second EGMs displaying the accumulated number of charm luck points; and
modifying the corresponding charm luck values of the first and second casino charms based on the accumulated number of charm luck points; and
animating corresponding casino charm icons on the charms challenge game screen of the first and second EGMS to display the modified charm luck values of the first and second casino charms.

24. A non-transitory computer-readable storage media having computer-executable instructions embodied thereon to operate a networked computer system including a plurality of EGMs located at a gaming property with each EGM including a display device including a graphical user interface (GUI) display screen displaying computer-generated icon images thereon and a corresponding player tracking device configured to monitor wagering activity associated with the EGM, and a gaming property management server including one or more processors coupled to each EGM, when executed by the one or more processors the computer-executable instructions cause the one or more processors to perform an algorithm to display a computer-animated sequence of computer-generated images on the display screens of corresponding EGMs including the steps of:
displaying a game window and a patron service window on a first EGM including a user selectable charms challenge selection icon in the patron service window;
receiving a charms challenge gaming session request from the first EGM initiated by a patron selection of the charms challenge selection icon and conducting a charms challenge session by:
identifying a second EGM;
associating a first casino charm with the first EGM and a second casino charm with the second EGM, each of the first and second casino charms having corresponding charm luck values;
establishing a number of game plays associated with the charms challenge session;
displaying a charms challenge game screen on the first and second EGMs including casino charm icons associated with the first and second casino charms and the corresponding charm luck values;
monitoring wagering activity at the first and second EGMs for each of the number of game plays;
determining a number of charm luck points accumulated during the charms challenge session based on the monitored wagering activity at the first and second EGMs;
animating a charms luck points icon on the first and second EGMs displaying the accumulated number of charm luck points; and
modifying the corresponding charm luck values of the first and second casino charms based on the accumulated number of charm luck points; and
animating corresponding casino charm icons on the charms challenge game screen of the first and second EGMS to display the modified charm luck values of the first and second casino charms.
